(19) United States
(12) Patent Application Publication
(10) Pub. No.: US 2005/0211871 A1
(43) Pub. Date: Sep. 29, 2005

(54) Interlocking masonry blocks and method and system of making interlocking masonry blocks

(76) Inventors: John T. Ness, Stillwater, MN (US); Jeffrey A. Ness, Oak Park Heights, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/104,009

(22) Filed: Apr. 12, 2005

Related U.S. Application Data
(63) Continuation-in-part of application No. 10/879,381, filed on Jun. 29, 2004.
Application No. 10/879,381 is a continuation-in-part of application No. 10/629,460, filed on Jul. 29, 2003.

(51) Int. Cl. B29C 33/46

(52) U.S. Cl. 249/140; 249/155

(57) ABSTRACT

A method of producing a masonry block having a front face, a rear face, an upper face, a lower face, and a pair of opposed side faces. The method includes providing a mold assembly having a plurality of liner plates that form a mold cavity having an open top and an open bottom, wherein at least a first liner plate is moveable between a retracted position and an extended position, the first liner plate including a flange element. The first liner plate is moved to the extended position, the bottom of the mold cavity is closed with a pallet, dry cast concrete is placed in the mold cavity via the open top, the top of the mold cavity is closed with a moveable head shoe assembly, the head shoe assembly including a notch element. The dry cast concrete is compacted to form a pre-cured masonry block with the upper face resting on the pallet, whereby the flange element of the first liner plate and pallet cooperate to form a notch in the upper face along an edge shared with the rear face and the notch element of the shoe assembly and the first liner plate cooperate to form a flange extending from the lower face along an edge shared with the rear face, the flange adapted to engage a notch in an upper face of at least one similar masonry block. The first liner plate is moved to the retracted position and the pre-cured masonry block is expelled from the mold cavity and cured.

### CROSS-REFERENCE TO RELATED APPLICATIONS

This application is a continuation-in-part of Ser. No. 10/879,381 filed on Jun. 29, 2004, which is a continuation-in-part of Ser. No. 10/629,460 filed Jul. 29, 2003, each of which is incorporated by reference herein in its entirety.

### THE FIELD OF THE INVENTION

The present invention relates to masonry blocks, and more particularly to methods of making interlocking masonry blocks employing mold assemblies having at least one moveable liner plate and masonry blocks made by such methods.

### BACKGROUND OF THE INVENTION

Concrete blocks, also referred to as concrete masonry units (CMU's), are typically manufactured by forming them into various shapes using a concrete block machine employing a mold frame assembled so as to form a mold box. A mold cavity having a negative of a desired shape of the block to be formed is provided within the mold box. A support board, or pallet, is moved via a conveyor system onto a pallet table. The pallet table is moved upward until the pallet contacts and forms a bottom of the mold box. The cavity is then filled with concrete by a moveable feedbox drawer.

As soon as the mold is filled with concrete, the feedbox drawer is moved back to a storage position and a plunger, or head shoe assembly, descends to form a top of the mold. The head shoe assembly is typically matched to the top outside surface of the mold cavity and is hydraulically or mechanically pressed down on the concrete. The head shoe assembly compresses the concrete to a desired pounds-per-square-inch (psi) rating and block dimension while simultaneously vibrating the mold along with the vibrating table, resulting in substantial compression and optimal distribution of the concrete throughout the mold cavity.

Because of the compression, the concrete reaches a level of hardness that permits immediate stripping of the finished block from the mold. To remove the finished block from the mold, the mold remains stationary while the shoe and pallet table, along with the corresponding pallet, are moved downward and force the block from the mold onto the pallet. As soon as the bottom edge of the head shoe assembly clears the bottom edge of the mold, the conveyor system moves the pallet with the finished block forward, and another pallet takes its place under the mold. The pallet table then raises the next pallet to form a bottom of the mold box for the next block, and the process is repeated.

For many types of CMU's (e.g., pavers, patio blocks, light weight blocks, cinder blocks, etc.), but for retaining wall blocks and architectural units in particular, it is desirable for at least one surface of the block to have a desired texture, such as a stone-like texture. One technique for creating a desired texture on the block surface is to provide a negative of a desired pattern or texture on the side walls of the mold. However, because of the way finished blocks are vertically ejected from the mold, any such pattern or texture would be stripped from the side walls unless they are moved away from the mold interior prior to the block being ejected.

One technique employed for moving the sidewalls of a mold involves the use of a cam mechanism to move the sidewalls of the mold inward and an opposing spring to push the sidewalls outward from the center of the mold. However, this technique applies an “active” force to the sidewall only when the sidewall is being moved inward and relies on the energy stored in the spring to move the sidewall outward. The energy stored in the spring may potentially be insufficient to retract the sidewall if the sidewall sticks to the concrete. Additionally, the cam mechanism can potentially be difficult to utilize within the limited confines of a concrete block machine.

A second technique involves using a piston to extend and retract the sidewall. However, a shaft of the piston shaft is coupled directly to the moveable sidewall and moves in-line with the direction of movement of the moveable sidewall. Thus, during compression of the concrete by the head shoe assembly, an enormous amount of pressure is exerted directly on the piston via the piston shaft. Consequently, a piston having a high psi rating is required to hold the sidewall in place during compression and vibration of the concrete. Additionally, the direct pressure on the piston shaft can potentially cause increased wear and shorten the expected life of the piston.

### SUMMARY OF THE INVENTION

One aspect of the present invention provides a method of producing a masonry block having a front face, a rear face, an upper face, a lower face, and a pair of opposed side faces. The method includes providing a mold assembly having a plurality of liner plates that form a mold cavity having an open top and an open bottom, wherein at least a first liner plate is moveable between a retracted position and an extended position, the first liner plate including a flange element. The first liner plate is moved to the extended position, the bottom of the mold cavity is closed with a pallet, dry cast concrete is placed in the mold cavity via the open top, the top of the mold cavity is closed with a moveable head shoe assembly, the head shoe assembly including a notch element. The dry cast concrete is compacted to form a pre-cured masonry block with the upper face resting on the pallet, whereby the flange element of the first liner plate and pallet cooperate to form a notch in the upper face along an edge shared with the rear face and the notch element of the shoe assembly and the first liner plate cooperate to form a flange extending from the lower face along an edge shared with the rear face, the flange adapted to engage a notch in an upper face of at least one similar masonry block. The first liner plate is moved to the retracted position and the pre-cured masonry block is expelled from the mold cavity and cured.

### BRIEF DESCRIPTION OF THE DRAWINGS

FIG. 1 is a perspective view of one exemplary embodiment of a mold assembly having moveable liner plates according to the present invention.

FIG. 2 is a perspective view of one exemplary embodiment of a gear drive assembly and moveable liner plate according to the present invention.

FIG. 3A is a top view of gear drive assembly and moveable liner plate as illustrated in FIG. 2.

FIG. 3B is a side view of gear drive assembly and moveable liner plate as illustrated in FIG. 2.

FIG. 4A is a top view of the mold assembly of FIG. 1 having the liner plates retracted.

FIG. 4B is a top view of the mold assembly of FIG. 1 having the liner plates extended.

FIG. 5A illustrates a top view of one exemplary embodiment of a gear plate according to the present invention.

FIG. 5B illustrates an end view of the gear plate illustrated by FIG. 5A.

FIG. 5C illustrates a bottom view of one exemplary embodiment of a gear head according to the present invention.

FIG. 5D illustrates an end view of the gear head of FIG. 5C.

FIG. 6A is a top view of one exemplary embodiment of a gear track according to the present invention.

FIG. 6B is a side view of the gear track of FIG. 6A.

FIG. 6C is an end view of the gear track of FIG. 6A.

FIG. 7 is a diagram illustrating the relationship between a gear track and gear plate according to the present invention.

FIG. 8A is a top view illustrating the relationship between one exemplary embodiment of a gear head, gear plate, and gear track according to the present invention.

FIG. 8B is a side view of the illustration of FIG. 8A.

FIG. 8C is an end view of the illustration of FIG. 8A.

FIG. 9A is a top view illustrating one exemplary embodiment of a gear plate being in a retracted position within a gear track according to the present invention.

FIG. 9B is a top view illustrating one exemplary embodiment of a gear plate being in an extended position from a gear track according to the present invention.

FIG. 10A is a diagram illustrating one exemplary embodiment of drive unit according to the present invention.

FIG. 10B is a partial top view of the drive unit of the illustration of FIG. 10A.

FIG. 11A is a top view illustrating one exemplary embodiment of a mold assembly according to the present invention.

FIG. 11B is a diagram illustrating one exemplary embodiment of a gear drive assembly according to the present invention.

FIG. 12 is a perspective view illustrating a portion of one exemplary embodiment of a mold assembly according to the present invention.

FIG. 13 is a perspective view illustrating one exemplary embodiment of a gear drive assembly according to the present invention.

FIG. 14 is a top view illustrating a portion of one exemplary embodiment of a mold assembly and gear drive assembly according to the present invention.

FIG. 15A is a top view illustrating a portion of one exemplary embodiment of a gear drive assembly employing a stabilizer assembly.

FIG. 15B is a cross-sectional view of the gear drive assembly of FIG. 15A.

FIG. 15C is a cross-sectional view of the gear drive assembly of FIG. 15A.

FIG. 16 is a side view illustrating a portion of one exemplary embodiment of a gear drive assembly and moveable liner plate according to the present invention.

FIG. 17 is a block diagram illustrating one exemplary embodiment of a mold assembly employing a control system according to the present invention.

FIG. 18A is a top view illustrating a portion of one exemplary embodiment of gear drive assembly employing a screw drive system according to the present invention.

FIG. 18B is a lateral cross-sectional view of the gear drive assembly of FIG. 18A.

FIG. 18C is a longitudinal cross-sectional view of the gear drive assembly of FIG. 18A.

FIG. 19 is flow diagram illustrating one exemplary embodiment of a process for forming a concrete block employing a mold assembly according to the present invention.

FIG. 20A is a perspective view of an example masonry block in accordance with the present invention.

FIG. 20B is a side view of the example masonry block of FIG. 20A.

FIG. 20C is a top view illustrating one embodiment of the masonry block of FIG. 20A.

FIG. 20D is a top view illustrating one embodiment of the masonry block of FIG. 20A.

FIG. 21 is a cross-section of an example soil retention wall employing masonry blocks illustrated by FIG. 20A.

FIG. 22A is a side view illustrating one embodiment of the masonry block of FIG. 20A.

FIG. 22B is a side view illustrating one embodiment of the masonry block of FIG. 20A.

FIG. 23A is a cross-section of an example soil retention wall employing masonry blocks illustrated by FIG. 22A.

FIG. 23B is a cross-section of an example soil retention wall employing masonry blocks illustrated by FIG. 22B.

FIG. 24A is a top view illustrating one exemplary embodiment of a mold assembly in accordance with the present invention.

FIG. 24B is a top view further illustrating the mold assembly of FIG. 24A.

FIG. 24C illustrates a cross-section through the mold assembly illustrated by FIG. 24A.

FIG. 24D illustrates a cross-section through the mold assembly illustrated by FIG. 24B.

FIG. 25A is a perspective view of an example masonry block in accordance with the present invention.

FIG. 25B is a side view of the example masonry block of FIG. 25A.

FIG. 25C is a top view illustrating one embodiment of the masonry block of FIG. 25A.

FIG. 25D is a top view illustrating one embodiment of the masonry block of FIG. 25A.

FIG. 26 is a cross-section of an example soil retention wall employing masonry blocks illustrated by FIG. 25A.

FIG. 27A is a side view illustrating one embodiment of the masonry block of FIG. 25A.

FIG. 27B is a side view illustrating one embodiment of the masonry block of FIG. 25A.

FIG. 28A is a cross-section of an example soil retention wall employing masonry blocks illustrated by FIG. 27A.

FIG. 28B is a cross-section of an example soil retention wall employing masonry blocks illustrated by FIG. 27B.

FIG. 29A is a top view illustrating one exemplary embodiment of a mold assembly in accordance with the present invention.

FIG. 29B is a top view further illustrating the mold assembly of FIG. 29A.

FIG. 29C illustrates a cross-section through the mold assembly illustrated by FIG. 29A.

FIG. 29D illustrates a cross-section through the mold assembly illustrated by FIG. 29B.

FIG. 30A is a perspective view of an example masonry block in accordance with the present invention.

FIG. 30B is a front view of the example masonry block of FIG. 25A.

FIG. 30C is a front view illustrating one embodiment of the masonry block of FIG. 30A.

FIG. 31A is a front elevation of an example structure employing the masonry block of FIG. 30B.

FIG. 31B is a front elevation of an example structure employing the masonry block of FIG. 30C.

FIG. 32A is a perspective view of an example masonry block in accordance with the present invention.

FIG. 32B is a side view of the example masonry block of FIG. 32A.

FIG. 32C is an end view illustrating one embodiment of the masonry block of FIG. 32A.

FIG. 32D is an end view illustrating one embodiment of the masonry block of FIG. 32A.

FIG. 32E is a top view illustrating one embodiment of the masonry block of FIG. 32A.

FIG. 32F is a top view illustrating one embodiment of the masonry block of FIG. 32A.

FIG. 33A is a cross-section of an example soil retention wall employing masonry blocks illustrated by FIG. 32C.

FIG. 33B is a cross-section of an example wall structure employing masonry blocks illustrated by FIG. 32D.

FIG. 33C is a front elevation of a portion of an example structure employing masonry blocks illustrated by FIGS. 33A and 33B.

FIG. 34A is an end view illustrating one embodiment of the masonry block of FIG. 32A.

FIG. 34B is an end view illustrating one embodiment of the masonry block of FIG. 32A.

FIG. 35A is a cross-section of an example soil retention wall employing masonry blocks illustrated by FIG. 34A.

FIG. 35B is a cross-section of an example soil retention wall employing masonry blocks illustrated by FIG. 34B.

FIG. 36A is a top view illustrating one exemplary embodiment of a mold assembly in accordance with the present invention.

FIG. 36B is a top view further illustrating the mold assembly of FIG. 36A.

FIG. 36C illustrates a cross-section through the mold assembly illustrated by FIG. 36A.

FIG. 36D illustrates a cross-section through the mold assembly illustrated by FIG. 36B.

FIG. 37A is a perspective view of an example masonry block in accordance with the present invention.

FIG. 37B is an end view illustrating one embodiment of the masonry block of FIG. 37A.

FIG. 37C is an end view illustrating one embodiment of the masonry block of FIG. 37A.

FIG. 38A is a cross-section of an example soil retention wall employing masonry blocks illustrated by FIG. 37B.

FIG. 38B is a cross-section of an example wall structure employing masonry blocks illustrated by FIG. 37C.

FIG. 39A is a top view illustrating one exemplary embodiment of a mold assembly in accordance with the present invention.

FIG. 39B is a top view further illustrating the mold assembly of FIG. 39A.

FIG. 39C illustrates a cross-section through the mold assembly illustrated by FIG. 39A.

FIG. 39D illustrates a cross-section through the mold assembly illustrated by FIG. 39B.

FIG. 40A is a perspective view of an example pair of interlocking masonry blocks according to the present invention.

FIG. 40B illustrates end and side views of the pair of interlocking masonry blocks of FIG. 40A.

FIG. 40C illustrates top views of the pair of interlocking masonry blocks of FIG. 40A.

FIG. 40D illustrates top views of the pair of interlocking masonry blocks of FIG. 40A.

FIG. 41 is a perspective view of a structure employing masonry blocks of FIG. 37A and having a corner formed by pairs of interlocking blocks illustrated by FIG. 40A.

### DESCRIPTION OF THE PREFERRED EMBODIMENTS

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

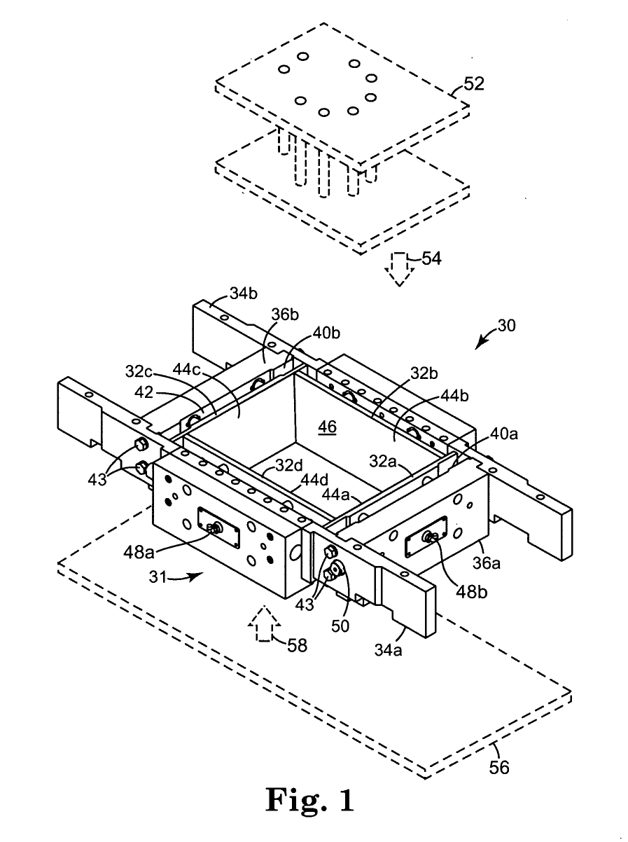

FIG. 1 is a perspective view of one exemplary embodiment of a mold assembly 30 having moveable liner plates 32a, 32b, 32c and 32d according to the present invention. Mold assembly 30 includes a drive system assembly 31 having side-members 34a and 34b and cross-members 36a and 36b, respectively having an inner wall 38a, 38b, 40a, and 40b, and coupled to one another such that the inner surfaces form a mold box 42. In the illustrated embodiment, cross members 36a and 36b are bolted to side members 34a and 34b with bolts 37.

Moveable liner plates 32a, 32b, 32c, and 32d, respectively have a front surface 44a, 44b, 44c, and 44d configured so as to form a mold cavity 46. In the illustrated embodiment, each liner plate has an associated gear drive assembly located internally to an adjacent mold frame member. A portion of a gear drive assembly 50 corresponding to liner plate 32a and located internally to cross-member 36a is shown extending through side-member 34a. Each gear drive assembly is selectively coupled to its associated liner plate and configured to move the liner plate toward the interior of mold cavity 46 by applying a first force in a first direction parallel to the associated cross-member, and to move the liner plate away from the interior of mold cavity 46 by applying a second force in a direction opposite the first direction. Side members 34a and 34b and cross-members 36a and 36b each have a corresponding lubrication port that extends into the member and provides lubrication to the corresponds gear elements. For example, lubrication ports 48a and 48b. The gear drive assembly and moveable liner plates according to the present invention are discussed in greater detail below.

In operation, mold assembly 30 is selectively coupled to a concrete block machine. For ease of illustrative purposes, however, the concrete block machine is not shown in FIG. 1. In one embodiment, mold assembly 30 is mounted to the concrete block machine by coupling side members 34a and 34b of drive system assembly 31 to the concrete block machine. In one embodiment, mold assembly 30 further includes a head shoe assembly 52 having dimensions substantially equal to those of mold cavity 46. Head shoe assembly 52 is also configured to selectively couple to the concrete block machine.

Liner plates 32a through 32d are first extended a desired distance toward the interior of mold box 42 to form the desired mold cavity 46. A vibrating table on which a pallet 56 is positioned is then raised (as indicated by directional arrow 58) such that pallet 56 contacts and forms a bottom to mold cavity 46. In one embodiment, a core bar assembly (not shown) is positioned within mold cavity 46 to create voids within the finished block in accordance with design requirements of a particular block.

Mold cavity 46 is then filled with concrete from a moveable feedbox drawer. Head shoe assembly 52 is then lowered (as indicated by directional arrow 54) onto mold 46 and hydraulically or mechanically presses the concrete. Head shoe assembly 52 along with the vibrating table then simultaneously vibrate mold assembly 30, resulting in a high compression of the concrete within mold cavity 46. The high level of compression fills any voids within mold cavity 46 and causes the concrete to quickly reach a level of hardness that permits immediate removal of the finished block from mold cavity 46.

The finished block is removed by first retracting liner plates 32a through 32d. Head shoe assembly 52 and the vibrating table, along with pallet 56, are then lowered (in a direction opposite to that indicated by arrow 58), while mold assembly 30 remains stationary so that head shoe assembly 56 pushes the finished block out of mold cavity 46 onto pallet 52. When a lower edge of head shoe assembly 52 drops below a lower edge of mold assembly 30, the conveyer system moves pallet 56 carrying the finished block away and a new pallet takes its place. The above process is repeated to create additional blocks.

By retracting liner plates 32a through 32b prior to removing the finished block from mold cavity 46. liner plates 32a through 32d experience less wear and, thus, have an increased operating life expectancy. Furthermore, moveable liner plates 32a through 32d also enables a concrete block to be molded in a vertical position relative to pallet 56, in lieu of the standard horizontal position, such that head shoe assembly 52 contacts what will be a “face” of the finished concrete block. A “face” is a surface of the block that will be potentially be exposed for viewing after installation in a wall or other structure.

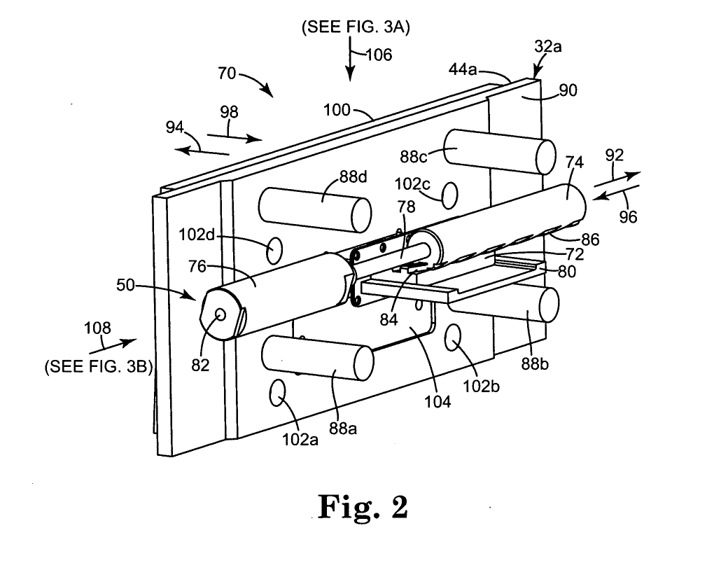

FIG. 2 is a perspective view 70 illustrating a moveable liner plate and corresponding gear drive assembly according to the present invention, such as moveable liner plate 32a and corresponding gear drive assembly 50. For illustrative purposes, side member 34a and cross-member 36 are not shown. Gear drive assembly 50 includes a first gear element 72 selectively coupled to liner plate 32a, a second gear element 74, a single rod-end double-acting pneumatic cylinder (cylinder) 76 coupled to second gear element 74 via a piston rod 78, and a gear track 80. Cylinder 76 includes an aperture 82 for accepting a pneumatic fitting. In one embodiment, cylinder 76 comprises a hydraulic cylinder. In one embodiment, cylinder 76 comprises a double rod-end dual-acting cylinder. In one embodiment, piston rod 78 is threadably coupled to second gear element 74.

In the embodiment of FIG. 2, first gear element 72 and second gear element 74 are illustrated and hereinafter referred to as a gear plate 72 and second gear element 74, respectively. However, while illustrated as a gear plate and a cylindrical gear head, first gear element 72 and second gear element 74 can be of any suitable shape and dimension.

Gear plate 72 includes a plurality of angled channels on a first major surface 84 and is configured to slide in gear track 80. Gear track 80 slidably inserts into a gear slot (not shown) extending into cross member 36a from inner wall 40a. Cylindrical gear head 74 includes a plurality of angled channels on a surface 86 adjacent to first major surface 84 of female gear plate 72, wherein the angled channels are tangential to a radius of cylindrical gear head 74 and configured to slidably mate and interlock with the angled channels of gear plate 72. Liner plate 32a includes guide posts 88a, 88b, 88c, and 88d extending from a rear surface 90. Each of the guide posts is configured to slidably insert into a corresponding guide hole (not shown) extending into cross member 36a from inner wall 40a. The gear slot and guide holes are discussed in greater detail below.

When cylinder 76 extends piston rod 78, cylindrical gear head 74 moves in a direction indicated by arrow 92 and, due to the interlocking angled channels, causes gear plate 72 and, thus, liner plate 32a to move toward the interior of mold 46 as indicated by arrow 94. It should be noted that, as illustrated, FIG. 2 depicts piston rod 78 and cylindrical gear head 74 in an extended position. When cylinder 76 retracts piston rod 78, cylindrical gear head 74 moves in a direction indicated by arrow 96 causing gear plate 72 and liner plate 32 to move away from the interior of the mold as indicated by arrow 98. As liner plate 32a moves, either toward or away from the center of the mold, gear plate 72 slides in guide track 80 and guide posts 88a through 88d slide within their corresponding guide holes.

In one embodiment, a removable liner face 100 is selectively coupled to front surface 44a via fasteners 102a, 102b, 102c, and 102d extending through liner plate 32a. Removable liner face 100 is configured to provide a desired shape and/or provide a desired imprinted pattern, including text, on a block made in mold 46. In this regard, removable liner face 100 comprises a negative of the desired shape or pattern. In one embodiment, removable liner face 100 comprises a polyurethane material. In one embodiment, removable liner face 100 comprises a rubber material. In one embodiment, removable liner plate comprises a metal or metal alloy, such as steel or aluminum. In one embodiment, liner plate 32 further includes a heater mounted in a recess 104 on rear surface 90, wherein the heater aids in curing concrete within mold 46 to reduce the occurrence of concrete sticking to front surface 44a and removable liner face 100.

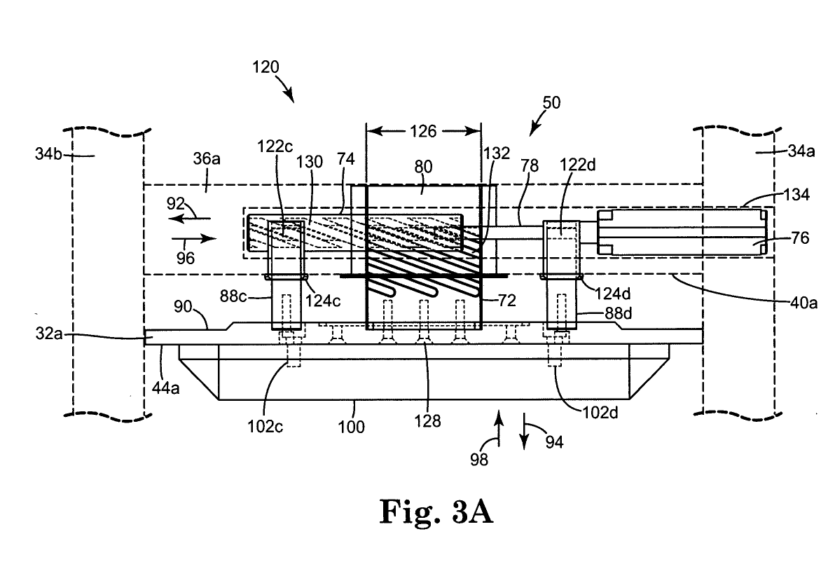

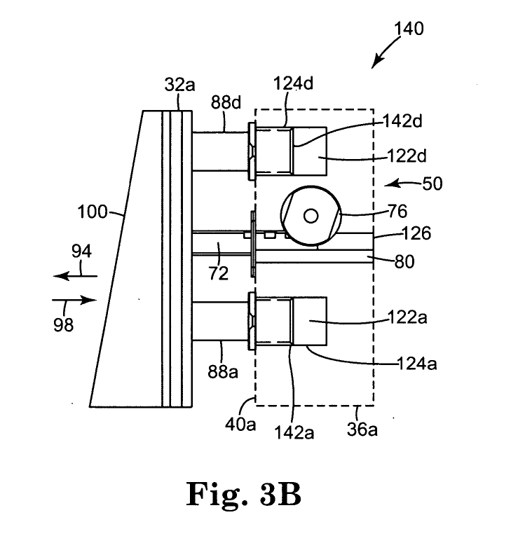

FIG. 3A is a top view 120 of gear drive assembly 50 and liner plate 32a, as indicated by directional arrow 106 in FIG. 2. In the illustration, side members 34a and 34b, and cross member 36a are indicated dashed lines. Guide posts 88c and 88d are slidably inserted into guide holes 122c and 122d, respectively, which extend into cross member 36a from interior surface 40a. Guide holes 122a and 122b, corresponding respectively to guide posts 88a and 88b, are not shown but are located below and in-line with guide holes 122c and 122d. In one embodiment, guide hole bushings 124c and 124d are inserted into guide holes 122c and 122d, respectively, and slidably receive guide posts 88c and 88d. Guide hole bushings 124a and 124b are not shown, but are located below and in-line with guide hole bushings 124c and 124d. Gear track 80 is shown as being slidably inserted in a gear slot 126 extending through cross member 36a with gear plate 72 sliding in gear track 80. Gear plate 72 is indicated as being coupled to liner plate 32a by a plurality of fasteners 128 extending through liner plate 32a from front surface 44a.

A cylindrical gear shaft is indicated by dashed lines 134 as extending through side member 34a and into cross member 36a and intersecting, at least partially with gear slot 126. Cylindrical gear head 74, cylinder 76, and piston rod 78 are slidably inserted into gear shaft 134 with cylindrical gear head 74 being positioned over gear plate 72. The angled channels of cylindrical gear head 74 are shown as dashed lines 130 and are interlocking with the angled channels of gear plate 72 as indicated at 132.

FIG. 3B is a side view 140 of gear drive assembly 50 and liner plate 32a, as indicated by directional arrow 108 in FIG. 2. Liner plate 32a is indicated as being extended, at least partially, from cross member 36a. Correspondingly, guide posts 88a and 88d are indicated as partially extending from guide hole bushings 124a and 124d, respectively. In one embodiment, a pair of limit rings 142a and 142d are selectively coupled to guide posts 88a and 88, respectively, to limit an extension distance that liner plate 32a can be extended from cross member 36a toward the interior of mold cavity 46. Limit rings 142b and 142c corresponding respectively to guide posts 88b and 88c are not shown, but are located behind and in-line with limit rings 142a and 142d. In the illustrated embodiment, the limit rings are indicated as being substantially at an end of the guide posts, thus allowing a substantially maximum extension distance from cross member 36a. However, the limit rings can be placed at other locations along the guide posts to thereby adjust the allowable extension distance.

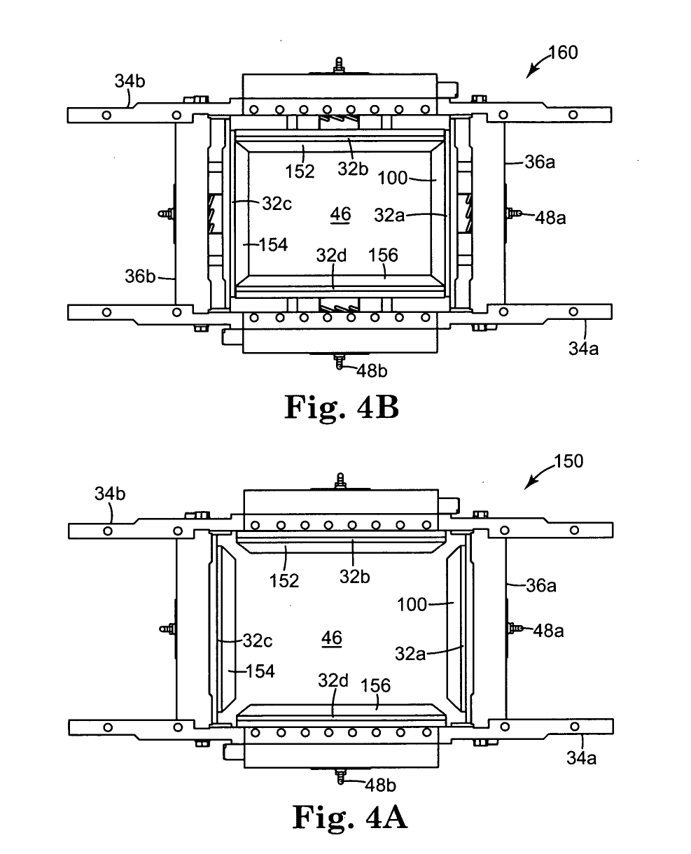

FIG. 4A and FIG. 4B are top views 150 and 160, respectively, of mold assembly 30. FIG. 4A illustrates liner plates 32a, 32b, 32c, and 32d in a retracted positions. Liner faces 152, 154, and 154 correspond respectively to liner plates 32b, 32c, and 32d. FIG. 4B illustrates liner plates 32a, 32b, 32c, and 32d, along with their corresponding liner faces 100, 152, 154, and 156 in an extended position.

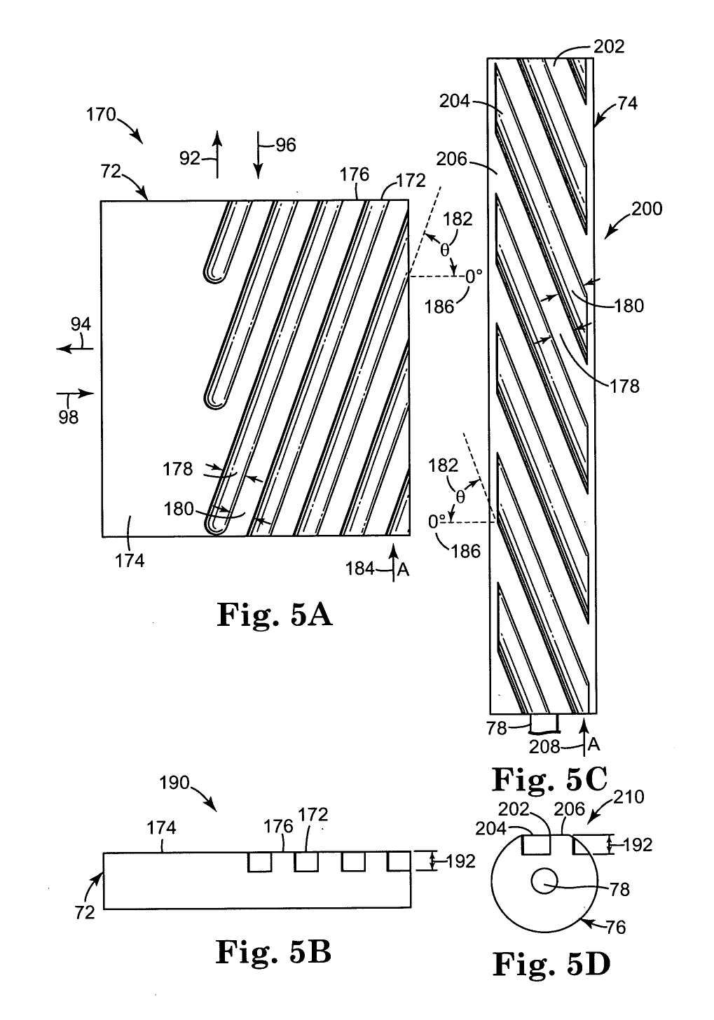

FIG. 5A is a top view 170 of gear plate 72. Gear plate 72 includes a plurality of angled channels 172 running across a top surface 174 of gear plate 72. Angled channels 172 form a corresponding plurality of linear “teeth” 176 having as a surface the top surface 174. Each angled channel 172 and each tooth 176 has a respective width 178 and 180. The angled channels run at an angle (Θ) 182 from 0°, indicated at 186, across gear plate 72.

FIG. 5B is an end view (“A”) 185 of gear plate 72, as indicated by directional arrow 184 in FIG. 5A, further illustrating the plurality of angled channels 172 and linear teeth 176. Each angled channel 172 has a depth 192.

FIG. 5C illustrates a view 200 of a flat surface 202 of cylindrical gear head 76. Cylindrical gear head 76 includes a plurality of angled channels 204 running across surface 202. Angled channels 204 form a corresponding plurality of linear teeth 206. The angled channels 204 and linear teeth 206 have widths 180 and 178, respectively, such that the width of linear teeth 206 substantially matches the width of angled channels 172 and the width of angled channels 204 substantially match the width of linear teeth 176. Angled channels 204 and teeth 206 run at angle (Θ) 182 from 0°, indicated at 186, across surface 202.

FIG. 5D is an end view 210 of cylindrical gear head 76, as indicated by directional arrow 208 in FIG. 5C, further illustrating the plurality of angled channels 204 and linear teeth 206. Surface 202 is a flat surface tangential to a radius of cylindrical gear head 76. Each angled channel has a depth 192 from flat surface 202.

When cylindrical gear head 76 is “turned over” and placed across surface 174 of gear plate 72, linear teeth 206 of gear head 76 mate and interlock with angled channels 172 of gear plate 72, and linear teeth 176 of gear plate 72 mate and interlock with angled channels 204 of gear head 76 (See also FIG. 2). When gear head 76 is forced in direction 92, linear teeth 206 of gear head 76 push against linear teeth 176 of gear plate 72 and force gear plate 72 to move in direction 94. Conversely, when gear head 76 is forced in direction 96, linear teeth 206 of gear head 76 push against linear teeth 176 of gear plate 72 and force gear plate 72 to move in direction 98.

In order for cylindrical gear head 76 to force gear plate 72 in directions 94 and 98, angle (Θ) 182 must be greater than 0° and less than 90°. However, it is preferable that Θ 182 be at least greater than 45°. When Θ 182 is 45° or less, it takes more force for cylindrical gear head 74 moving in direction 92 to push gear plate 72 in direction 94 than it does for gear plate 72 being forced in direction 98 to push cylindrical gear head 74 in direction 96, such as when concrete in mold 46 is being compressed. The more Θ 182 is increased above 45°, the greater the force that is required in direction 98 on gear plate 72 to move cylindrical gear head 74 in direction 96. In fact, at 90° gear plate 72 would be unable to move cylindrical gear head 74 in either direction 92 or 96, regardless of how much force was applied to gear plate 72 in direction 98. In effect, angle (Θ) acts as a multiplier to a force provided to cylindrical gear head 74 by cylinder 76 via piston rod 78. When Θ 182 is greater than 45°, an amount of force required to be applied to gear plate 72 in direction 98 in order to move cylindrical gear head 74 in direction 96 is greater than an amount of force required to be applied to cylindrical gear head 74 in direction 92 via piston rod 78 in order to “hold” gear plate 72 in position (i.e., when concrete is being compressed in mold 46).

However, the more Θ 182 is increased above 45°, the less distance gear plate 72, and thus corresponding liner plate 32a, will move in direction 94 when cylindrical gear head 74 is forced in direction 92. A preferred operational angle for Θ 182 is approximately 70°. This angle represents roughly a balance, or compromise, between the length of travel of gear plate 72 and an increase in the level of force required to be applied in direction 98 on gear plate 72 to force gear head 74 in direction 96. Gear plate 72 and cylindrical gear head 74 and their corresponding angled channels 176 and 206 reduce the required psi rating of cylinder 76 necessary to maintain the position of liner plate 32a when concrete is being compressed in mold cavity 46 and also reduces the wear experienced by cylinder 76. Additionally, from the above discussion, it is evident that one method for controlling the travel distance of liner plate 32a is to control the angle (Θ) 182 of the angled channels 176 and 206 respectively of gear plate 72 and cylindrical gear head 74.

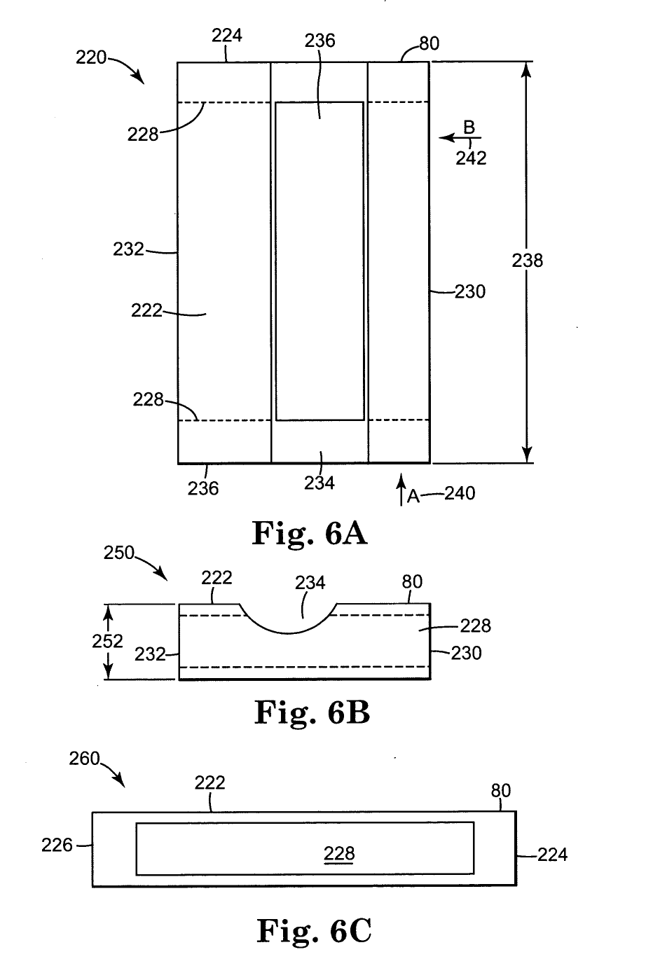

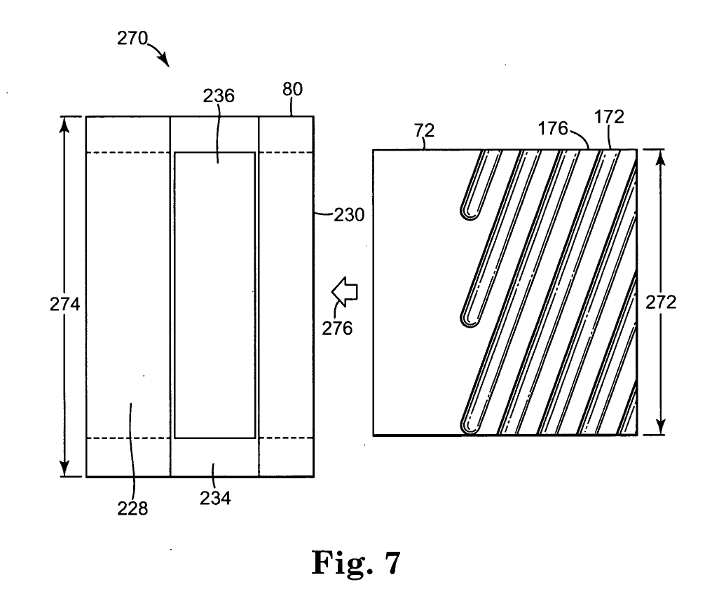

FIG. 6A is a top view 220 of gear track 80. Gear track 80 has a top surface 220, a first end surface 224, and a second end surface 226. A rectangular gear channel, indicated by dashed lines 228, having a first opening 230 and a second opening 232 extends through gear track 80. An arcuate channel 234, having a radius required to accommodate cylindrical gear head 76 extends across top surface 220 and forms a gear window 236 extending through top surface 222 into gear channel 228. Gear track 80 has a width 238 incrementally less than a width of gear opening 126 in side member 36a (see also FIG. 3A).

FIG. 6B is an end view 250 of gear track 80, as indicated by direction arrow 240 in FIG. 6A, further illustrating gear channel 228 and arcuate channel 234. Gear track 80 has a depth 252 incrementally less than height of gear opening 126 in side member 36a (see FIG. 3A). FIG. 6B is a side view 260 of gear track 80 as indicated by directional arrow 242 in FIG. 6A.

FIG. 7 is a top view 270 illustrating the relationship between gear track 80 and gear plate 72. Gear plate 72 has a width 272 incrementally less than a width 274 of gear track 80, such that gear plate 72 can be slidably inserted into gear channel 228 via first opening 230. When gear plate 72 is inserted within gear track 80, angled channels 172 and linear teeth 176 are exposed via gear window 236.

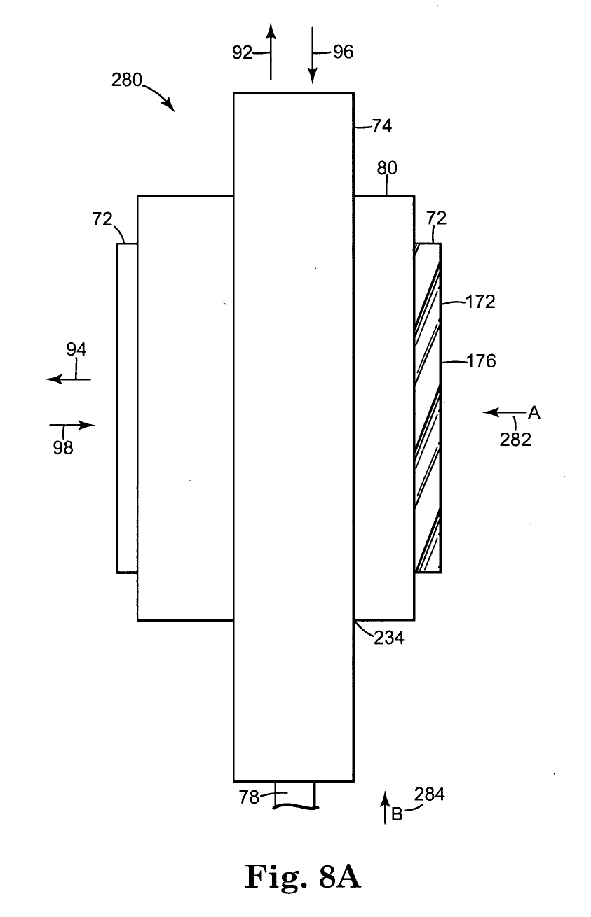

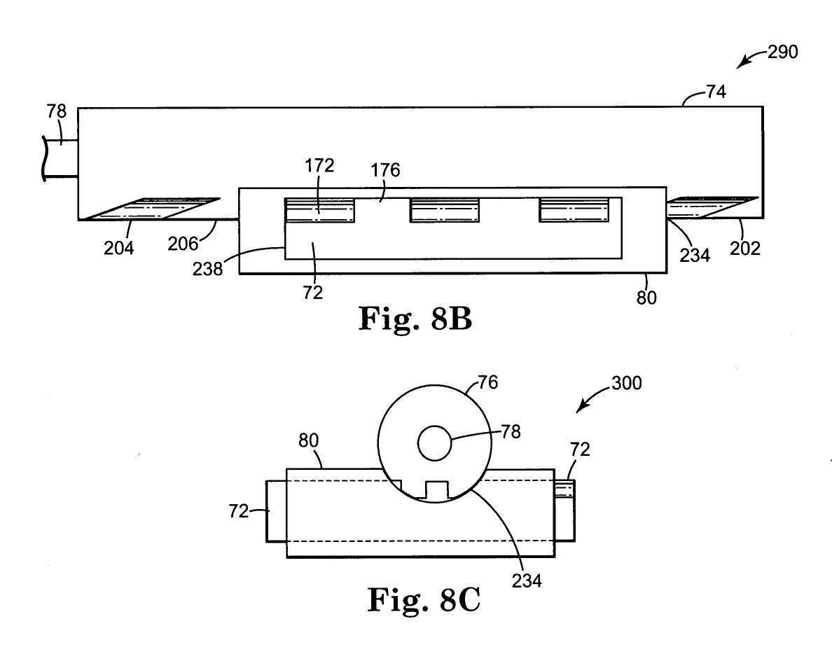

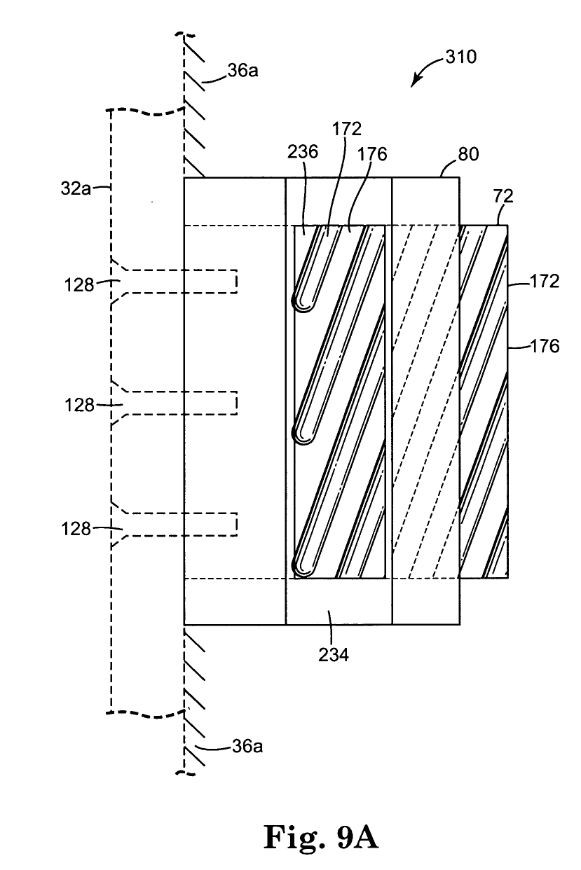

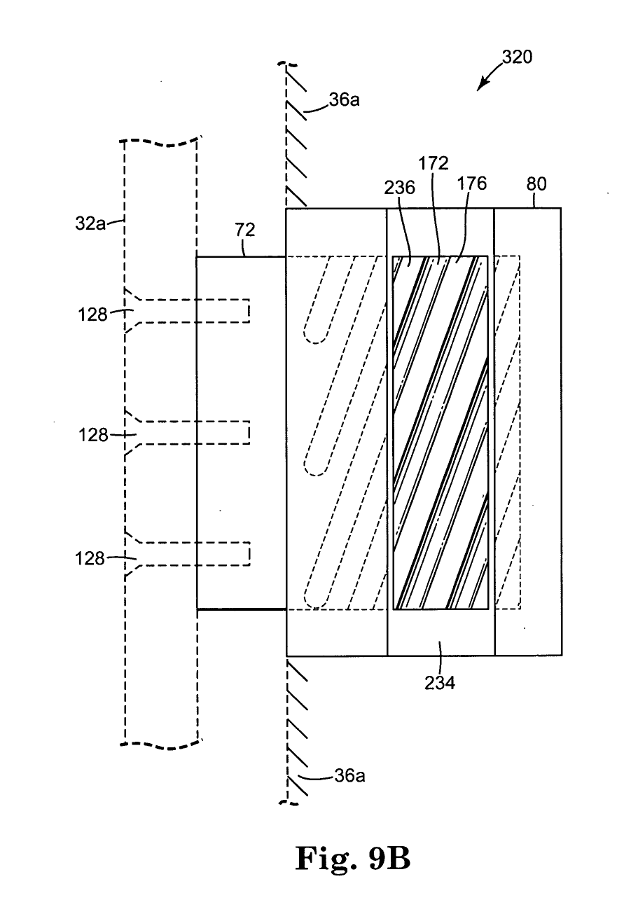

FIG. 8A is a top view 280 illustrating the relationship between gear plate 72, cylindrical gear head 74, and gear track 80. Gear plate 72 is indicated as being slidably inserted within guide track 80. Cylindrical gear head 74 is indicated as being positioned within arcuate channel 234, with the angled channels and linear teeth of cylindrical gear head 74 being slidably mated and interlocked with the angled channels 172 and linear teeth 176 of gear plate 72. When cylindrical gear head 74 is moved in direction 92 by extending piston rod 78, gear plate 72 extends outward from gear track 80 in direction 94 (See also FIG. 9B below). When cylindrical gear head 74 is moved in direction 96 by retracting piston rod 78, gear plate 72 retracts into gear track 80 in direction 98 (See also FIG. 9A below).

FIG. 8B is a side view 290 of gear plate 72, cylindrical gear head 74, and guide track 80 as indicated by directional arrow 282 in FIG. 8A. Cylindrical gear head 74 is positioned such that surface 202 is located within arcuate channel 234. Angled channels 204 and teeth 206 of cylindrical gear head 74 extend through gear window 236 and interlock with angled channels 172 and linear teeth 176 of gear plate 72 located within gear channel 228. FIG. 8C is an end view 300 as indicated by directional arrow 284 in FIG. 8A, and further illustrates the relationship between gear plate 72, cylindrical gear head 74, and guide track 80.

FIG. 9A is top view 310 illustrating gear plate 72 being in a fully retracted position within gear track 80, with liner plate 32a being retracted against cross member 36a. For purposes of clarity, cylindrical gear head 74 is not shown. Angled channels 172 and linear teeth 176 are visible through gear window 236. Liner plate 32a is indicated as being coupled to gear plate 72 with a plurality of fasteners 128 extending through liner plate 32a into gear plate 72. In one embodiment, fasteners 128 threadably couple liner plate 32a to gear plate 72.

FIG. 9B is a top view 320 illustrating gear plate 72 being extended, at least partially from gear track 80, with liner plate 32a being separated from cross member 36a. Again, cylindrical gear head 74 is not shown and angled channels 172 and linear teeth 176 are visible through gear window 236.

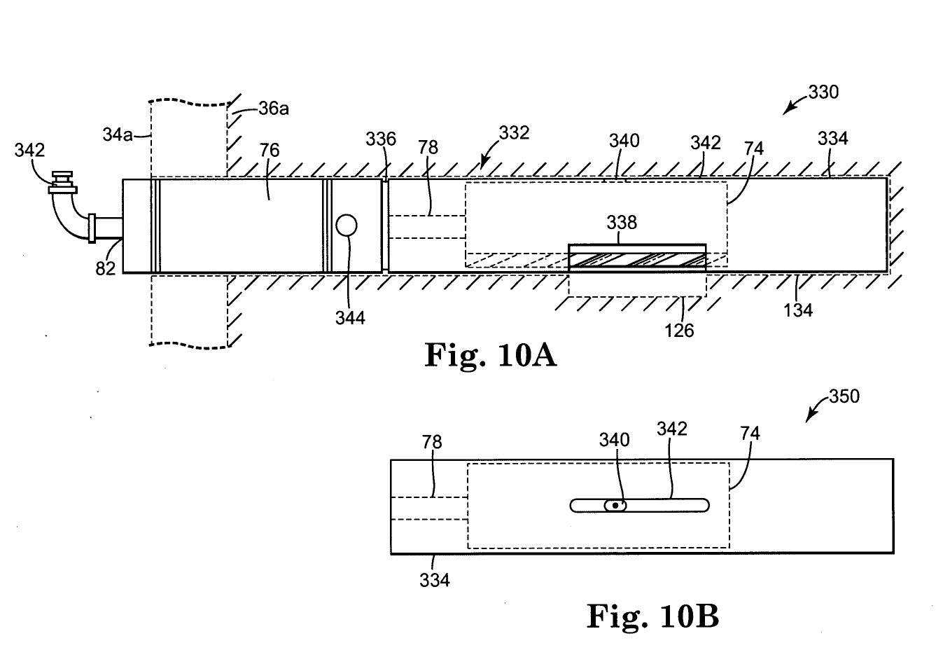

FIG. 10A is a diagram 330 illustrating one exemplary embodiment of a gear drive assembly 332 according to the present invention. Gear drive assembly 332 includes cylindrical gear head 74, cylinder 76, piston rod 78, and a cylindrical sleeve 334. Cylindrical gear head 74 and piston rod 78 are configured to slidably insert into cylindrical sleeve 334. Cylinder 76 is threadably coupled to cylindrical sleeve 334 with an O-ring 336 making a seal. A window 338 along an axis of cylindrical sleeve 334 partially exposes angled channels 204 and linear teeth 206. A fitting 342, such as a pneumatic or hydraulic fitting, is indicated as being threadably coupled to aperture 82. Cylinder 76 further includes an aperture 344, which is accessible through cross member 36a.

Gear drive assembly 332 is configured to slidably insert into cylindrical gear shaft 134 (indicated by dashed lines) so that window 338 intersects with gear slot 126 so that angled channels 204 and linear teeth 206 are exposed within gear slot 126. Gear track 80 and gear plate 72 (not shown) are first slidably inserted into gear slot 126, such that when gear drive assembly 332 is slidably inserted into cylindrical gear shaft 134 the angled channels 204 and linear teeth 206 of cylindrical gear head 74 slidably mate and interlock with the angled channels 172 and linear teeth 176 of gear plate 72.

In one embodiment, a key 340 is coupled to cylindrical gear head 74 and rides in a key slot 342 in cylindrical sleeve 334. Key 340 prevents cylindrical gear head 74 from rotating within cylindrical sleeve 334. Key 340 and key slot 342 together also control the maximum extension and retraction of cylindrical gear head 74 within cylindrical sleeve 334. Thus, in one embodiment, key 340 can be adjusted to control the extension distance of liner plate 32a toward the interior of mold cavity 46. FIG. 10A is a top view 350 of cylindrical shaft 334 as illustrated in FIG. 10B, and further illustrates key 340 and key slot 342.

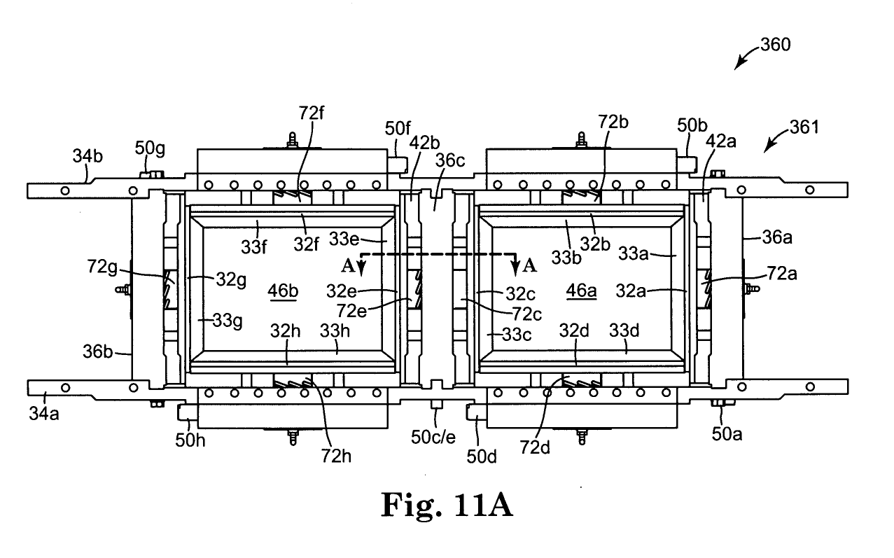

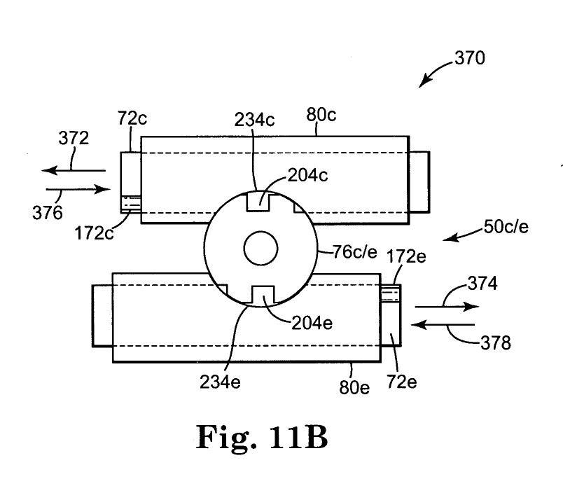

FIG. 11A is a top view illustrating one exemplary embodiment of a mold assembly 360 according to the present invention for forming two concrete blocks. Mold assembly 360 includes a mold frame 361 having side members 34a and 34b and cross members 36a through 36c coupled to one another so as to form a pair of mold boxes 42a and 42b. Mold box 42a includes moveable liner plates 32a through 32d and corresponding removable liner faces 33a through 33d configured to form a mold cavity 46a. Mold box 42b includes moveable liner plates 32e through 32h and corresponding removable liner faces 33e through 33h configured to form a mold cavity 46b.

Each moveable liner plate has an associated gear drive assembly located internally to an adjacent mold frame member as indicated by 50a through 50h. Each moveable liner plate is illustrated in an extended position with a corresponding gear plate indicated by 72a through 72h. As described below, moveable liner plates 32c and 32e share gear drive assembly 50c/e, with gear plate 72e having its corresponding plurality of angled channels facing upward and gear plate 72c having its corresponding plurality of angled channels facing downward.

FIG. 11B is diagram illustrating a gear drive assembly according to the present invention, such as gear drive assembly 50c/e. FIG. 11B illustrates a view of gear drive assembly 50c/e as viewed from section A-A through cross-member 36c of FIG. 11A. Gear drive assembly 50c/e includes a single cylindrical gear head 76c/e having angled channels 204c and 204e on opposing surfaces. Cylindrical gear head 76c/e fits into arcuate channels 234c and 234e of gear tracks 80c and 80d, such that angled channels 204c and 204e slidably interlock with angled channels 172c and 172e of gear plates 72c and 72e respectively.

Angled channels 172c and 204c, and 172e and 204e oppose one another and are configured such that when cylindrical gear head 76c/e is extended (e.g. out from FIG. 11B) gear plate 72c moves in a direction 372 toward the interior of mold cavity 46a and gear plate 72e moves in a direction 374 toward the interior of mold cavity 46b. Similarly, when cylindrical gear head 76c/e is retracted (e.g. into FIG. 11B) gear plate 72c moves in a direction 376 away from the interior of mold cavity 46a and gear plate 72e moves in a direction 378 away from the interior of mold cavity 378. Again, cylindrical gear head 76c/e and gear plates 72c and 72c could be of any suitable shape.

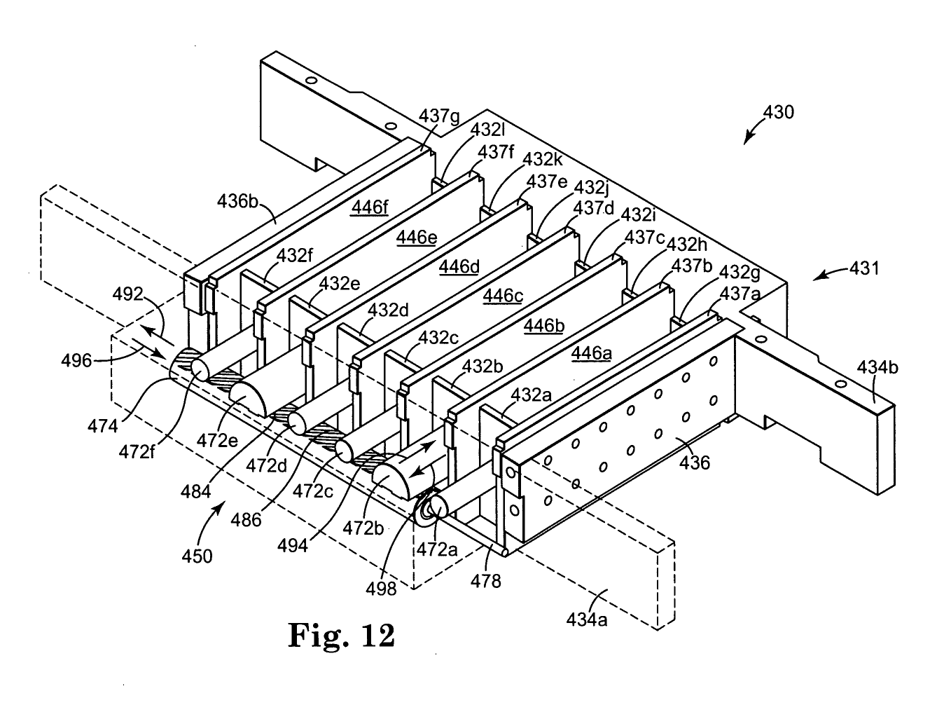

FIG. 12 is a perspective view illustrating a portion of one exemplary embodiment of a mold assembly 430 according to the present invention. Mold assembly includes moveable liner plates 432a through 4321 for simultaneously molding multiple concrete blocks. Mold assembly 430 includes a drive system assembly 431 having a side members 434a and 434b, and cross members 436a and 436b. For illustrative purposes, side member 434a is indicated by dashed lines. Mold assembly 430 further includes division plates 437a through 437g.

Together, moveable liner plates 432a through 4321 and division plates 437a through 437g form mold cavities 446a through 446f, with each mold cavity configured to form a concrete block. Thus, in the illustrated embodiment, mold assembly 430 is configured to simultaneously form six blocks. However, it should be apparent from the illustration that mold assembly 430 can be easily modified for simultaneously forming quantities of concrete blocks other than six.

In the illustrated embodiment, side members 434a and 434b each have a corresponding gear drive assembly for moving moveable liner plates 432a through 432f and 432g through 4321, respectively. For illustrative purposes, only gear drive assembly 450 associated with side member 434a and corresponding moveable liner plates 432a through 432g is shown. Gear drive assembly 450 includes first gear elements 472a through 472f selectively coupled to corresponding moveable liner plates 432a through 432f, respectively, and a second gear element 474. In the illustrated embodiment, first gear elements 472a through 472f and second gear element 474 are shown as being cylindrical in shape. However, any suitable shape can be employed.

Second gear element 474 is selectively coupled to a cylinder-piston (not shown) via a piston rod 478. In one embodiment, which is described in greater detail below (see FIG. 12), second gear element 474 is integral with the cylinder-piston so as to form a single component.

In the illustrated embodiment, each first gear element 472a through 472b further includes a plurality of substantially parallel angled channels 484 that slidably mesh and interlock with a plurality of substantially parallel angled channels 486 on second gear element 474. When second gear element 474 is moved in a direction indicated by arrow 492, each of the moveable liner plates 432a through 432f moves in a direction indicated by arrow 494. Similarly, when second gear element 474 is move in a direction indicated by arrow 496, each of the moveable liner plates 432a through 432f moves in a direction indicated by arrow 498.

In the illustrated embodiment, the angled channels 484 on each of the first gear elements 432a through 432f and the angled channels 486 are at a same angle. Thus, when second gear element 474 moves in direction 492 and 496, each moveable liner plate 432a through 432f moves a same distance in direction 494 and 498, respectively. In one embodiment, second gear element 474 includes a plurality of groups of substantially parallel angled channels with each group corresponding to a different one of the first gear elements 472a through 472f. In one embodiment, the angled channels of each group and its corresponding first gear element have a different angle such that each moveable liner plate 432a through 432f move a different distance in directions 494 and 498 in response to second gear element 474 being moved in direction 492 and 496, respectively.

FIG. 13 is a perspective view illustrating a gear drive assembly 500 according to the present invention, and a corresponding moveable liner plate 502 and removable liner face 504. For illustrative purposes, a frame assembly including side members and cross members is not shown. Gear drive assembly 500 includes double rod-end, dual-acting pneumatic cylinder-piston 506 having a cylinder body 507, and a hollow piston rod 508 with a first rod-end 510 and a second rod-end 512. Gear drive assembly 500 further includes a pair of first gear elements 514a and 514b selectively coupled to moveable liner plate 502, with each first gear element 514a and 514b having a plurality of substantially parallel angled channels 516a and 516b.

In the illustrated embodiment, cylinder body 507 of cylinder-piston 506 includes a plurality of substantially parallel angled channels 518 configured to mesh and slidably interlock with angled channels 516a and 516b. In one embodiment, cylinder body 507 is configured to slidably insert into and couple to a cylinder sleeve having angled channels 518.

In one embodiment, cylinder-piston 506 and piston rod 508 are located within a drive shaft of a frame member, such as drive shaft 134 of cross-member 36a, with rod-end 510 coupled to and extending through a frame member, such as side member 34b, and second rod-end 512 coupled to and extending through a frame member, such a side member 34a. First rod-end 510 and second rod-end 512 are configured to receive and provide compressed air to drive dual-acting cylinder-piston 506. With piston rod 508 being fixed to side members 34a and 34b via first and second rod-ends 512 and 510, cylinder-piston 506 travels along the axis of piston rod 508 in the directions as indicated by arrows 520 and 522 in response to compressed air received via first and second rod-ends 510 and 512.

When compressed air is received via second rod-end 512 and expelled via first rod-end 510, cylinder-piston 506 moves within a drive shaft, such as drive shaft 134, in direction 522 and causes first gear elements 514a and 516b and corresponding liner plate 502 and liner face 504 to move in a direction indicated by arrow 524. Conversely, when compressed air is received via first rod-end 510 and expelled via second rod-end 512, cylinder-piston 506 moves within a gear shaft, such as gear shaft 134, in direction 520 and causes first gear elements 514a and 516b and corresponding liner plate 502 and liner face 504 to move in a direction indicated by arrow 526.

In the illustrated embodiment, cylinder-piston 506 and first gear elements 514a and 514b are shown as being substantially cylindrical in shape. However, any suitable shape can be employed. Furthermore, in the illustrated embodiment, cylinder-piston 506 is a double rod-end dual-acting cylinder. In one embodiment, cylinder piston 506 is a single rod-end dual acting cylinder having only a single rod-end 510 coupled to a frame member, such as side member 34b. In such an embodiment, compressed air is provided to cylinder-piston via single rod-end 510 and a flexible pneumatic connection made to cylinder-piston 506 through side member 34a via gear shaft 134. Additionally, cylinder-piston 506 comprises a hydraulic cylinder.

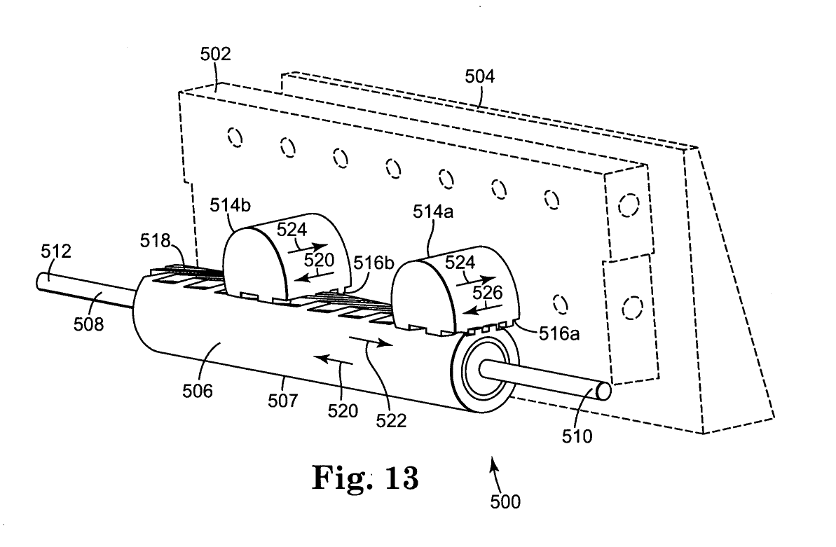

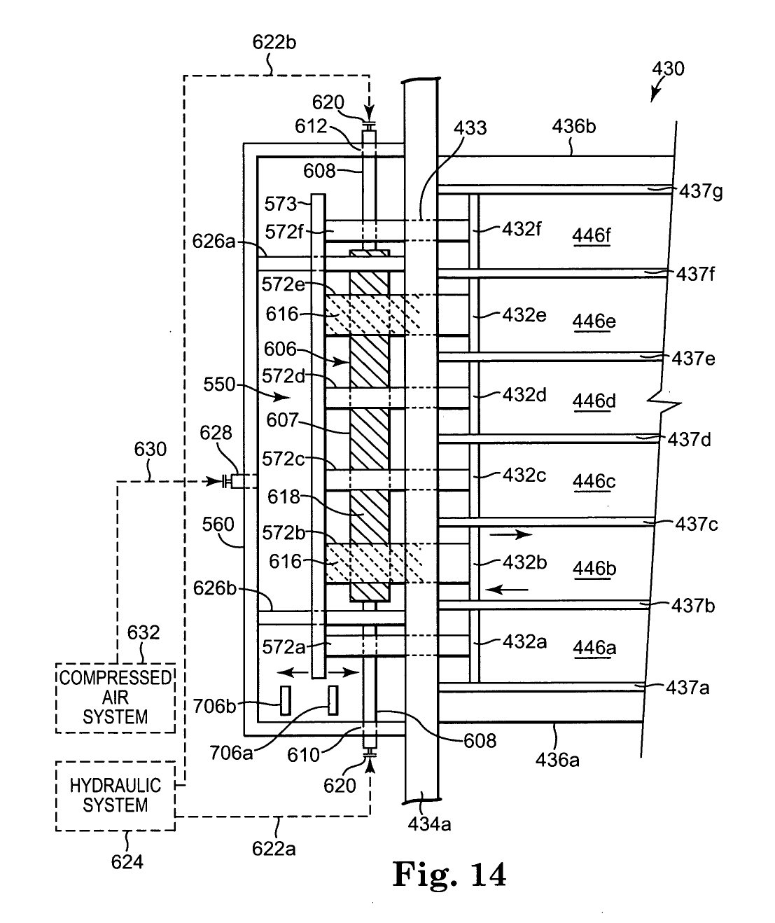

FIG. 14 is a top view of a portion of mold assembly 430 (as illustrated by FIG. 12) having a drive assembly 550 according to one embodiment of the present invention. Drive assembly 550 includes first drive elements 572a to 572f that are selectively coupled to corresponding liner plates 432a to 432f via openings, such as opening 433, in side member 434a. Each of the first drive elements 572a to 572 if further coupled to a master bar 573. Drive assembly 550 further includes a double-rod-end hydraulic piston assembly 606 having a dual-acting cylinder 607 and a hollow piston rod 608 having a first rod-end 610 and a second rod-end 612. First and second rod-ends 610, 612 are stationary and are coupled to and extend through a removable housing 560 that is coupled to side member 434a and encloses drive assembly 550. First and second rod ends 610, 612 are each coupled to hydraulic fittings 620 that are configured to connect via lines 622a and 622b to an external hydraulic system 624 and to transfer hydraulic fluid to and from dual-acting cylinder 607 via hollow piston rod 608.

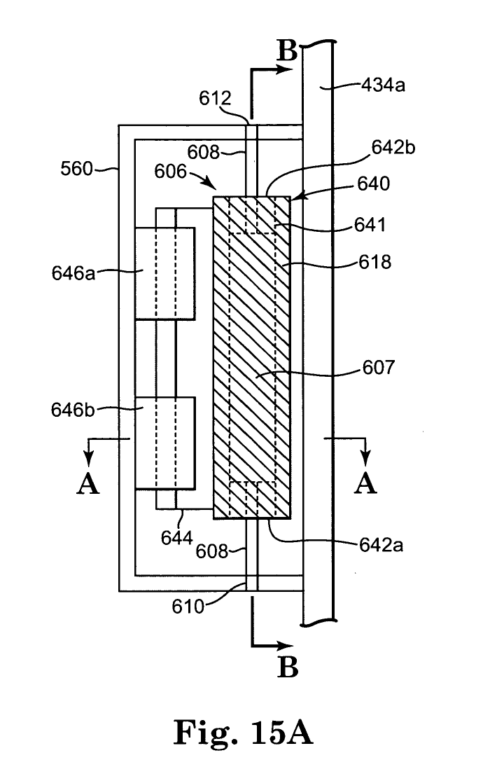

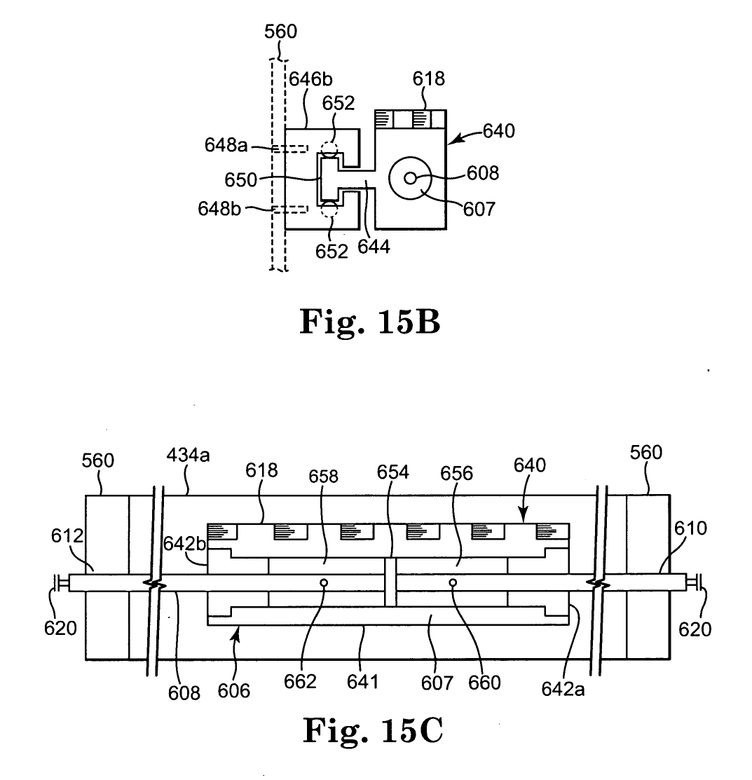

In one embodiment, as illustrated, first drive elements 572b and 572e include a plurality of substantially parallel angled channels 616 that slideably interlock with a plurality of substantially parallel angled channels 618 that form a second drive element. In one embodiment, as illustrated above by FIG. 12, angled channels 618 are formed on dual-acting cylinder 607 of hydraulic piston assembly 606, such that dual-acting cylinder 607 forms the second drive element. In other embodiments, as will be described by FIGS. 15A-15C below, the second drive element is separate from and operatively coupled to dual-acting cylinder 607.

When hydraulic fluid is transmitted into dual-acting cylinder 607 from second rod-end 612 via fitting 620 and hollow piston rod 608, hydraulic fluid is expelled from first rod-end 610, causing dual-acting cylinder 607 and angled channels 618 to move along piston rod 608 toward second rod-end 612. As dual-acting cylinder 607 moves toward second rod-end 612, angled channels 618 interact with angled channels 616 and drive first drive elements 572b and 572e, and thus corresponding liner plates 432b and 432e, toward the interior of mold cavities 446b and 446e, respectively. Furthermore, since each of the first drive elements 572a through 572f is coupled to master bar 573, driving first gear elements 572b and 572e toward the interiors of mold cavities 446b and 446e also moves first drive elements 572a, 572c, 572d, and 572f and corresponding liner plates 432a, 432c, 432d, and 432e toward the interiors of mold cavities 446a, 446c, 446d, and 446f, respectively. Conversely, transmitting hydraulic fluid into dual-acting cylinder 607 from first rod-end 610 via fitting 620 and hollow-piston rod 608 causes dual-acting cylinder 607 to move toward first rod-end 610, and causes liner plates 432 to move away from the interiors of corresponding mold cavities 446.

In one embodiment, drive assembly 550 further includes support shafts 626, such as support shafts 626a and 626b, which are coupled between removable housing 560 and side member 434a and extend through master bar 573. As dual-acting cylinder 607 is moved by transmitting/expelling hydraulic fluid from first and second rod-ends 610, 612, master bar 573 moves back and forth along support shafts 626. Because they are coupled to static elements of mold assembly 430, support shafts 626a and 626b provide support and rigidity to liner plates 432, drive elements 572, and master bar 573 as they move toward and away from mold cavities 446.

In one embodiment, drive assembly 550 further includes a pneumatic fitting 628 configured to connect via line 630 to and external compressed air system 632 and provide compressed air to housing 560. By receiving compressed air via pneumatic fitting 628 to removable housing 560, the internal air pressure of housing 560 is positive relative to the outside air pressure, such that air is continuously “forced” out of housing 560 through any non-sealed openings, such as openings 433 through which first drive elements 572 extend through side member 434a. By maintaining a positive air pressure and forcing air out through such non-sealed opening, the occurrence of dust and debris and other unwanted contaminants from entering housing 560 and fouling drive assembly 550 is reduced.

First and second rod ends 610, 612 are each coupled to hydraulic fittings 620 that are configured to connect via lines 622a and 622b to an external hydraulic system 624 and to transfer hydraulic fluid to and from dual-acting cylinder 607 via hollow piston rod 608.

FIG. 15A is a top view illustrating a portion of one embodiment of drive assembly 550 according to the present invention. Drive assembly 550 includes double-rod-end hydraulic piston assembly 606 comprising dual-acting cylinder 607 and a hollow piston rod 608 with first and second rod-ends 610 and 612 being and coupled to and extending through removable housing 560.

As illustrated, dual-acting cylinder 607 is slideably-fitted inside a machined opening 641 within a second gear element 640, with hollow piston rod 608 extending through removable end caps 642. In one embodiment, end caps 646 are threadably inserted into machined opening 641 such that end caps 646 butt against and secure dual-acting cylinder 607 so that dual-acting cylinder 607 is held stationary with respect to second drive element 640. Second drive element 640 includes the plurality of substantially parallel angled channels 618, in lieu of angled channels being an integral part of dual-acting cylinder 607. With reference to FIG. 14, angled channels 618 of second gear element 640 are configured to slideably interlock with angled channels 616 of first gear elements 572b and 572e.

Second gear element 640 further includes a guide rail 644 that is slideably coupled to linear bearing blocks 646 that are mounted to housing 560. As described above with respect to FIG. 14, transmitting and expelling hydraulic fluid to and from dual-acting cylinder 607 via first and second rod-ends 610, 612 causes dual-acting cylinder 607 to move along hollow piston-rod 608. Since dual-acting cylinder 607 is “locked” in place within machined shaft 641 of second gear element 640 by end caps 642, second gear element 640 moves along hollow piston-rod 608 together with dual-acting cylinder 607. As second drive element 640 moves along hollow piston-rod 608, linear bearing blocks 646 guide and secure guide rail 644, thereby guiding and securing second drive element 640 and reducing undesirable motion in second drive element 640 that is perpendicular to hollow piston rod 608.

FIG. 15B is a lateral cross-sectional view A-A of the portion of drive assembly 550 illustrated by FIG. 15A. Guide rail 644 is slideably fitted into a linear bearing track 650 and rides on bearings 652 as second drive element 640 is moved along piston rod 608 by dual-acting cylinder 607. In one embodiment, linear bearing block 646b is coupled to housing 560 via bolts 648.

FIG. 15C is a longitudinal cross-sectional view B-B of the portion of drive assembly 550 of FIG. 15A, and illustrates dual-acting cylinder 607 as being secured within shaft 641 of drive element 640 by end caps 642a and 642b. In one embodiment, end caps 642a and 642b are threadably inserted into the ends of second drive element 640 so as to butt against each end of dual-acting cylinder 607. Hollow piston rod 608 extends through end caps 642a and 642b and has first and second rod ends 610 and 612 coupled to and extending through housing 560. A divider 654 is coupled to piston rod 608 and divides dual-acting cylinder 607 into a first chamber 656 and a second chamber 658. A first port 660 and a second port 662 allow hydraulic fluid to be pumped into and expelled from first chamber 656 and second chamber 658 via first and second rod ends 610 and 612 and associated hydraulic fittings 620, respectively.

When hydraulic fluid is pumped into first chamber 656 via first rod-end 610 and first port 660, dual-acting cylinder 607 moves along hollow piston rod 608 toward first rod-end 610 and hydraulic fluid is expelled from second chamber 658 via second port 662 and second rod-end 612. Since dual-acting cylinder 607 is secured within shaft 641 by end caps 642a and 642b, second drive element 640 and, thus, angled channels 618 move toward first rod-end 610. Similarly, when hydraulic fluid is pumped into second chamber 658 via second rod-end 612 and second port 662, dual-acting cylinder 607 moves along hollow piston rod 608 toward second rod-end 612 and hydraulic fluid is expelled from first chamber 656 via first port 660 and first rod-end 610.

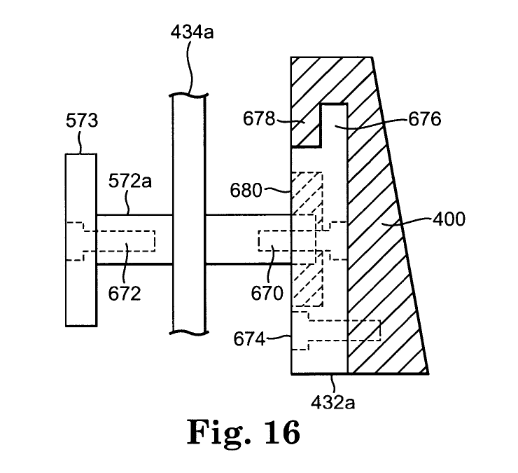

FIG. 16 is a side view of a portion of drive assembly 550 as shown by FIG. 14 and illustrates a typical liner plate, such as liner plate 432a, and corresponding removable liner face 400. Liner plate 432a is coupled to second drive element 572a via a bolted connection 670 and, in-turn, drive element 572a is coupled to master bar 573 via a bolted connection 672. A lower portion of liner face 400 is coupled to liner plate 432a via a bolted connection 674. In one embodiment, as illustrated, liner plate 432a includes a raised “rib” 676 that runs the length of and along an upper edge of liner plate 432a. A channel 678 in liner face 400 overlaps and interlocks with raised rib 676 to form a “boltless” connection between liner plate 432a and an upper portion of liner face 400. Such an interlocking connection securely couples the upper portion of liner face 400 to liner plate 432 in an area of liner face 400 that would otherwise be too narrow to allow use of a bolted connection between liner face 400 and liner plate 432a without the bolt being visible on the surface of liner face 400 that faces mold cavity 446a.

In one embodiment, liner plate 432 includes a heater 680 configured to maintain the temperature of corresponding liner face 400 at a desired temperature to prevent concrete in corresponding mold cavity 446 sticking to a surface of liner face 400 during a concrete curing process. In one embodiment, heater 680 comprises an electric heater.

FIG. 17 is a block diagram illustrating one embodiment of a mold assembly according to the present invention, such as mold assembly 430 of FIG. 14, further including a controller 700 configured to coordinate the movement of moveable liner plates, such as liner plates 432, with operations of concrete block machine 702 by controlling the operation of the drive assembly, such as drive assembly 550. In one embodiment, as illustrated, controller 700 comprises a programmable logic controller (PLC).

As described above with respect to FIG. 1, mold assembly 430 is selectively coupled, generally via a plurality of bolted connections, to concrete block machine 702. In operation, concrete block machine 702 first places pallet 56 below mold box assembly 430. A concrete feedbox 704 then fills mold cavities, such as mold cavities 446, of assembly 430 with concrete. Head shoe assembly 52 is then lowered onto mold assembly 430 and hydraulically or mechanically compresses the concrete in mold cavities 446 and, together with a vibrating table on which pallet 56 is positioned, simultaneously vibrates mold assembly 430. After the compression and vibration is complete, head shoe assembly 52 and pallet 56 are lowered relative to mold cavities 446 so that the formed concrete blocks are expelled from mold cavities 446 onto pallet 56. Head shoe assembly 52 is then raised and a new pallet 56 is moved into position below mold cavities 446. The above process is continuously repeated, with each such repetition commonly referred to as a cycle. With specific reference to mold assembly 430, each such cycle produces six concrete blocks.

PLC 700 is configured to coordinate the extension and retraction of liner plates 432 into and out of mold cavities 446 with the operations of concrete block machine 702 as described above. At the start of a cycle, liner plates 432 are fully retracted from mold cavities 446. In one embodiment, with reference to FIG. 14, drive assembly 550 includes a pair of sensors, such as proximity switches 706a and 706b to monitor the position of master bar 573 and, thus, the positions of corresponding moveable liner plates 432 coupled to master bar 573. As illustrated in FIG. 14, proximity switches 706a and 706b are respectively configured to detect when liner plates 432 are in an extended position and a retracted position with respect to mold cavities 446.

In one embodiment, after pallet 56 has been positioned beneath mold assembly 430, PLC 700 receives a signal 708 from concrete block machine 702 indicating that concrete feedbox 704 is ready to deliver concrete to mold cavities 446. PLC 700 checks the position of moveable liners 432 based on signals 710a and 710b received respectively from proximity switches 706a and 706b. With liner plates 432 in a retracted position, PLC 700 provides a liner extension signal 712 to hydraulic system 624.

In response to liner extension signal 712, hydraulic system 624 begins pumping hydraulic fluid via path 622b to second rod-end 612 of piston assembly 606 and begins receiving hydraulic fluid from first rod-end 610 via path 622a, thereby causing dual-acting cylinder 607 to begin moving liner plates 432 toward the interiors of mold cavities 446. When proximity switch 706a detects master bar 573, proximity switch 706a provides signal 710a to PLC 700 indicating that liner plates 432 have reached the desired extended position. In response to signal 710a, PLC 700 instructs hydraulic system 624 via signal 712 to stop pumping hydraulic fluid to piston assembly 606 and provides a signal 714 to concrete block machine 702 indicating that liner plates 432 are extended.

In response to signal 714, concrete feedbox 704 fills mold cavities 446 with concrete and head shoe assembly 52 is lowered onto mold assembly 430. After the compression and vibrating of the concrete is complete, concrete block machine 702 provides a signal 716 indicating that the formed concrete blocks are ready to be expelled from mold cavities 446. In response to signal 716, PLC 700 provides a liner retraction signal 718 to hydraulic system 624.

In response to liner retraction signal 718, hydraulic system 624 begins pumping hydraulic fluid via path 622a to first rod-end 610 via path 622 and begins receiving hydraulic fluid via path 622b from second rod-end 612, thereby causing dual-acting cylinder 607 to begin moving liner plates 432 away from the interiors of mold cavities 446. When proximity switch 706b detects master bar 573, proximity switch 706b provides signal 710b to PLC 700 indicating that liner plates 432 have reached a desired retracted position. In response to signal 710b, PLC 700 instructs hydraulic system 624 via signal 718 to stop pumping hydraulic fluid to piston assembly 606 and provides a signal 720 to concrete block machine 702 indicating that liner plates 432 are retracted.

In response to signal 720, head shoe assembly 52 and pallet 56 eject the formed concrete blocks from mold cavities 446. Concrete block machine 702 then retracts head shoe assembly 52 and positions a new pallet 56 below mold assembly 430. The above process is then repeated for the next cycle.

In one embodiment, PLC 700 is further configured to control the supply of compressed air to mold assembly 430. In one embodiment, PLC 700 provides a status signal 722 to compressed air system 630 indicative of when concrete block machine 702 and mold assembly 430 are in operation and forming concrete blocks. When in operation, compressed air system 632 provides compressed air via line 630 and pneumatic fitting 628 to housing 560 of mold assembly 420 to reduce the potential for dirt/dust and other debris from entering drive assembly 550. When not in operation, compressed air system 632 does not provide compressed air to mold assembly 430.

Although the above description of controller 700 is in regard to controlling a drive assembly employing only a single piston assembly, such as piston assembly 606 of drive assembly 500, controller 700 can be adapted to control drive assemblies employing multiple piston assemblies and employing multiple pairs of proximity switches, such as proximity switches 706a and 706b. In such instances, hydraulic system 624 would be coupled to each piston assembly via a pair of hydraulic lines, such as lines 622a and 622b. Additionally, PLC 700 would receive multiple position signals and would respectively allow mold cavities to be filled with concrete and formed blocks to be ejected only when each applicable proximity switch indicates that all moveable liner plates are at their extended position and each applicable proximity switch indicates that all moveable liner plates are at their retracted position.

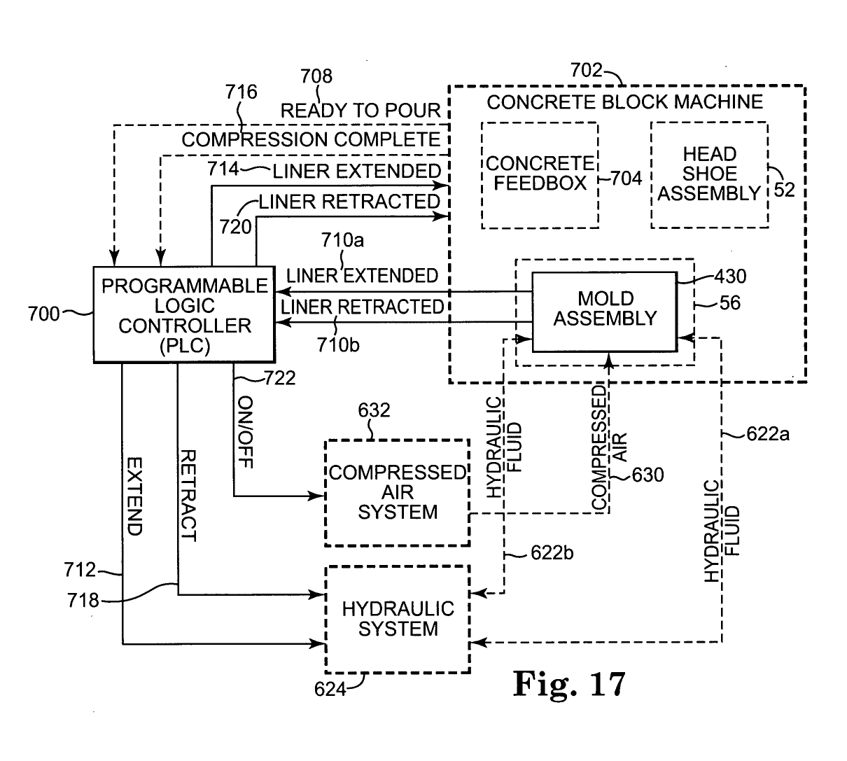

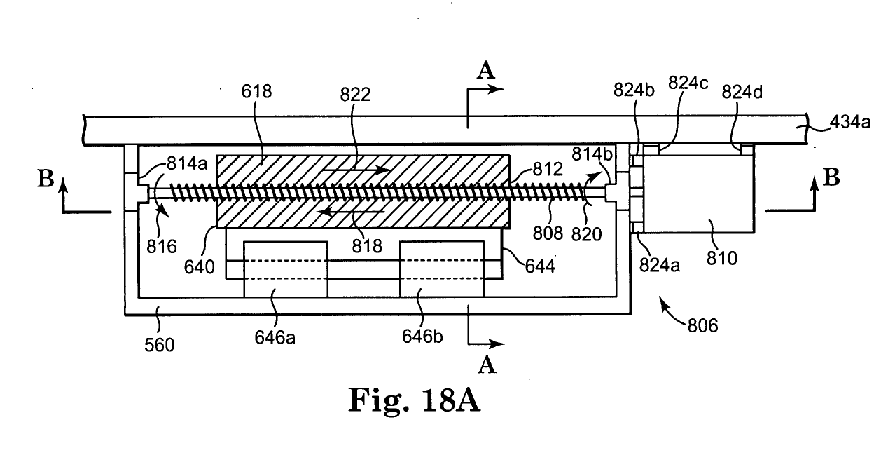

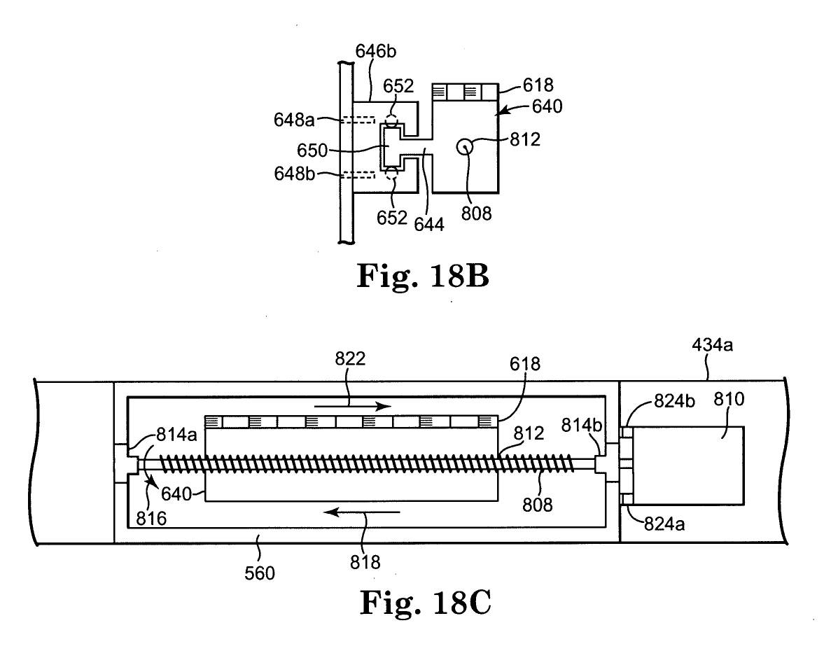

FIGS. 18A through 18C illustrate portions of an alternate embodiment of drive assembly 550 as illustrated by FIGS. 15A through 15C. FIG. 18A is top view of second gear element 640, wherein second gear element 640 is driven by a screw drive system 806 in lieu of a piston assembly, such as piston assembly 606. Screw drive system 806 includes a threaded screw 808, such as an Acme or Ball style screw, and an electric motor 810. Threaded screw 808 is threaded through a corresponding threaded shaft 812 extending lengthwise through second gear element 640. Threaded screw 808 is coupled at a first end to a first bearing assembly 814a and is coupled at a second end to motor 810 via a second bearing assembly 814b. Motor 810 is selectively coupled via motor mounts 824 to housing 560 and/or to the side/cross members, such as cross member 434a, of the mold assembly.

In a fashion similar to that described by FIG. 15A, second gear element 640 includes the plurality of angled channels 618 which slideably interlock and mesh with angled channels 616 of first gear elements 572b and 572e, as illustrated by FIG. 14. Since second gear element 640 is coupled to linear bearing blocks 646, when motor 810 is driven to rotate threaded screw 808 in a counter-clockwise direction 816, second gear element 640 is driven in a direction 818 along linear bearing track 650. As second gear element 640 moves in direction 818, angled channels 618 interact with angled channels 616 and extend liner plates, such as liner plates 432a through 432f illustrated by FIGS. 12 and 14, toward the interior of mold cavities 446a through 446f.

When motor 810 is driven to rotate threaded screw 808 in a clockwise direction 820, second gear element 640 is driven in a direction 822 along linear bearing track 650. As second gear element 640 moves in direction 822, angled channels 618 interact with angled channels 616 and retract liner plates, such as liner plates 432a through 432f illustrated by FIGS. 12 and 14, away from the interior of mold cavities 446a through 446f. In one embodiment, the distance the liner plates are extended and retracted toward and away from the interior of the mold cavities is controlled based on the pair of proximity switches 706a and 706b, as illustrated by FIG. 14. In an alternate embodiment, travel distance of the liner plates is controlled based on the number of revolutions of threaded screw 808 is driven by motor 810.

FIGS. 18B and 18C respectively illustrate lateral and longitudinal cross-sectional views A-A and B-B of drive assembly 550 as illustrated by FIG. 18A. Although illustrated as being located external to housing 560, in alternate embodiments, motor 810 is mounted within housing 560.

As described above, concrete blocks, also referred to broadly as concrete masonry units (CMUs), encompass a wide variety of types of blocks such as, for example, patio blocks, pavers, light weight blocks, gray blocks, architectural units, and retaining wall blocks. The terms concrete block, masonry block, and concrete masonry unit are employed interchangeably herein, and are intended to include all types of concrete masonry units suitable to be formed by the assemblies, systems, and methods of the present invention. Furthermore, although described herein primarily as comprising and employing concrete, dry-cast concrete, or other concrete mixtures, the systems, methods, and concrete masonry units of the present invention are not limited to such materials, and are intended to encompass the use of any material suitable for the formation of such blocks.

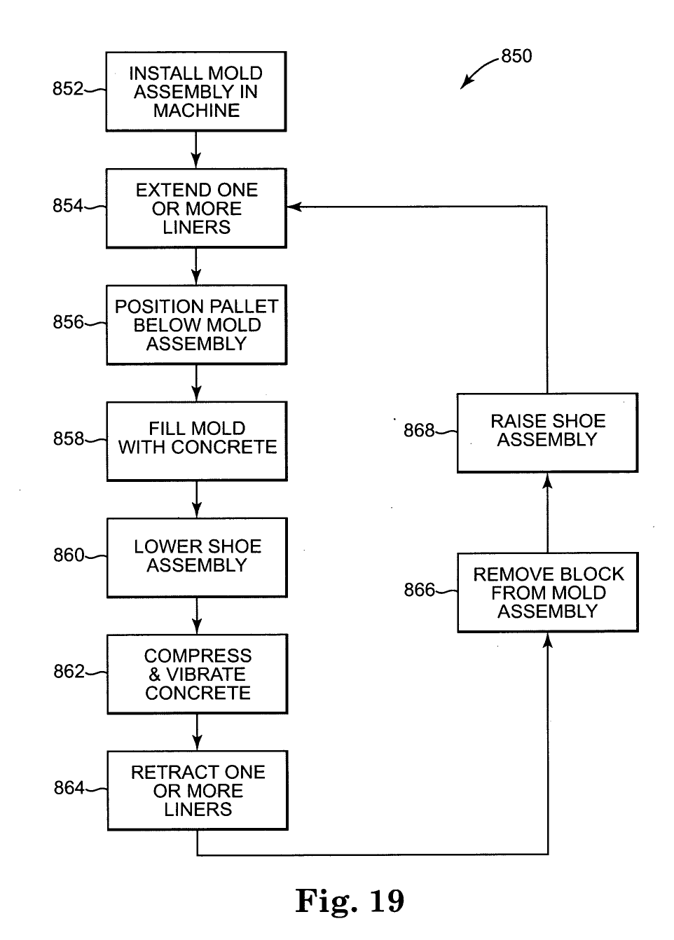

FIG. 19 is flow diagram illustrating one exemplary embodiment of a process 850 for forming a concrete block employing a mold assembly according to the present invention, with reference to mold assembly 30 as illustrated by FIG. 1. Process 850 begins at 852, where mold assembly 30 is bolted, such as via side members 34a and 34b, to a concrete block machine. For ease of illustration, the concrete block machine is not shown in FIG. 1. Examples of concrete block machines for which mold assembly is adapted for use include models manufactured by Columbia and Besser. In one embodiment, installation of mold assembly 30 in the concrete block machine at 852 further includes installation of a core bar assembly (not shown in FIG. 1, but known to those skilled in the art), which is positioned within mold cavity 46 to create voids within the formed block in accordance with design requirements of a particular block. In one embodiment, mold assembly 30 further includes head shoe assembly 52, which is also bolted to the concrete block machine at 852.

At 854, one or more liner plates, such as liner plates 32a through 32d, are extended a desired distance to form a mold cavity 46 having a negative of a desired shape of the concrete block to be formed. As will be described in further detail below, the number of moveable liner plates may vary depending on the particular implementation of mold assembly 30 and the type of concrete block to be formed. At 856, after the one or more liners plates have been extended, the concrete block machine raises a vibrating table on which pallet 56 is located such that pallet 56 contacts mold assembly 30 and forms a bottom to mold cavity 46.

At 858, the concrete block machine moves a feedbox drawer (not illustrated in FIG. 1) into position above the open top of mold cavity 46 and fills mold cavity 46 with a desired concrete mixture. After mold cavity 46 has been filled with concrete, the feedbox drawer is retracted, and concrete block machine, at 860, lowers head shoe assembly 52 onto mold cavity 46. Head shoe assembly 52 configured to match the dimensions and other unique configurations of each mold cavity, such as mold cavity 46.

At 862, the concrete block machine then compresses (e.g. hydraulically or mechanically) the concrete while simultaneously vibrating mold assembly 30 via the vibrating table on which pallet 56 is positioned. The compression and vibration together causes concrete to substantially fill any voids within mold cavity 46 and causes the concrete quickly reach a level of hardness (“pre-cure”) that permits removal of the formed concrete block from mold cavity 46.

At step 864, the one or more moveable liner plates 32 are retracted away from the interior of mold cavity 46. After the liner plates 32 are retracted, the concrete block machine removes the formed concrete block from mold cavity 46 by moving head shoe assembly 52 along with the vibrating table and pallet 56 downward while mold assembly 30 remains stationary. The head shoe assembly, vibrating table, and pallet 56 are lower until a lower edge of head shoe assembly 52 drops below a lower edge of mold cavity 46 and the formed block is ejected from mold cavity 46 onto pallet 56. A conveyor system (not shown) then moves pallet 56 carrying the formed block away from the concrete block machine to an area (e.g. an oven) for final curing. Head shoe assembly 56 is raised to the original start position at 868, and process 850 returns to 854 where the above described process is repeated to create additional concrete blocks.

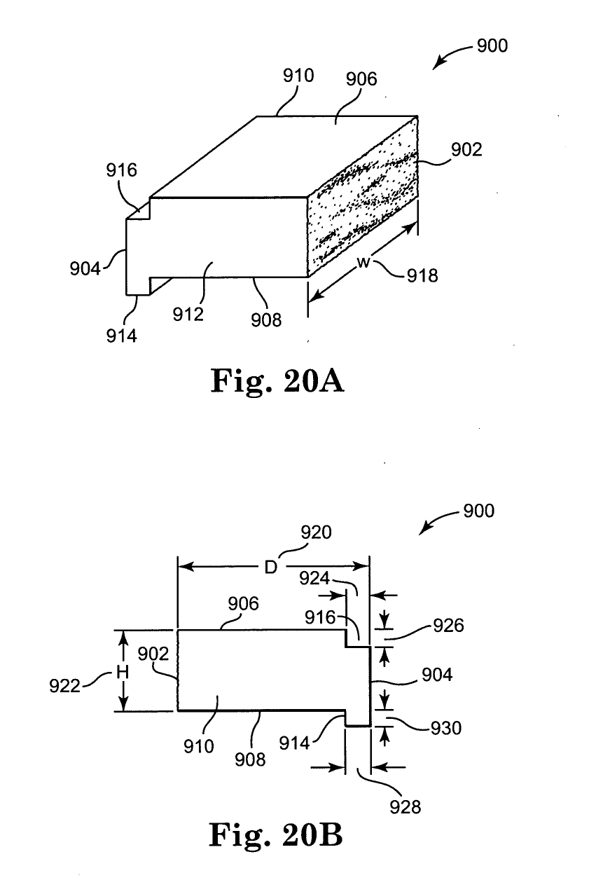

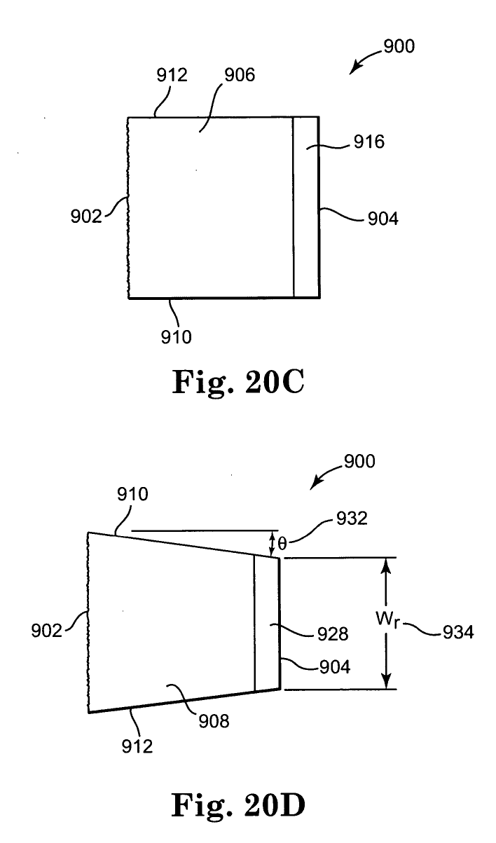

FIGS. 20A through 20D illustrate examples of a masonry block 900 according to the present invention. FIG. 20A is a perspective view of masonry block 900. Masonry block 900 includes a front face 902, a rear face 904, an upper face 906, a lower face 908, and opposed side faces 910 and 912. As illustrated, front face 902 includes a desired three-dimensional texture or pattern which is imparted to front face 902 by a moveable liner plate, such as moveable liner 32b (see FIG. 1), which includes a negative of the desired three-dimensional texture or pattern. The desired three-dimensional texture or pattern can be nearly any texture or pattern, such as, for example, natural stone(s), stones stacked in layers, multiple stones which have been mortared together, text, and any number of desired graphics.

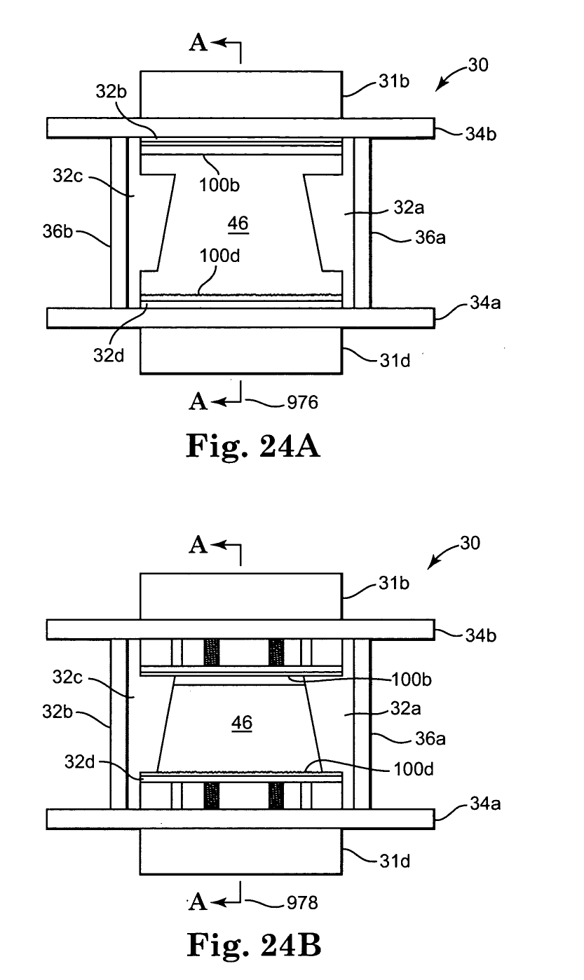

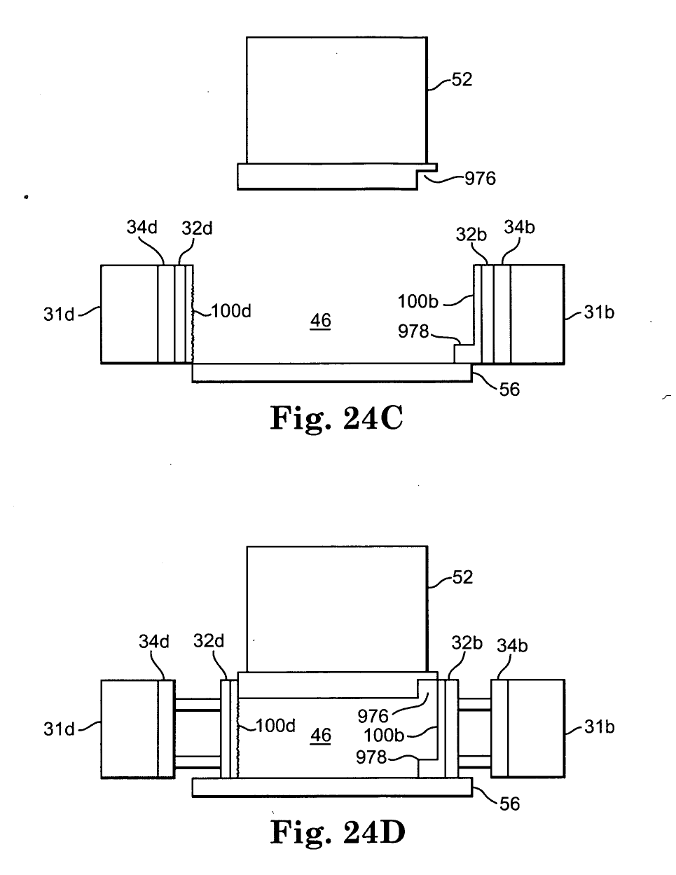

Masonry block 900 further includes a flange 914 and a notch 916. Flange 914 extends from lower face 908 along an edge shared with rear face 904. Notch 916 extends across upper face 906 along an edge shared with rear face 904. As described in more detail below by FIGS. 24A through 24D, flange 914 is formed through action of a moveable shoe assembly and a moveable liner plate, and notch 916 is formed by the moveable liner plate in cooperation with a pallet.

FIG. 20B is a side view of masonry block 900 of FIG. 20A. Masonry block 900 has a width (W) 918 (see FIG. 20A), a depth (D) 920, and a height (H) 922. Notch 916 has a width 924 and a depth 926, and flange 914 has a width 928 and a height 930, wherein the depth 926 of notch 916 is at least equal to the height 930 of flange 914. In one embodiment, as illustrated by FIG. 20B, the width 928 of flange 914 is equal to the width 924 of notch 916. Masonry block 900 can be formed with a plurality of dimensions, including standard dimensions such as, for example, 4″(H)×12″(D)×9″(W), 6″(H)×10″(D)×12″(W), and 8″(H)×12″(D)×18″(W). Additionally, although illustrated as being of solid construction, masonry block 900 can also be formed with one or more hollow cores using core assemblies as generally understood by those skilled in the art.

FIGS. 20C and 20D respectively illustrate top and bottom views of masonry block 900 of FIGS. 20A and 20B. In one embodiment, as illustrated by FIG. 20C, opposed side faces 910, 912 are generally parallel with one another and extend perpendicularly between front face 902 and rear face 904. In one embodiment, as illustrated by FIG. 20D, opposed side faces 910, 912 are angled inwardly from front face 902 to rear face 904 at an angle (θ) 932, such that a width (Wr) 934 of rear face 904 is less than W 918 of front face 902. In another embodiment (not illustrated), only one of the opposed side faces 910, 912 is inwardly angled from front face 902 to rear face 904.

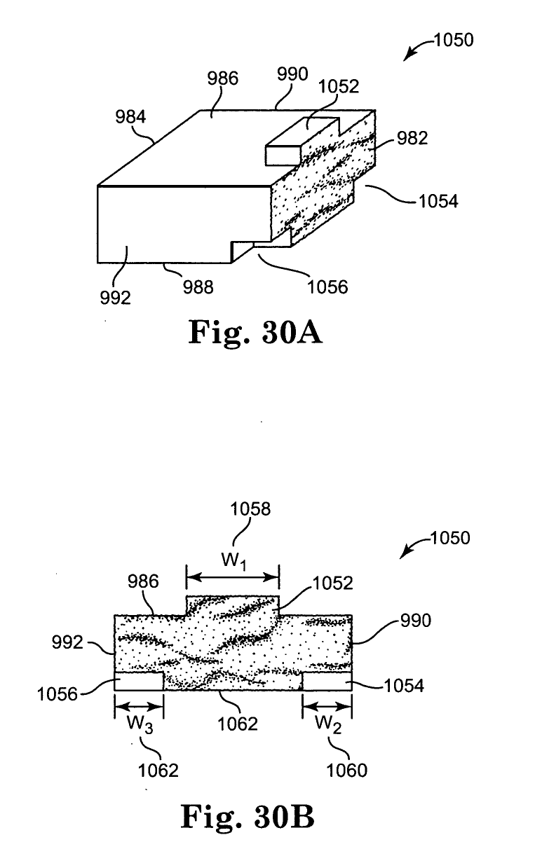

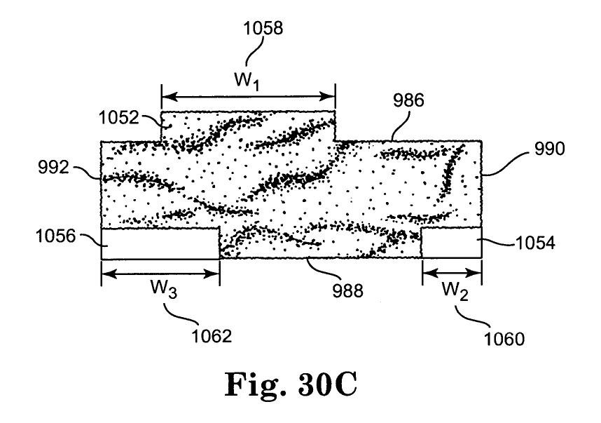

As illustrated by FIGS. 20C and 20D, flange 914 and notch 916 extend the entire distance between opposed side faces 910, 912. However, as will be described in greater detail below with respect to FIGS. 30A through 30C, flange 914 and notch 916 need not extend the entire distance. For example, flange 914 could extend for only a portion of the distance and be spaced from opposed side faces 910, 912 with notch 916 comprising two notch portions separated from one another and extending a corresponding distance from each side face 910, 912.

Masonry blocks 900 are adapted to be stacked in courses to form various structures including landscape structures such as soil retention walls and raised planting beds, for example. As such, lower face 908 of masonry block 900 is adapted to engage an upper face 906 of a similar masonry block in a course of blocks below masonry block 900 so as to maintain a generally parallel relationship between upper faces 906 of adjacent courses of blocks. Furthermore, flange 914 of masonry block 900 is configured to interlock with a notch 916 of at least one masonry block in the course below masonry block 900 so that each successive course of blocks is interlocked with the preceding course of blocks of the structure. Such interlocking between courses of blocks provides shear strength and stability to the structure, as well as a means for maintaining alignment between blocks. Masonry blocks 900 having at least one inwardly angled opposed side face 910, 912, as described above by FIG. 20D, enable the construction of curved structures.

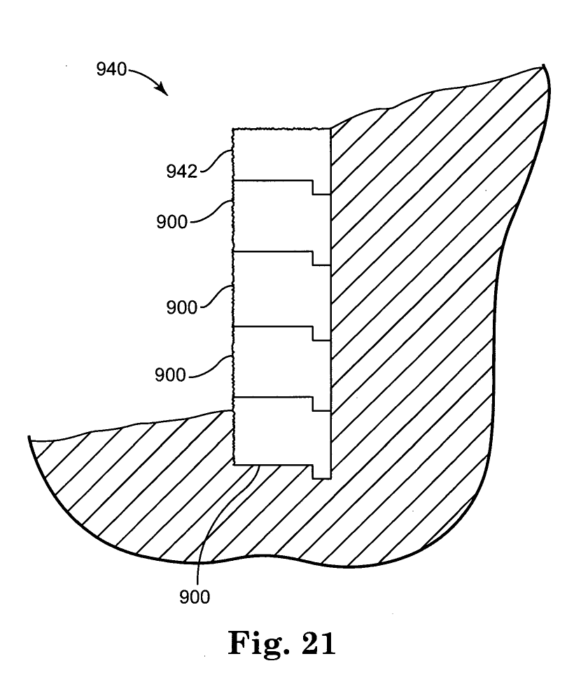

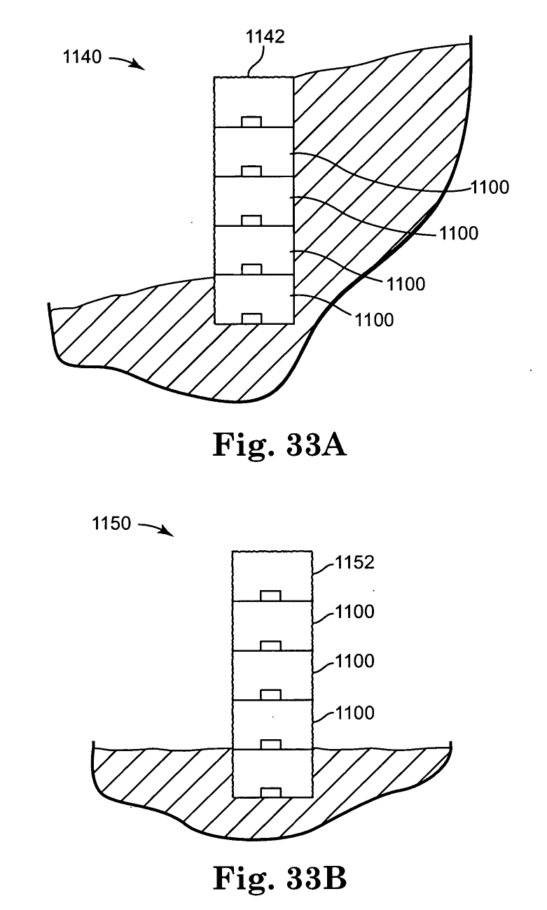

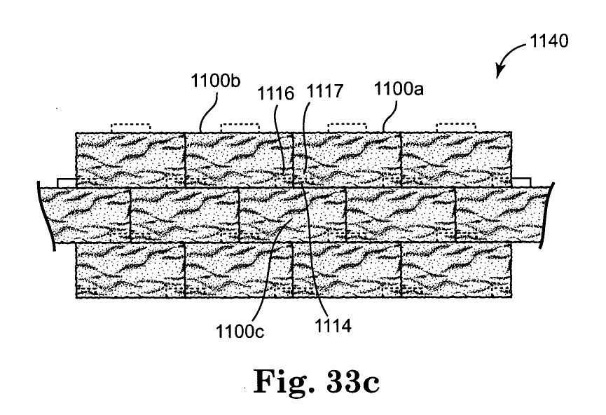

FIG. 21 illustrates a cross-section of an example soil retention wall 940 employing masonry blocks 900 as described above by FIGS. 20A through 20D. As illustrated, the width 928 of flange 914 is equal to the width 924 of notch 916 (see FIG. 20B) such that soil retention wall 940 is substantially vertical when flanges 914 of each successive course of blocks is interlocked with notches 916 of previous courses of blocks. Although illustrated as being employed to form a soil retention wall 940, masonry blocks 900 as described by FIGS. 20A through 20D can also be employed to form free-standing walls or structures (see FIG. 33B below for an example of a free-standing wall).

FIG. 21 further illustrates use of what is commonly referred to as a “cap” block 942. Cap block 942 has an upper surface having a desired three-dimensional texture or pattern in lieu of a notch, such as notch 916. An example of such a cap block is described by U.S. patent application Ser. No. 11/036,275 entitled “Masonry Blocks and Method and System of Making Masonry Blocks”, having Attorney Docket No. H295.106.101.

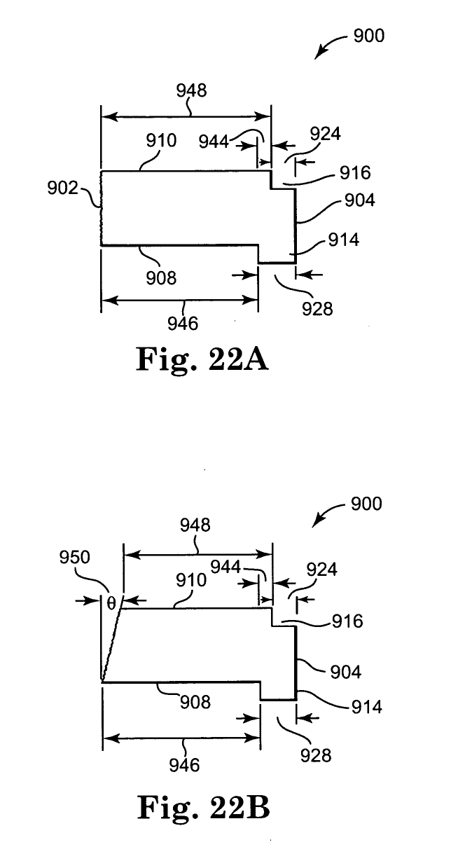

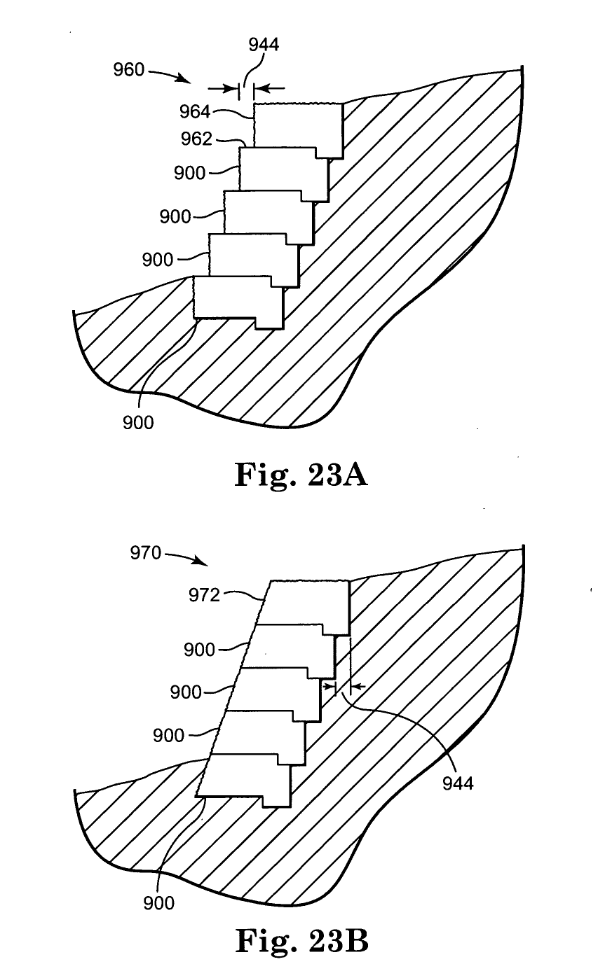

FIGS. 22A and 22B illustrate side views of alternate embodiments of masonry block 900 described above by FIGS. 20A through 20D. As illustrated by FIGS. 22A and 22B, in one embodiment, the width 928 of flange 914 exceeds the width 924 of notch 916 by a set-back distance 944. As illustrated below by FIGS. 23A and 23B, such a configuration causes each successive course of blocks of the structure to be set back from the preceding course of blocks by the set-back distance 944, thereby providing the structure with additional shear strength.

In one embodiment, as illustrated by FIG. 22A, front face 902 is generally vertical relative to lower face 908 and upper face 906 such that a depth 948 of upper face 906 from front face 902 to notch 916 is greater than a depth 946 of lower face 908 from front face 902 to flange 914 by an amount substantially equal to set-back depth 944. In one embodiment, as illustrated by FIG. 22B, front face 902 is angled inwardly at an angle (θ) 950 toward rear face 902 as it extends from lower face 908 to upper face 910, such that the depth 948 of upper face 910 from front face 902 to notch 916 is substantially equal to the depth 946 of lower face 908 from front face 902 to flange 914.

FIG. 23A illustrates an example soil retention wall 960 employing masonry blocks 900 as described above by FIG. 22A. As illustrated, the width 928 of flange 914 is greater than the width 924 of notch 916 (see FIG. 22A) so that of each successive course of blocks is set back from the preceding course of blocks by set-back distance 944. However, since the front face of each masonry block is generally vertical relative to the rear face, a portion of the upper face of each block in a lower course is visible between front face of each block in the lower course and the front face of each block in the adjacent upper course. These visible portions of the upper faces of each block create the appearance of a ledge, as illustrated at 962. Such a ledge can be undesirable, especially when trying to create a structure having a natural appearance. A cap block, as previously described with regard to FIG. 21, is illustrated at 964.

FIG. 23B illustrates an example soil retention wall 970 employing masonry blocks 900 as described above by FIG. 22B. As illustrated, the width 928 of flange 914 is greater than the width 924 of notch 916 (see FIG. 22A) so that of each successive course of blocks is set-back from the preceding course of blocks by set-back distance 944. However, since the front face of each masonry block is inwardly angled relative to the rear face, ledge 962, as illustrated by FIG. 23B, is substantially eliminated, thereby providing soil retention wall 970 with a more uniform slope and more natural appearance. A cap block, as previously described with regard to FIG. 21, is illustrated at 972.

FIGS. 24A through 24D are simplified illustrations of one exemplary implementation of mold assembly 30 configured to from masonry block 900 as described above by FIGS. 20A and 20B. Mold assembly 30 includes side members 34a, 34b, cross-members 36a, 36b, stationary liner plates 32a, 32c, and moveable liner plates 32b, 32d. Drive assemblies 31b, 31d are respectively coupled to moveable liner plates 32b, 32d and configured to extend and retract moveable liner plates 32b, 32d toward and away from the interior of mold cavity 46. Liner faces 100b, 100d are respectively coupled to moveable liners 32b, 32d. Liner face 100b comprises a negative of notch 916 to be formed in upper surface 910 and liner face 100d comprises a negative of the desired three-dimensional texture or pattern to be imprinted on front face 902 of masonry block 900 (see FIGS. 20A and 20B).

FIG. 24A illustrates liner plates 32b, 32d in their retracted positions. Upon extending moveable liner plates 32b, 32d and associated liner faces 100b, 100d to an extended position toward the interior of mold cavity 46, as illustrated by FIG. 24B, mold assembly 30 receives concrete and forms a masonry block, such as masonry block 900, as described generally by process 850 of FIG. 19.

Alternatively, in lieu of employing liner faces 10b, 10d, the negative of notch 916 and the desired three-dimensional texture or pattern may be integrally included as portions of moveable liners plates 32b, 32d, respectively. Additionally, although not illustrated, a core bar assembly can be positioned within mold cavity 46 to form hollow cores in masonry block 900.

FIGS. 24C and 24D respectively illustrate simpliefied cross-sections A-A 976, 978 of mold assembly 30 as illustrated by FIGS. 20A and 20B, and further illustrate head shoe assembly 52 and pallet 56. FIGS. 24C and 24D respectively illustrate liner plates 32b, 32d, liner faces 10b, 10d, and shoe assembly 52 in their retracted positions and in their extended positions after concrete has been introduced to mold cavity 46 (as described generally by process 850 of FIG. 19). Head shoe assembly 52 includes a notch 976 that cooperates with moveable liner plate 32b and associated liner face 100b to form flange 914 which extends from lower face 908 of masonry block 900. Liner face 100b includes a notch element 978 that is the negative of notch 916, which cooperates with pallet 56 to from notch 916 which extends across the upper face 906 of masonry block 900 from opposed side faces 910, 912 (see FIGS. 20A and 20B). As illustrated, liner face 100d includes a negative of a desired three-dimensional texture or pattern to be imprinted on front surface 902 of masonry block 900.

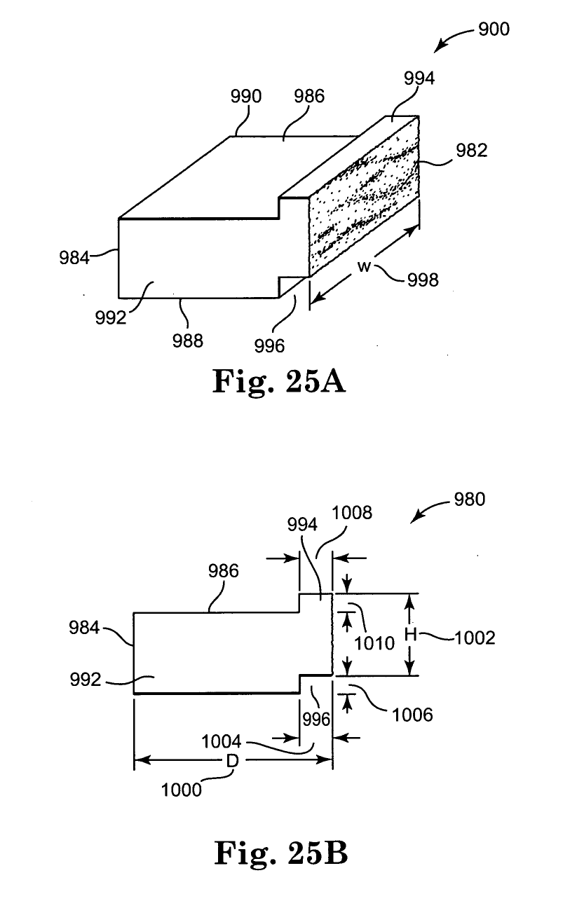

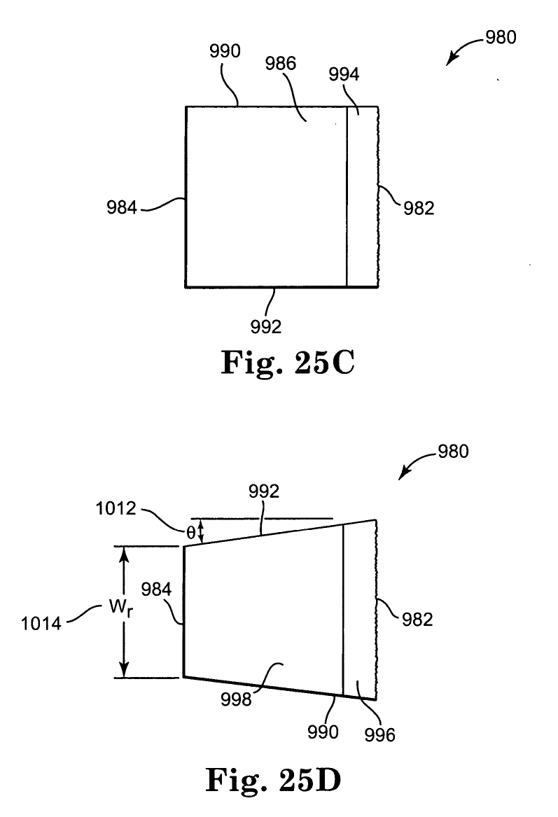

FIGS. 25A through 25D illustrate examples of a masonry block 980 according to the present invention. FIG. 25A is a perspective view of masonry block 980. Masonry block 980 includes a front face 982, a rear face 984, an upper face 986, a lower face 988, and opposed side faces 990 and 992. As illustrated, front face 982 includes a desired three-dimensional texture or pattern which is imparted to front face 982 by a moveable liner plate, such as liner plate 32d (see FIG. 1), which includes a negative of the desired three-dimensional texture or pattern. The desired three-dimensional texture or pattern can be nearly any texture or pattern such as, for example, natural stone(s), stones stacked in layers, multiple stones which have been mortared together, text, and any number of desired graphics.

Masonry block 980 further includes a flange 994 and a notch 996. Flange 994 extends from upper face 986 along an edge shared with front face 982. Notch 916 extends across lower face 988 along an edge shared with front face 982. As described in more detail below, flange 994 is formed through action of a moveable shoe assembly and a moveable liner plate, and notch 996 is formed by the moveable liner plate in cooperation with a pallet (see, for example, shoe assembly 52, liner plate 32d, and pallet 56 of FIG. 1).

FIG. 25B is a side view of masonry block 980 of FIG. 25A. Masonry block 980 has a width (W) 998 (see FIG. 25A), a depth (D) 1000, and a height (H) 1002. Notch 996 has a width 1004 and a depth 1006, and flange 994 has a width 2008 and a height 2010, wherein depth 1006 of notch 996 is at least equal to height 2010 of flange 994. In one embodiment, as illustrated by FIG. 25B, width 2008 of flange 994 is equal to width 1004 of notch 996. As with masonry block 900, masonry block 980 can be formed with a plurality of dimensions, including standard dimensions such as, for example, 4″(H)×12″(D)×9″(W), 6″(H)×10″(D)×12″(W), and 8″(H)×12″(D)×18″(W). Additionally, although illustrated as being of solid construction, masonry block 980 can also be formed with one or more hollow cores using core assemblies as generally understood by those skilled in the art.

FIGS. 25C and 25D respectively illustrate top and bottom views of masonry block 980 of FIGS. 25A and 25D. In one embodiment, as illustrated by FIG. 25C, opposed side faces 990, 992 are generally parallel with one another and extend perpendicularly between front face 982 and rear face 984. In one embodiment, as illustrated by FIG. 25D, opposed side faces 990, 992 are angled inwardly from front face 982 to rear face 984 at an angle (θ) 1012 such that a width (Wr) 1014 of rear face 984 is less than W 998 of front face 982. In another embodiment (not illustrated), only one of the opposed side faces 990, 992 is inwardly angled from front face 982 to rear face 984.

As illustrated by FIGS. 25C and 25D, flange 994 and notch 996 respectively extend the entire distance across upper face 986 and lower face 998 between opposed side face 990, 992. However, as will be described in greater detail below with respect to FIG. 30A to 30C, flange 994 and notch 996 need not extend the entire distance. For example, flange 994 could extend for only a portion of the distance and be spaced from opposed side faces 990, 992 with notch 996 comprising two notch portions separated from one another and extending a corresponding distance from each side face 990, 992.

Masonry blocks 980 are adapted to be stacked in courses to from various structures including landscape structures such as soil retention walls and raised planting beds, for example. As such, lower face 998 of masonry block 980 is adapted to engage an upper face 986 of a similar masonry block in a course of blocks below masonry block 980 so as to maintain a generally parallel relationship between uppers faces 986 of adjacent blocks of a same course. Furthermore, notch 996 of masonry block 980 is configured to slideably interlock with a flange 994 of at least one similar masonry block in the course below masonry block 980 so that each successive course of blocks in interlocked with the preceding course of blocks of the structure. Such interlocking between courses of blocks provides shear strength and stability to the structure. Masonry blocks 980 having at least one inwardly angled opposed side face 990, 992, as described above, enable the construction of curved structures.

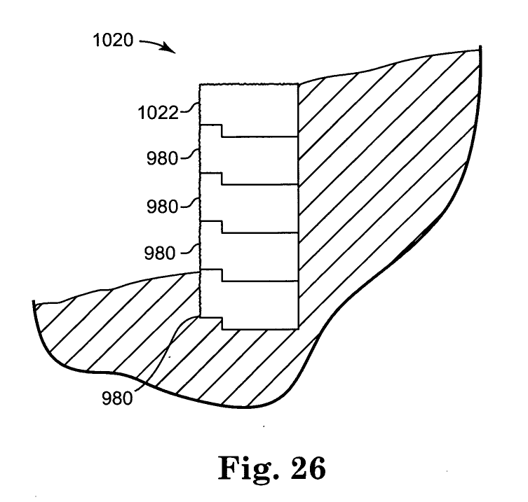

FIG. 26 illustrates an example soil retention wall 1020 employing masonry blocks 980 as described above by FIGS. 25A through 25D. As illustrated, the width 2008 of flange 994 is generally equal to width 1004 of notch 996 (see FIG. 25B) such that soil retention wall 1020 is substantially vertical when notches 996 of each successive course of blocks is interlocked with flanges 994 of previous courses of blocks. Although illustrated as being employed to form a soil retention wall 1020, masonry blocks 980 as described by FIGS. 25A through 25D can also be employed to form free-standing walls or structures (see FIG. 33B below for an example of a free-standing wall).

FIG. 26 illustrates use of what is commonly referred to as a “cap” block 1022. As illustrated, cap block 1022 has an upper surface having a desired three-dimensional texture or pattern in lieu of a flange, such as flange 994. An example of such a cap block is described by U.S. patent application Ser. No. 11/036,275 entitled “Masonry Blocks and Method and System of Making Masonry Blocks”, having Attorney Docket No. H295.106.101.

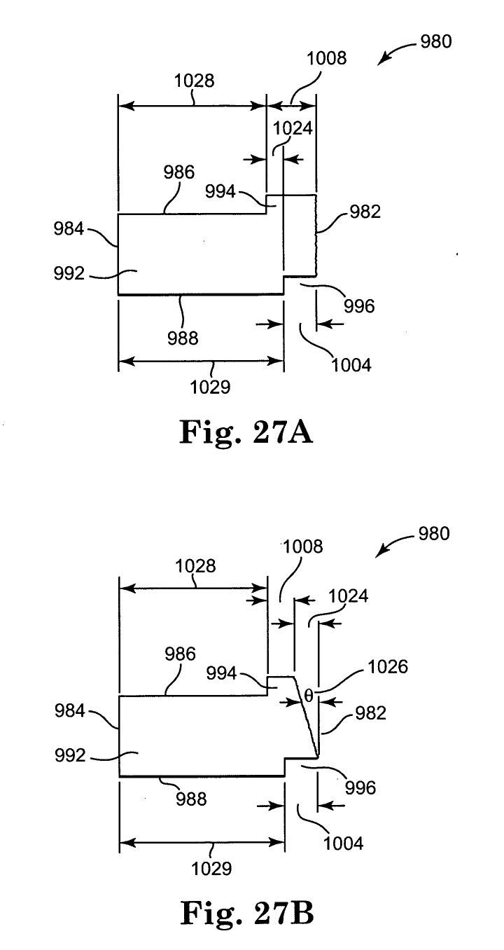

FIGS. 27A and 27B illustrate side views of alternate embodiments of masonry block 980 described above by FIGS. 25A through 25D. In one embodiment, as illustrated by FIG. 27A, front face 982 is generally vertical relative to lower face 988 and upper face 986, and the width 1008 of flange 994 exceeds the width 1004 of notch 996 by a set-back distance 1024. In one embodiment, as illustrated by FIG. 27B, front face 982 is inwardly angled at an angle (θ) 1026 toward rear face 984 as it extends from lower face 988 to upper face 986, such that width 1008 of flange 994 is substantially equal to width 1004 of notch 996.

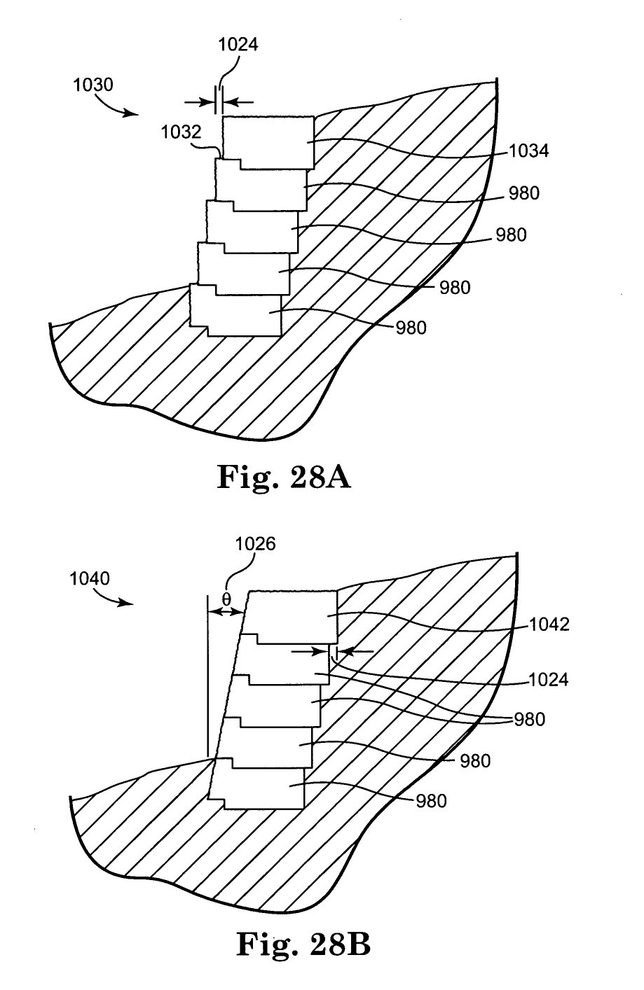

In each embodiment of the embodiments illustrated by FIGS. 27A and 27B, a depth 1028 of upper face 986 from rear face 984 to flange 994 is less than a depth 1029 of lower face 988 from rear face 984 to notch 996 by an amount substantially equal to set-back distance 1024. As illustrated below by FIGS. 28A and 28B, such a configuration causes each successive course of blocks of a structure to be set back from the preceding course of blocks by the set-back distance 1024, thereby providing the structure with additional shear strength.

FIG. 28A illustrates an example soil retention wall 1030 employing masonry blocks 980 as described above by FIG. 27A. As illustrated, width 1008 of flange 994 is greater than width 1004 of notch 996 (see FIG. 27A) so that each successive course of blocks is set back from the preceding course of blocks by set-back distance 1024. However, since the front face of each masonry block is generally vertical relative to the rear face, a portion of the upper face of each block in a lower course of blocks is visible between the front face of each block of the lower course and the front face of each block in the adjacent upper course. These visible portions of the upper faces of each block create the appearance of a ledge, as illustrated at 1032. Such a ledge can be undesirable, especially when trying to create a structure having a natural appearance. A cap block, as described previously with regard to FIG. 21, is illustrated at 1034.

FIG. 28B illustrates an example soil retention wall 1040 employing masonry blocks 980 as described above by FIG. 27B. As illustrated, the depth 1028 of upper face 986 from rear face 984 to flange 994 is less than a depth 1029 of lower face 988 from rear face 984 to notch 996 so that each successive course of blocks is set back from the preceding course of blocks by an amount substantially equal to set-back distance 1024. However, since front face 982 of each masonry block is inwardly angled at an angle (θ) 1026, ledge 1032, which is present in soil retention wall 1030 illustrated by FIG. 28A, is substantially eliminated, thereby providing soil retention wall 1040 with a more uniform slope and more natural appearance. A cap block, as described previously with regard to FIG. 21, is illustrated at 1042.

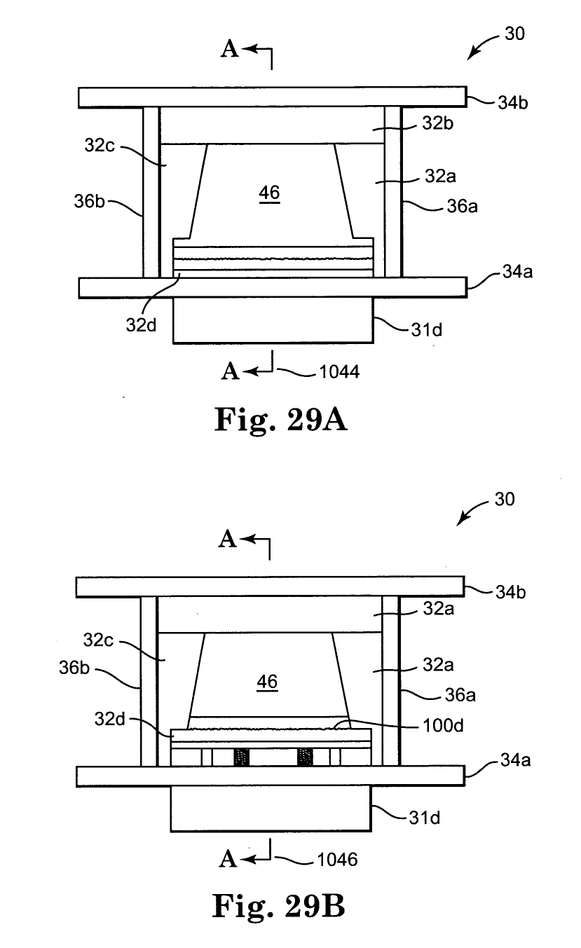

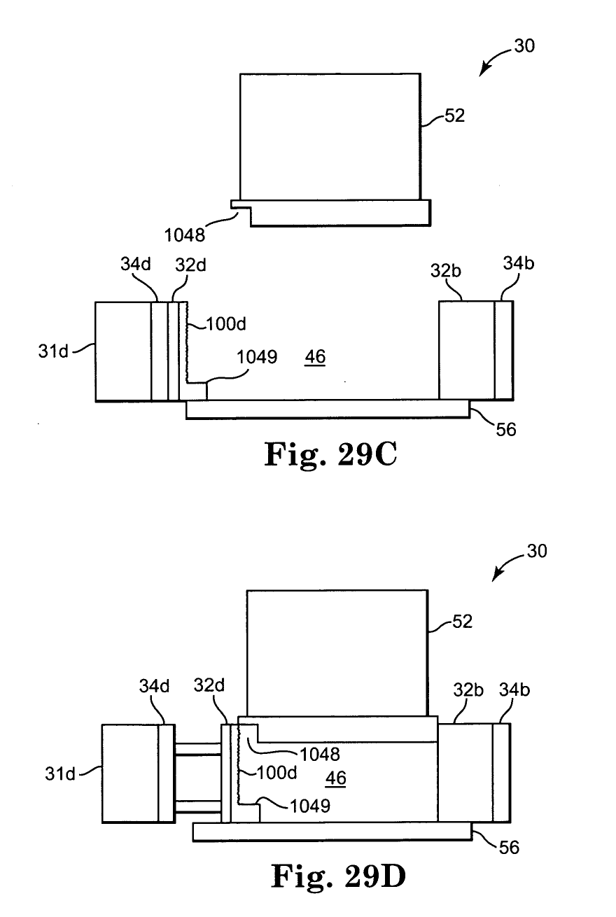

FIGS. 29A through 29D are simplified illustrations of one exemplary implementation of mold assembly 30 configured to form masonry block 980 as described above by FIGS. 25A and 25B. Mold assembly 30 includes side members 34a, 34b, cross-members 36a, 36b, stationary liner plates 32a through 32c, and moveable liner plate 32d. Drive assembly 31d is coupled to moveable liner plate 32d and configured to extend and retract moveable liner plate 32d toward and away from the interior of mold cavity 46.

Liner face 100d is coupled to moveable liner plate 32d and includes a negative of notch 996 to be formed in lower surface 988 and a negative of the desired three-dimensional texture or pattern to be imprinted on front face 982 of masonry block 980 (see FIGS. 25A and 25B). Alternatively, in lieu of employing liner face 10d, the negative of notch 996 and the negative of the desired three-dimensional texture may be integrally included as portions of moveable liner plate 32d. Additionally, although not illustrated, a core bar assembly can be positioned within mold cavity 46 to form hollow cores in masonry block 980.

FIG. 29A illustrates liner plate 32d in a retracted position. Upon extending moveable liner plate 32d and associated liner plate 100d to an extended position within mold cavity 46, as illustrated by FIG. 29B, mold assembly 30 receives concrete and forms a masonry block 980 as described generally by process 850 of FIG. 19.

FIGS. 29C and 29D respectively illustrate cross-sections A-A 1044, 1046 of mold assembly 30 as illustrated by FIGS. 29A and 29B, and further illustrate head shoe assembly 52 and pallet 56. FIG. 29C illustrates liner plate 32d, liner face 10d, and head shoe assembly in their retracted positions, and FIG. 29D in their extended positions after concrete has been introduced into mold cavity 46 (as described generally by process 850 of FIG. 19). Head shoe assembly 52 includes a notch 1048 that cooperates with moveable liner plate 32d and associated liner face 100d to form flange 994 which extends from upper face 986 of masonry block 980. Liner face 100b includes a notch element 1049 that is the negative of notch 996, which cooperates with pallet 56 to form notch 996 which extends across lower surface 988 of masonry block 980 between opposed side faces 990, 992 (see FIGS. 25A through 25D).

FIGS. 30A through 30C illustrate examples of a masonry block 1050, according to the present invention. Masonry block 1050 is an alternate embodiment of masonry block 980 illustrated above FIGS. 25A through 29B. FIG. 30A is a perspective view of masonry block 1050. Masonry block 1050 includes a flange 1052 that extends only a portion of the distance across upper face 986 and a pair of notches 1054, 1056 respectively extending a portion of the distance across lower face 998 from opposed side faces 992 and 990.

FIG. 30B is a front view of masonry block 1050. Flange 980 has a width (W1) 1058, notch 1060 has a width (W2) 1060, and notch 1062 has a width (W3) 1064, wherein the sum of W2 1060 and W3 1062 is substantially equal to the W1 1058. In one embodiment, as illustrated by FIG. 30B, flange 1052 is substantially centered between opposed side faces 990, 992 and widths W2 160 and W3 1062 are each substantially equal to one-half the width W1 1058 of notch 1052. However, as illustrated by FIG. 30C, flange 1052 need not be centered between opposed side faces 990, 992 and notches 1050, 1052 need not be equal in width, so long as the sum of W2 1060 and W3 1062 is substantially equal to W1 1058.

Although not illustrated, opposed side faces 990, 992 of masonry block 1050 can be generally parallel to one another, or one or both opposed side faces 990, 992 can be inwardly angled from front face 982 to rear face 984 in a fashion similar to that of masonry block 980 as illustrated above by FIGS. 25C and 25D. Also, front face 982 can be substantially parallel with rear face 984 or can be inwardly angled toward rear face 984 as it extends from lower face 988 to upper face 986 in a fashion similar to that of masonry block 980 as illustrated above by FIGS. 27A and 27B. Furthermore, masonry blocks 1050 can formed with and without a set-back in a fashion similar to that of masonry block 980, as respectively illustrated by FIGS. 25A and 25B and FIGS. 27A and 27B.

As with masonry block 980, masonry blocks 1050 are adapted to be stacked in courses to form various structures, wherein each of the notches 1060 and 1062 are configured to interlock with portions of flanges 1058 of two adjacent masonry blocks in the course of blocks below masonry block 1050. Although not illustrated, masonry blocks 1050 can be employed to form various structures similar to those formed using masonry blocks 980, such as, for example, soil retention walls 1020, 1030, and 1040 respectively illustrated above by FIGS. 26, 28A, and 28B.

However, while masonry blocks 980 will form structures with front elevations having a familiar “brick-like” pattern created by horizontal and vertical joint lines between adjacent blocks, flanges 1052 and notches 1054, 1056 of masonry blocks 1050 will “break-up” these horizontal and vertical joint lines. As a result, the horizontal and vertical joint lines will be less detectable, which is desirable when wishing to create structures having a “natural” appearance, such as when the three-dimensional texture of front face 982 simulates rock, stone, and/or other naturally occurring material.

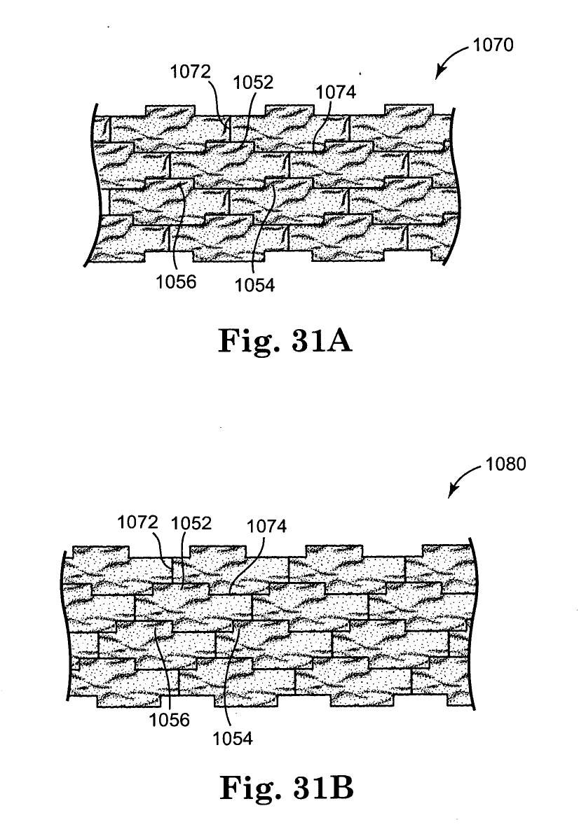

FIGS. 31A and 31B illustrate front elevations of portions of example soil retention walls 1070, 1080 respectively employing masonry blocks 1050 as illustrated above by FIGS. 30B and 30C. As illustrated, flanges 1052 and notches 1054, 1056 break-up vertical and horizontal joint lines 1072 and 1074. This is particularly true of vertical joint lines 1072 when flange 1052 is not centered between opposed side faces 990, 992 and notches 1054, 1056 are of unequal widths, as illustrated by soil retention wall 1080 of FIG. 31B.

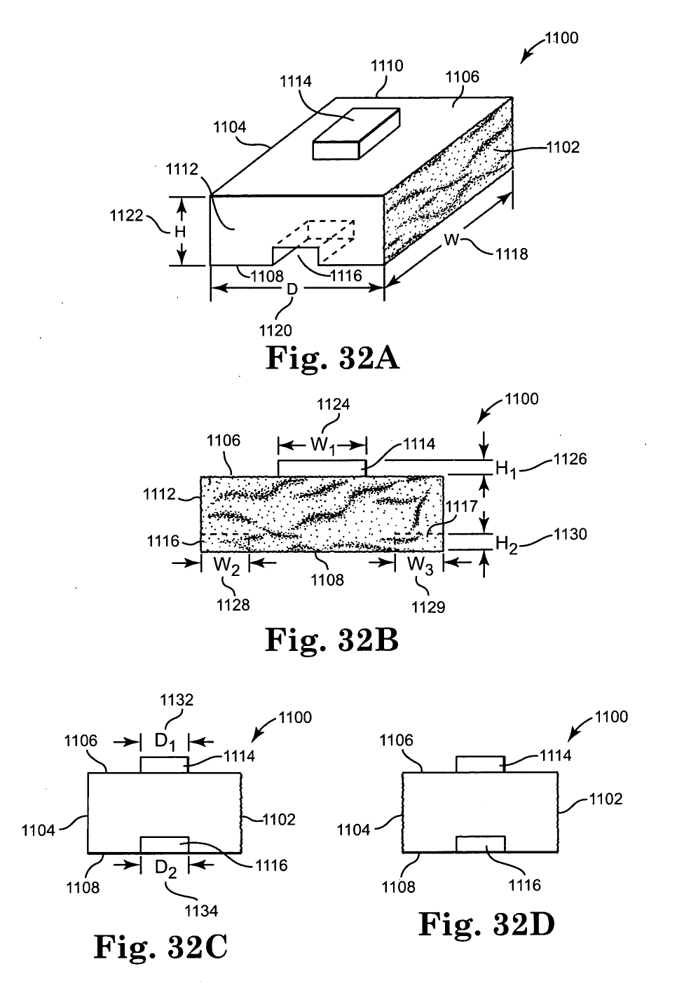

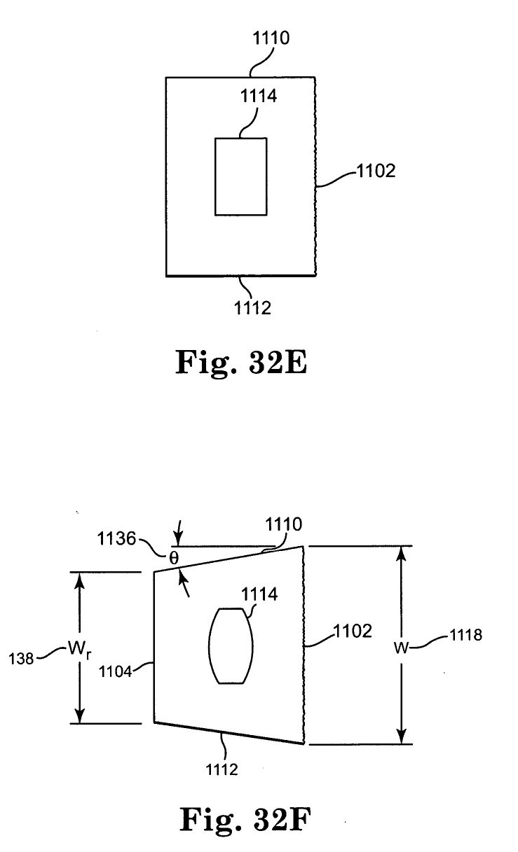

FIGS. 32A through 32F illustrate examples of a masonry block 1100 according to the present invention. FIG. 32A is a perspective view of masonry block 1100. Masonry block 1100 includes a front face 1102, a rear face 1104, an upper face 1106, a lower face 1108, and opposed side faces 1110, 1112. Masonry block 1100 further includes a flange 1114 and a pair of notches 1116, 1117 (see FIG. 32B for notch 1117). Masonry block 1100 has a width (W) 1118, a depth (D) 1120, and a height (H) 1122. Masonry block 1100 can be formed with a plurality of dimensions, including standard dimensions such as, for example, 4″(H)×12″(D)×9″(W), 6″(H)×10″(D)×12″(W), and 8″(H)×12″(D)×18″(W).

As illustrated, front face 1102 includes a desired three-dimensional texture or pattern which is imparted to front face 1102 by a moveable liner plate, such as moveable liner plate 32d (see FIG. 1), which includes a negative of the desired three-dimensional texture or pattern. The desired three-dimensional texture or pattern can be nearly any texture or pattern such as, for example, natural stone(s), stones stacked in layers, multiple stones which have been mortared together, and any number of desired graphics. As described in more detail below, flange 1114 is formed through action of a moveable shoe assembly and notches 1116, 1117 formed through action of a moveable liner plates in cooperation with a pallet.

FIG. 32B is a front view of masonry block 1100 of FIG. 32A. With reference to FIG. 32A, flange 1114 extends from upper surface 1106 and is spaced from front face 1102, rear face 1104, and opposed side faces 1110, 1112. Flange 1114 has a width (W₁) 1124 and a height (H₁) 1126. Notches 1116, 1117 have respective widths of (W₂) 1128 and (W₃) 1129, and a height of (H₂) 1130, wherein H₂ 1130 is at least equal to _{H1} 1126, and wherein the sum of widths W₂ 1128 and W₃ 1129 of notches 1116 and 1117 is substantially equal to the width W₁ 1124 of flange 1114.

FIG. 32C is a side view of masonry block 1100 of FIGS. 32A and 32B. As illustrated, flange 1114 has a depth (D1) 1132 and notches 1116, 1117 have a depth (D₂) 1134, wherein depth D₂ 1134 is at least equal to the width D₁ 1132. In one embodiment, as illustrated by FIGS. 32B and 32C, flange 1124 is substantially centered between opposed side faces 1110, 1112, and flange 114 and notches 116, 1117 are substantially centered between front and rear faces 1102, 1104, with W₂ 1128 and W₃ 1129 each approximately equal to one-half of W₁ 1124. FIG. 32D is a side view of an alternate embodiment of masonry block 1100, wherein rear face 1104 includes a desired three-dimensional texture or pattern which is imparted to rear face 1104 by a moveable liner plate.

FIGS. 32E and 32F are top views of masonry block 1100. In one embodiment, as illustrated by FIG. 32E, opposed side face 1110, 1112 are generally parallel with one another and extend perpendicularly from front face 1102 to rear face 1104. In one embodiment, as illustrated by FIG. 32F, opposed side faces 1110, 1112 are angled inwardly from front face 1102 to rear face 1104 at an angle (θ) 1136 such that a width (Wr) 1138 of rear face 1104 is less than width (W) 1118 of front face 1102. In another embodiment (not illustrated, only one of the opposed side faces 1110, 1112 is inwardly angled from front face 1102 to rear face 1104. In one embodiment, as illustrated by FIG. 32F, flange 1114 is curved, or oval-shaped.

Masonry blocks 1110 are adapted to be stacked in courses to form various structures, including landscape structures such as, for example, soil retention walls and raised planting beds. Lower face 1108 is adapted to engage an upper face 1106 of at least one similar masonry block in a course of block below masonry block 1100 so as to maintain a generally parallel relationship between masonry blocks of adjacent courses. Notches 1116 and 1117 are configured to interlock with portions of flanges 1114 of two similar and adjacent masonry blocks in the course of blocks below masonry block 1100. Oval-shaped flange 1114, in conjunction with at least one of opposed side faces 1110, 1112 being inwardly angled, enables curved structures to be formed using masonry blocks 1100.

FIGS. 33A and 33B illustrate cross-sections through example wall structures 1140 and 1150 employing masonry blocks 1100 as illustrated above by FIG. 32A through 32D. In each case, with reference to FIGS. 32B and 32C, flange 1124 is substantially centered between opposed side faces 1110, 1112, and flange 114 and notches 116, 1117 are substantially centered between front and rear faces 1102, 1104, with W₂ 1128 and W₃ 1129 each approximately equal to one-half of W₁ 1124. As such, wall structures 1140 and 1150 are substantially vertical.

As illustrated by FIG. 33A, wall structure 1140 comprises a soil retention wall employing masonry blocks 1100 having a three-dimensional texture or pattern on only front face 1102 (see FIG. 32C). Wall structure 1150 comprises a fence wall, or security type wall, employing masonry blocks 1100 having a three-dimensional texture or pattern on both front face 1102 and rear face 1104, as illustrated above by FIG. 32D. FIGS. 33A and 33B respectively illustrate use of cap blocks 1142 and 1152, which are described previously with regard to FIG. 21.

FIG. 33C is a partial front elevation of soil retention wall 1140 of FIG. 33A. FIG. 33C illustrates the interlocking relationship between notches in upper courses of blocks, such as notches 1116 and 1117 of masonry blocks 1100a and 1100b, and flanges in lower courses of blocks, such as flange 1114 of masonry block 1100c.

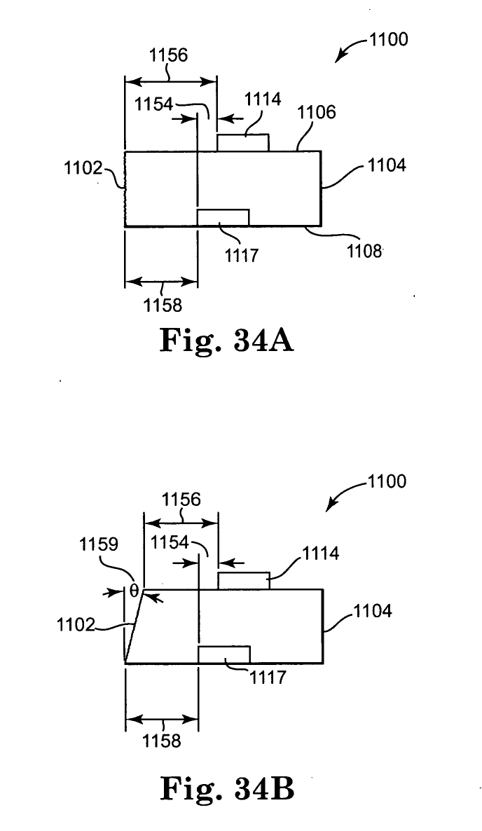

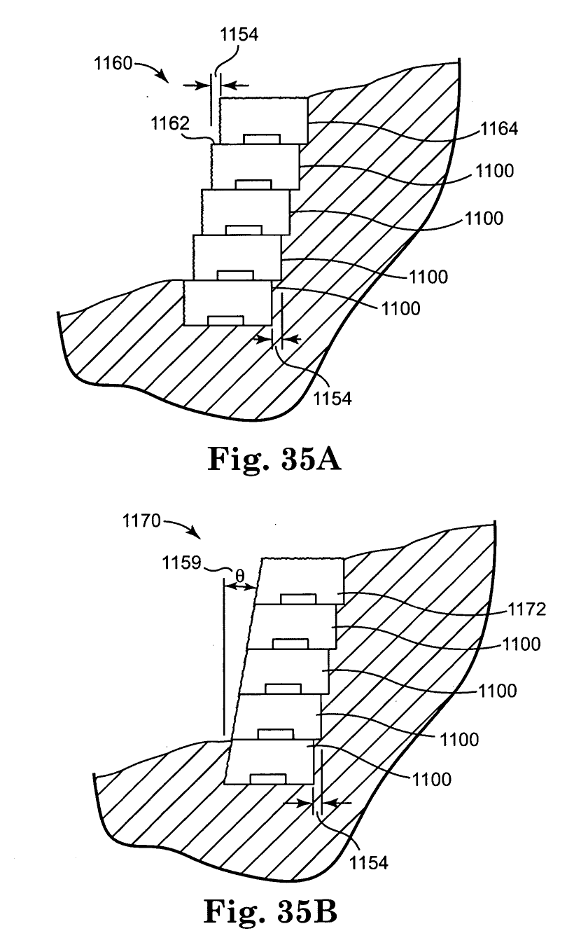

FIGS. 34A and 34B illustrate side views of alternate embodiments of masonry block 1100 described above by FIGS. 32A through 32F. In one embodiment, as illustrated by FIGS. 34A and 34B, flange 1114 is horizontally offset from notches 1116, 1117 (only 1117 is illustrated) by an off-set distance 1154. As illustrated below by FIGS. 35A and 35B, such an off-set causes each successive course of blocks of a structure to be set back from the preceding course of blocks by set-back distance 1154, thereby improving the shear strength of the structure.

In one embodiment, as illustrated by FIG. 34A, front face 1102 is generally vertical relative to rear face 1104 so that a depth 1156 of upper face 1106 from front face 1102 to flange 1114 is greater than a depth 1158 of lower face 1108 from front surface 1102 to notches 1116, 1117 by an amount substantially equal to set-back distance 1154. In one embodiment, as illustrated by FIG. 34B, front face 1102 is angled inwardly at an angle (θ) 1159 as it extends from lower face 1108 to upper face 1106 such that the depth 1156 of upper face 1106 from front face 1102 to flange 1114 is substantially equal to the depth 1158 of lower face 1108 from front surface 1102 to notches 1116, 1117.

FIG. 35A illustrates an example soil retention wall 1160 employing masonry blocks 1100 as described above by FIG. 34A. As illustrated, each successive course of blocks is set back from the preceding course of blocks by set-back distance 1154. Since the front face of each masonry block is generally vertical relative to the rear face, a portion of each of the upper face of each block in a lower course of blocks is visible between the front face of each masonry block in the lower course and the front face of each block in the adjacent upper course of blocks. These visible portions of the upper faces of each block create the appearance of a ledge, as indicated at 1162. Such a ledge can be undesirable, especially when attempting to create a structure having a natural appearance. A cap block, as described previously with regard to FIG. 21, is illustrated at 1164.

FIG. 35B illustrates an example soil retention wall 1170 employing masonry blocks 1100 as described above by FIG. 34B. As illustrated, each successive course of blocks is set back from the preceding course of blocks by set-back distance 1154. However, since the front face of each masonry block is inwardly angled toward the rear face, ledge 1162, which is present in soil retention wall 1160 illustrated by FIG. 35A, is substantially eliminated. As such, soil retention wall 1170 has a uniform slope substantially equal to angle (θ) 1159 and thus, a more natural appearance. As cap block, as described previously with regard to FIG. 21, is illustrated at 1172.

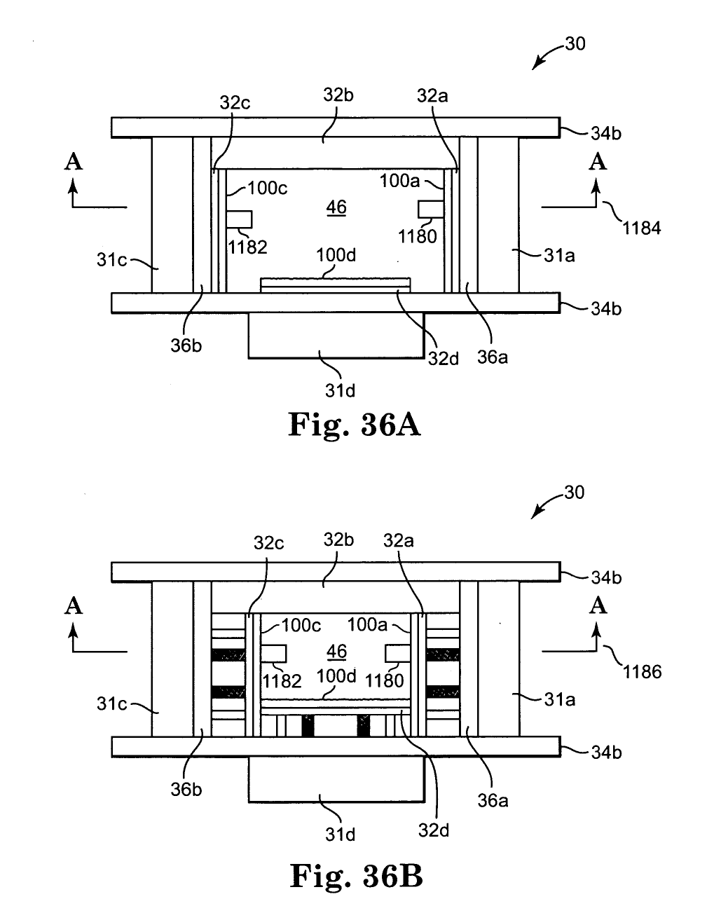

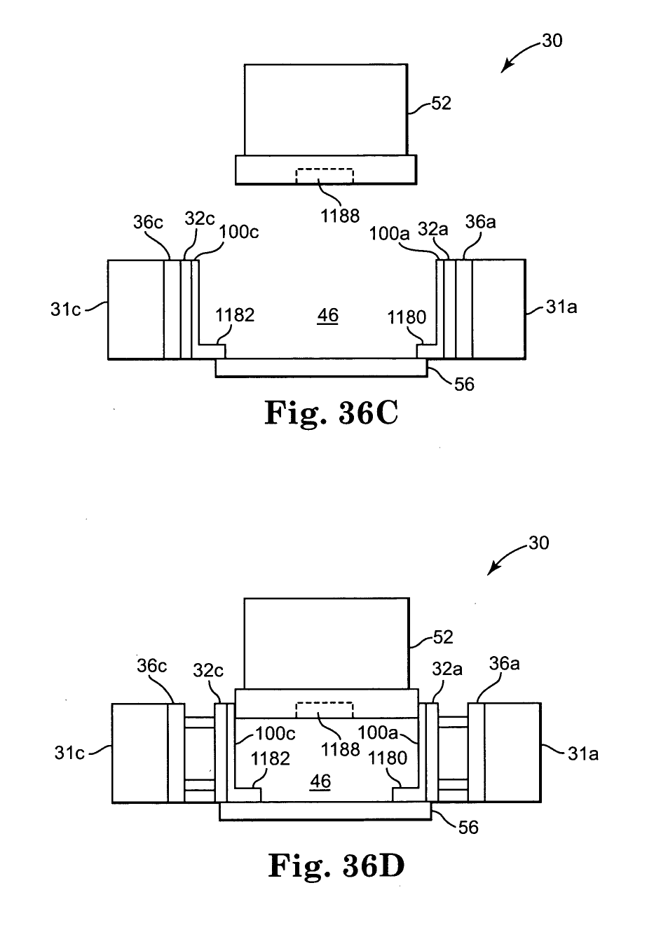

FIG. 36A through 36D are simplified illustrations of one example implementation of a mold assembly 30 configured to form masonry block 1100 as described above by FIGS. 32A through 32C. Mold assembly 30 includes side members 34a, 34b, cross-members 36a, 36b, stationary liner plate 32b, and moveable liner plates 32a, 32c, and 32d. Drive assemblies 31a, 31c, and 31d are respectively coupled to and configured to extend and retract moveable liner plate 32a, 32c, and 32d toward and away from the interior of mold cavity 46.

Liner faces 100a and 100c respectively include notch elements 1180 and 1182, which are the negatives of notches 1116 and 1117 to be formed in lower surface 1108 of masonry block 1100. Liner face 100d includes a negative of the desired three-dimensional texture or pattern to be imprinted on front face 1102 of masonry block 1100. Alternatively, in lieu of employing liner faces 100a, 100c, and 100d, the negatives of notch 1117 and 1116 and the negative of the desired three-dimensional texture may be integrally included as portions of moveable liner plates 32a, 32c, and 32d, respectively. Additionally, although not illustrated, a core bar assembly can be positioned within mold cavity 46 to form hollow cores in masonry block 1100.

FIG. 36A illustrates moveable liner plates 32a, 32c, and 32d in their retracted positions. Upon extending moveable liner plates 32a, 32c, and 32d and associated liner faces 100a, 100c, and 100d to corresponding extended positions within mold cavity 46, as illustrated by FIG. 36B, mold assembly 30 receives concrete and forms a masonry block 1100, as described generally by process 850 of FIG. 19.

FIGS. 36C and 36D respectively illustrate cross-sections A-A 1184, and 1186 of mold assembly 30 as illustrated by FIGS. 36A and 36B, and further illustrate head shoe assembly 52 and pallet 56. FIGS. 36C and 36D respectively illustrate liner plates 32a, 32c, associated liner faces 100a, 100c, and head shoe assembly 52 in their retracted and extended positions. Head shoe assembly 52 includes a notch element 1188 to form flange 1114 which extends from upper face 1106 of masonry block 1100 (see FIGS. 32A and 32B). Liner face 100b includes a notch element 1049 that is the negative of notch 996, which cooperates with pallet 56 to form notch 996 which extends across lower surface 988 of masonry block 980 between opposed side faces 990, 992 (see FIGS. 25A through 25D). Also illustrated are notch elements 1180 and 1182, which respectively form notches 1117 and 1116 in lower face 1108 of masonry block 1100.

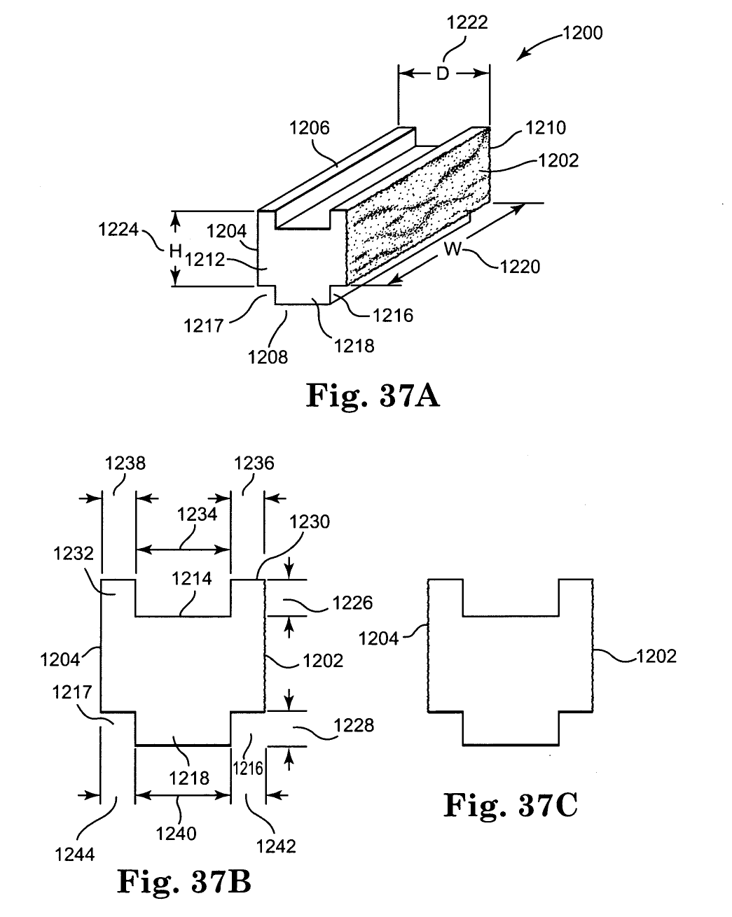

FIGS. 37A through 37C illustrate examples of a masonry block 1200 according to the present invention. FIG. 37A is a perspective view of masonry block 1200. Masonry block 1200 includes a front face 1202, a rear face 1204, an upper face 1206, a lower face 1208, and opposed side faces 1210, 1212. As illustrated, front face 1202 includes a desired three-dimensional texture or pattern which is imparted by a moveable liner plate, such as moveable liner plate 32d (see FIG. 1), which includes a negative of the desired three-dimensional pattern. The desired three-dimensional pattern can be nearly any texture or pattern such as, for example, natural stone(s), stones stacked in layers, multiple stones which have been mortared together, and any number of desired graphics and text.

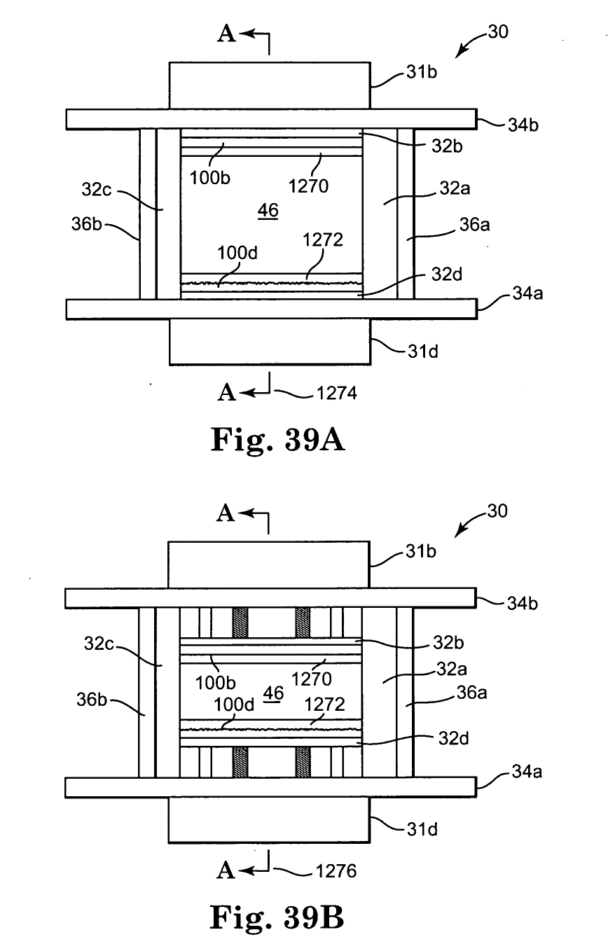

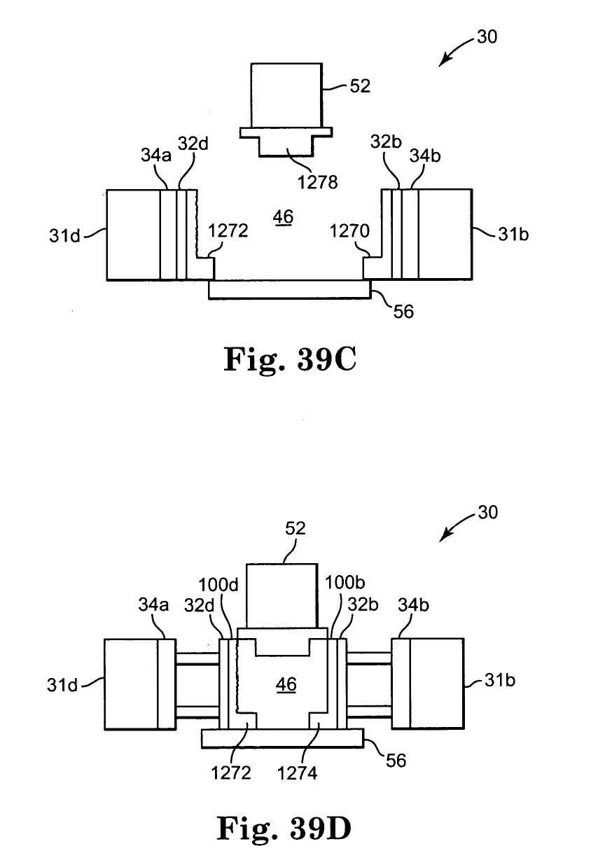

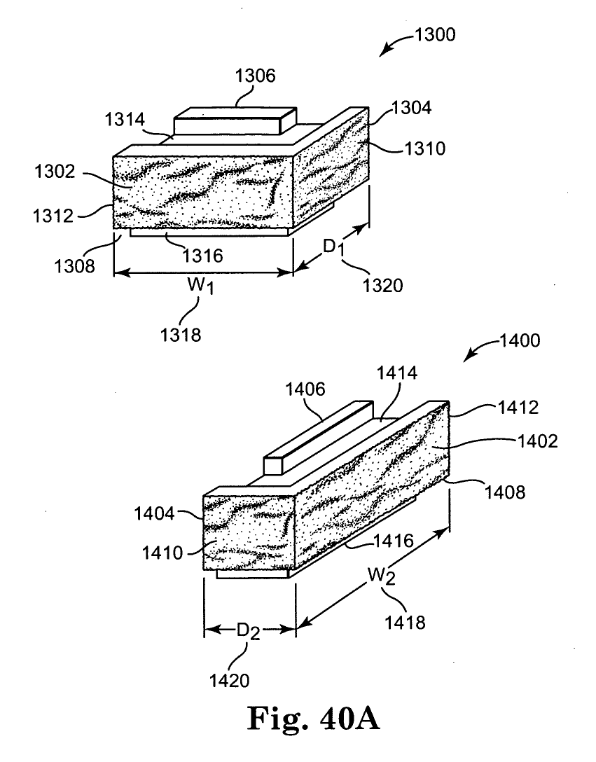

Masonry block 1200 includes a notch, or channel, 1214 extending across upper face 1206 between opposed side faces 1210, 1214 and spaced from front face 1202 and rear face 1204. A pair of notches 1216 and 1217 extend across lower face 1208 between opposed side faces 1210, 1212 along edges respectively shared with front face 1202 and rear face 1204. Together, notches 1216, 1217 form a flange 1218 extending across lower face 1208 between opposed side face 1210, 1212 and spaced from front face 1202 and rear face 1204. As will be described in more detail below by FIGS. 39A through 39D, channel 1214 is formed through action of a moveable shoe assembly and notches 1216, 1217 and thus, flange 1218, are formed through action of a pair of moveable liner plates, with notch 1216 being formed with the same moveable liner plate imparting the three-dimensional texture to front face 1202.

Masonry block 1200 has a width (W) 1220 (see FIG. 37A), a depth (D) 1222, and a height (H) 1224. Masonry block can be formed with a plurality of dimensions, including standard dimensions such as, for example, 16″W×8″D×8″H.

FIG. 37B is an end view of masonry block 1200 of FIG. 37A. Channel 1214 has a depth 1226 and flange 1218 has a height 1228, wherein depth 1226 of channel 1214 is at least equal to height 1228 of flange 1218. As illustrated, forming channel 1214 forms flanges 1230, 1232 parallel with channel 1214 across upper surface 1206. Channel 1214 has a width 1234 and flanges 1230, 1232 have widths 1236, 1238. Flange 1218 has a width 1240 and flanges 1216, 1217 have widths 1242, 1244, wherein width 1234 of channel 1214 is at least as wide as width 1240 of flange 1218.

In one embodiment, as illustrated by FIG. 37B, width 1234 of channel 1214 is substantially equal to width 1240 of flange 1218, and channel 1214 and flange 1218 are substantially centered between front face 1202 and rear face 1204 such that widths 1236, 1238 of flanges 1230, 1232 are substantially equal to one another and to widths 1242, 1244 of flanges 1216, 1217.

FIG. 37C is an end view of an alternate embodiment of masonry block 1200, wherein rear face 1204 also includes a desired three-dimensional texture or pattern which is imparted to rear face 1204 via the moveable liner plate employed to form notch 1217.

Masonry blocks 1200 are adapted to be stacked in courses to form various structures, including landscape structures such as, for example, soil retention walls and raised planting beds. Flange 1218 of lower face 1208 is adapted to slideably inert into and interlock with a channel 1214 of an upper face 1206 of at least one similar masonry block in a course of blocks below masonry block 1200.

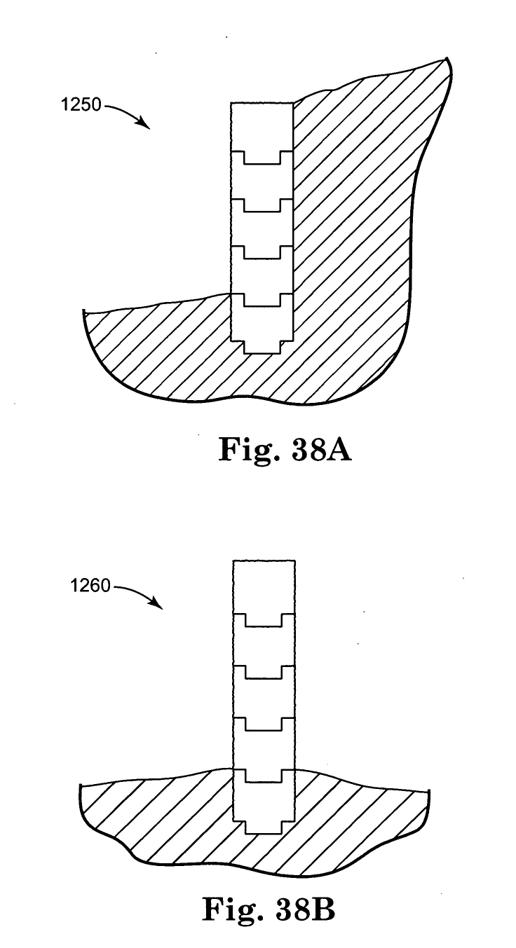

FIGS. 38A and 38B illustrate cross-sections through example wall structures 1250 and 1260 respectively employing wall blocks 1200 as illustrated by FIGS. 37B and 37C. In each case, with reference to FIGS. 37B and 37C, width 1240 of flange 1218 is substantially equal to width 1234 of channel 1214, and channel 1214 and flange 1218 are substantially centered between front face 1202 and rear face 1204. As a result, both wall structure 1250 and 1560 are substantially vertical.

As illustrated by FIG. 38A, wall structure 1250 comprises a soil retention wall employing masonry blocks 1200 having a three-dimensional texture on only front face 1202 (see FIGS. 37A and 37B). Wall structure 1260 comprises a fence wall, or security wall, employing masonry blocks 1200 having a three-dimensional texture on both front face 1202 and rear face 1204 (see FIG. 37C).

With reference to FIGS. 37A through 37B, although not illustrated, the widths of channel 1214, flange 1218, and flanges 1216, 1217, 1236 and 1238 can be adjusted to create set-backs and front face 1202 can be inwardly angled in a fashion similar to that described above with regard to masonry block 1100 (see FIGS. 34A and 34B). Masonry blocks 1200 formed in such a fashion can be employed to form structures having set-backs and slopes similar to soil retention walls 1160 and 1170 illustrated above with regard to FIGS. 35A and 35B.

Additionally, although not illustrated, masonry blocks 1200 can be formed with one or both of the opposed side faces 1210, 1212 inwardly angled from front face 1202 to rear face 1204 and with flange 1218 having an oval or arcuate shape in a fashion to that of opposed side faces 1110 and 1112 and flange 1114 of masonry block 1100 as illustrated above by FIG. 32F. Masonry blocks 1200 formed in such a fashion can be employed to form curved or serpentine structures.

FIGS. 39A through 39D are simplified illustrations of one example implementation of a mold assembly 30 configured to form masonry block 1200 as described above by FIGS. 37A and 37B. Mold assembly 30 includes side members 34a, 34b, cross-members 36a, 36b, stationary liner plates 32a, 32c, and moveable liners plates 32b and 32d. Drive assemblies 31b and 31d are respectively coupled to and configured to extend and retract moveable liner plates 32b and 32d toward and away from the interior of mold cavity 46.

Liner faces 100b and 100d respectively include notch elements 1270 and 1272, which are the negatives of notches 1217 and 1216 to be formed in lower surface 1208 of masonry block 1200. Liner face 100d further includes a negative of the desired three-dimensional texture or pattern to be imprinted on front face 1202 of masonry block 1200. Alternatively, in lieu of employing liner faces 100b and 100d, the notch elements 1270 and 1272 and the negative of the desired three-dimensional texture may be integrally included as portions of moveable liner plates 32b and 32d, respectively. Additionally, although not illustrated, a core bar assembly can be positioned within mold cavity to form hollow cores in masonry block 1200.

FIG. 39A illustrates moveable liner plates 32b and 32d in their retracted positions. Upon extending moveable liner plates 32b and 32d and associated liner faces 100b and 100d to corresponding extended positions within mold cavity 46, as illustrated by FIG. 39B, mold assembly receives concrete and forms a masonry block 1200, as described generally by process 850 of FIG. 19.

FIGS. 39C and 39D respectively illustrate cross-sections A-A 1274 and 1276 of mold assembly 30, as illustrated by FIGS. 39A and 39B, and further illustrate head shoe assembly 52 and pallet 56. FIGS. 36C and 36D respectively illustrate moveable liner plates 32b, 32d, liner faces 10b, 10d, and shoe assembly 52 in their retracted and extended positions. Head shoe assembly 52 includes a notch element 1278 configured to form channel 1214 in upper face 1206 of masonry block 1200. Liner faces 100b and 100d include notch elements 1270 and 1272, which respectively form flange 1218 on lower face 1208 of masonry block 1200. Liner face 100d further includes a negative of the three-dimensional texture or pattern to be imprinted on front face 1202 of masonry block 1200.

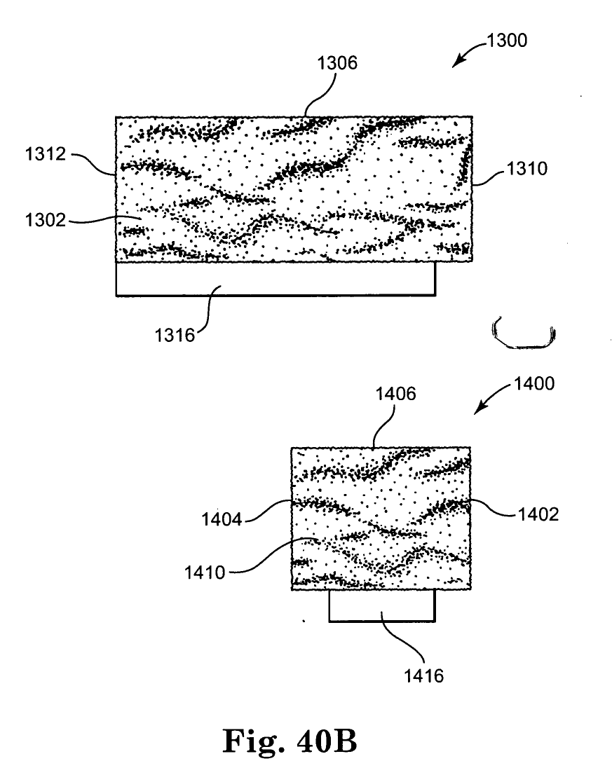

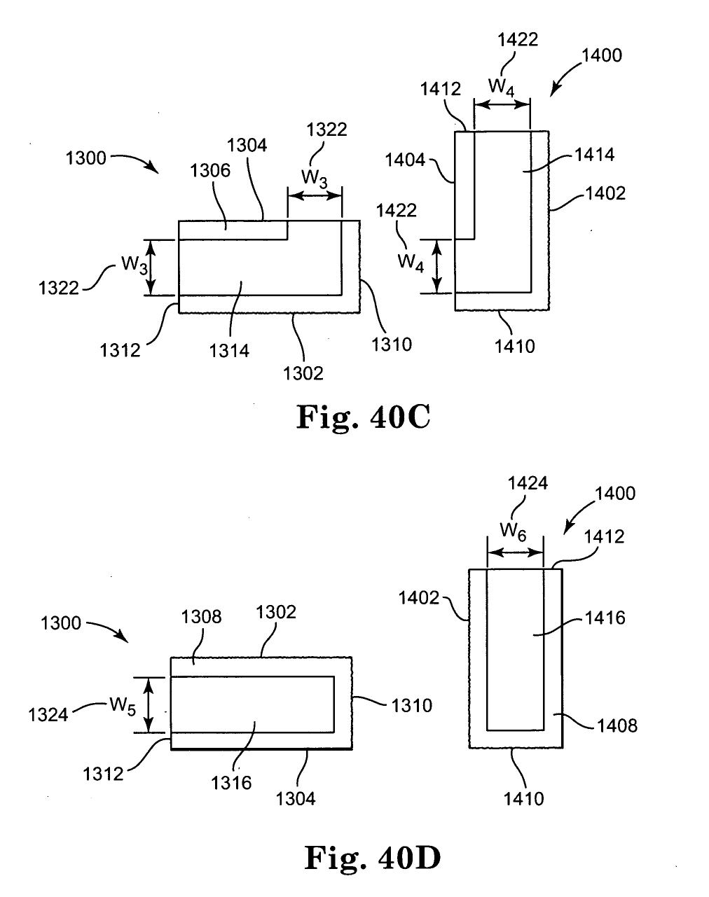

FIGS. 40A through 40D illustrate examples of masonry blocks 1300 and 1400, which are alternate embodiments of masonry block 1200. FIG. 40A is a perspective view of masonry blocks 1300 and 1400. Masonry block 1300 includes a front face 1302, a rear face 1304, an upper face 1306, a lower face 1308, and opposed side faces 1310 and 1312. Front face 1302 and side face 1310 include a desired three-dimensional texture or pattern imprinted by moveable liner plates. Upper face 1306 includes an “ell-shaped” notch, or channel, 1314 having short leg open to rear face 1304 and long leg open to side face 1312, wherein channel 1314 is formed through action of a moveable shoe assembly. Lower face 1308 includes a flange 1316 formed through action of a plurality of moveable liner plates, two of which also imprint the desired three-dimensional pattern on front face 1302 and side face 1310. Masonry block 1300 has a width (W₁) 1318 and a depth (D₁) 1320.

Masonry block 1400 includes a front face 1402, a rear face 1404, an upper face 1406, a lower face 1408, and opposed side faces 1410 and 1412. Front face 1402 and side face 1410 include a desired three-dimensional texture or pattern imprinted by moveable liner plates. Upper face 1406 includes an “ell-shaped” notch, or channel, 1414 having a short leg open to rear face 1404 and a long leg open to side face 1412, wherein channel 1414 is formed through action of a moveable shoe assembly. Lower face 1408 includes a flange 1416 formed through action of a plurality of moveable liner plates, two of which also imprint the desired three-dimensional pattern on front face 1402 and side face 1410.

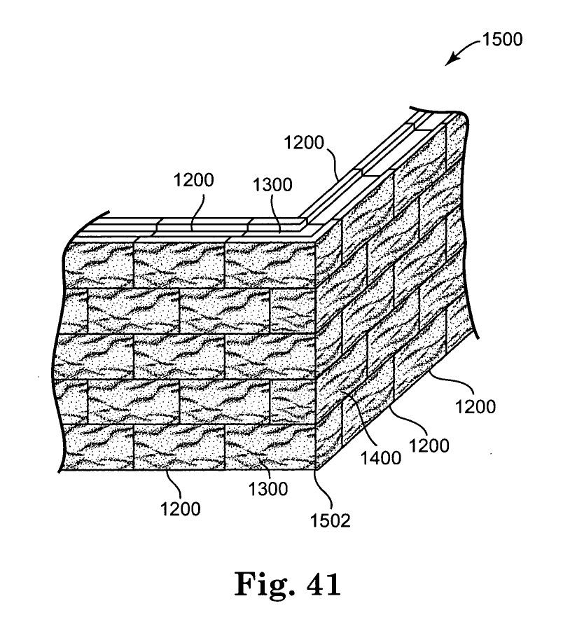

Masonry block 1400 has a width (W₂) 1318 and a depth (D₂) 1420. In one embodiment, depth D1 1320 of masonry block 1300 is equal to one-half the width W2 1418 of masonry block 1400, and depth D2 1420 of masonry block 1400 is equal to one-half the width W1 1318 of masonry block 1300. A portion of flange 1316 of masonry block 1300 proximate to end face 1310 is configured to slideably interlock with a portion of channel 1414 which opens to rear face 1404 of masonry block 1400, and a portion of flange 1416 proximate to end face 1410 is configured to slideably interlock with a portion of channel 1314 which opens to rear face 1304 of masonry block 1300. As such, and as illustrated below by FIG. 41, when stacked in an alternating fashion, masonry blocks 1300 and 1400 interlock with another to form angled corners for structures employing masonry blocks 1200, such as soil retention wall 1250 and security wall 1260 illustrated above by FIGS. 38A and 38B.

FIG. 40B illustrates a side view of masonry block 1300 and an end view of masonry block 1400. FIGS. 40C and 40D respectively illustrate top and bottom views of masonry blocks 1300 and 1400. Channel 1314 of masonry block 1300 has a width (W₃) 1322 and channel 1414 of masonry block 1400 has a width (W₄) 1422. Flange 1316 of masonry block 1300 has a width (W₅) 1324 and flange 1416 of masonry block 1400 has a width (W₆) 1424. In one embodiment, as illustrated, widths W₃, W₄, W₅, and W₆ are substantially equal to one another so that masonry blocks 1300 and 1400 securely interlock with one another when stacked.

FIG. 41 illustrates a perspective view of a portion of an example wall structure 1500 comprising masonry blocks 1200 and employing masonry blocks 1300 and 1400 stacked/interlocked in an alternating fashion to form a corner 1502. Although illustrated by FIGS. 40A through 40D and by FIG. 41 as forming substantially right angle corners, masonry blocks 1300 and 1400 can be formed so as to provide corners having angles other than right angles. Additionally, rear faces 1304 and 1404 of masonry blocks 1300 and 1400 can be formed to include desired three-dimensional textures and patterns so that structures, such as wall 1500, for example, include a texture on each side. Furthermore, while not specifically illustrated, mold assembly 30 of FIGS. 39A through 39D can be readily adapted to form masonry blocks 1300 and 1400.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A method of producing a masonry block having a front face, a rear face, an upper face, a lower face, and a pair of opposed side faces, the method comprising:
providing a mold assembly having a plurality of liner plates that form a mold cavity having an open top and an open bottom, wherein at least a first liner plate is moveable between a retracted position and an extended position, the first liner plate including a flange element;
moving the first liner plate to the extended position;
closing the bottom of the mold cavity with a pallet;
filling the mold cavity with dry cast concrete via the open top;
positioning a shoe assembly into the open top of the mold cavity, the shoe assembly including a notch element;
compacting the dry cast concrete to form a pre-cured masonry block with the upper face resting on the pallet, whereby the flange element of the first liner plate and pallet cooperate to form a notch in the upper face along an edge shared with the rear face and the notch element of the shoe assembly and the first liner plate cooperate to form a flange extending from the lower face along an edge shared with the rear face, the flange adapted to engage a notch in an upper face of at least one similar masonry block;
moving the first liner plate to the retracted position; and
expelling the pre-cured masonry block from the mold cavity; and
curing the pre-cured masonry block.

2. A masonry block produced by the method of claim 1.

3. The method of claim 1, wherein at least the first liner plate is moveable between an extended position and a retracted position with a drive assembly.

4. The method of claim 3, wherein the drive assembly comprises a gear drive assembly.

5. The method of claim 1, wherein a second liner plate is moveable between a retracted position and an extended position, the second liner plate being generally opposite the first liner plate and including a negative of a desired three-dimensional pattern, the method including moving the second liner plate to the extended position prior to closing the bottom of the mold cavity and to the retracted position subsequent to compacting the dry cast concrete such that the three-dimensional pattern is imprinted on the front face of the masonry block.

6. A masonry block produced by the method of claim 5.

7. The method of claim 1, wherein a depth of the flange element of the first liner plate is substantially equal to a depth of the notch element of the shoe assembly such that a depth of the notch in the upper face is substantially equal to a depth of the flange extending from the lower face as measured from the rear face to the front face.

8. A masonry block produced by the method of claim 7.

9. The method of claim 1, wherein a depth of the flange element of the first liner plate is less than a depth of the notch element of the shoe assembly such that a depth of the lower face from the front face to the flange extending from the lower face is less than a depth of the upper face from the front face to the notch.

10. The method of claim 7, wherein a second liner plate, opposite the first liner plate and moveable between a retracted position and an extended position, is moved to the extended position prior to closing the bottom of the mold cavity and to the retracted position subsequent to compacting the dry cast concrete, wherein the second liner plate is angled so that the front face is inwardly angled relative to the rear face such that the depth of the lower face from the front face to the flange extending from the lower face is substantially equal to the depth of the upper face from the front face to the notch.

11. The method of claim 10, wherein the second liner plate includes a negative of a desired three-dimensional pattern such that the three-dimensional pattern is imprinted on the front face when compacting the dry-cast concrete.

12. A masonry block produced by the method of claim 11.

13. A method of producing a masonry block having a front face, a rear face, an upper face, a lower face, and a pair of opposed side faces, the method comprising:
providing a mold assembly having a plurality of liner plates that form a mold cavity having an open top and an open bottom, wherein at least a first liner plate is moveable between a retracted position and an extended position, the first liner plate including a flange element and a negative of a three-dimensional pattern;
moving the first liner plate to the extended position;
closing the bottom of the mold cavity with a pallet;
filling the mold cavity with dry cast concrete via the open top;
positioning a shoe assembly into the open top of the mold cavity, the shoe assembly including a notch element;
compacting the dry cast concrete to form a pre-cured masonry block with the lower face resting on the pallet, whereby the notch element of the shoe assembly and the first liner plate cooperate to form a flange extending from the upper face along an edge shared with the front face, the three-dimensional pattern is imprinted on the front face, and the flange element of the first liner plate and pallet cooperate to form a notch in the lower face along an edge shared with the front face, the notch adapted to engage a flange extending from an upper face of at least one similar masonry block;
moving the first liner plate to the retracted position; and
expelling the pre-cured masonry block from the mold cavity; and
curing the pre-cured masonry block.

14. A masonry block produced by the method of claim 13.

15. The method of claim 13, wherein at least the first liner plate is moveable between an extended position and a retracted position with a drive assembly.

16. The method of claim 15, wherein the drive assembly comprises a gear drive assembly.

17. The method of claim 13, wherein the flange and notch extend across a full width of the masonry block between the opposed side faces.

18. The method of claim 13, wherein the flange extends from the upper face along a portion of a full width of the edge shared with the front face, the flange having a width and being spaced from each opposed side face, and wherein the notch in the lower face along the edge shared with the front face comprises a first notch portion and a second notch portion, each notch portion having a width and extending from a different one of the opposed side faces across a portion of a full width of the lower face, the sum of the widths of first and second notch portions being at least equal to flange width, and each notch portion adapted to engage a portion of a flange extending from upper faces of similar masonry blocks.

19. A masonry block produced by the method of claim 18.

20. The method of claim 18, wherein the flange is substantially centered between the opposed side faces and each notch portion is substantially equal to one half the width of the flange.

21. The method of claim 13, wherein a depth of the flange element of the first liner plate is substantially equal to a depth of the notch element of the shoe assembly such that a depth of the notch in the lower face is substantially equal to a depth of the flange extending from the upper face as measured from the front face to the rear face.

22. The method of claim 13, wherein a depth of the flange element of the first liner plate is less than a depth of the notch element of the shoe assembly such that a depth of the flange extending from the upper face is greater than a depth of the notch in the lower face as measured from the front face to the rear face, and such that a depth of the upper face from the rear face to the flange is less than a depth of the lower face from the rear face to the notch.

23. The method of claim 22, wherein the first liner plate is angled so that the front face is inwardly angled relative to the rear face such that the depth of the flange is substantially equal to the depth of the notch.

24. A masonry block produced by the method of claim 23.

25. A method of producing a masonry block having a front face, a rear face, an upper face, a lower face, and a pair of opposed side faces, the method comprising:
providing a mold assembly having a plurality of liner plates that form a mold cavity having an open top and an open bottom, wherein a first liner plate and a second liner plate, which is generally opposite the first liner plate, are each moveable between corresponding retracted and extended positions, the first and second liner plates each including a flange element;
moving the first and second liner plates to the corresponding extended position;
closing the bottom of the mold cavity with a pallet;
filling the mold cavity with dry cast concrete via the open top;
positioning a shoe assembly into the open top of the mold cavity, the shoe assembly including a notch element;
compacting the dry cast concrete to form a pre-cured masonry block with the lower face resting on the pallet, whereby the notch element of the shoe assembly forms a flange extending from the upper face, the flange spaced from front, rear, and opposed side faces and having a width, and whereby the flange elements of the first and second liner plates cooperate with the pallet to form first and second notches in the lower face, each notch having a width and spaced from the front and rear faces and extending from a different one of the opposed side faces across a portion of a full width of the lower face, the sum of the widths of first and second notch portions being at least equal to flange width, and each notch adapted to engage a portion of a flange extending from upper faces of similar masonry blocks.
moving the first and second liner plates to the corresponding retracted position; and
expelling the pre-cured masonry block from the mold cavity; and
curing the pre-cured masonry block.

26. A masonry block produced by the method of claim 25.

27. The method of claim 25, wherein the first and second liner plates are each moveable between the corresponding retracted and extended positions with a drive assembly.

28. The method of claim 27, wherein the drive assembly comprises a gear drive assembly.

29. The method of claim 25, wherein a third liner plate, which is generally perpendicular to the first and second liner plates, includes a negative of a desired three-dimensional pattern, and is moveable between a retracted position and an extended position with a gear drive assembly, is moved to the extended position prior to closing the bottom of the mold cavity and the retracted position subsequent to compacting the dry cast concrete such that the desired three-dimensional pattern is imprinted on the front face of the masonry block.

30. The method of claim 29, wherein the notch element of the shoe assembly is positioned such that flange is substantially centered between the front and rear faces and between the opposed side face, and wherein the flange elements of the first and second liner plates are positioned such that the first and second notches are substantially centered between the front and rear faces.

31. The method of claim 30, wherein the width of the first and second notches are each substantially equal to one half the width of the flange.

32. The method of claim 29, wherein the notch element of the shoe assembly and flange elements of the first and second liner plates are offset such that a depth of the lower face from the front face to the first and second notches is less than a depth of the upper face from the front face to the flange.

33. The method of claim 32, wherein the third liner plate is angled so that the front face is inwardly angled relative to the rear face such that the depth of the lower face from the front face to the first and second notches is substantially equal to the depth of the upper face from the front face to the flange.

34. A masonry block produced by the method of claim 33.

35. The method of claim 25, wherein the notch element of the shoe assembly is configured to form a flange having a shape that enables rotation of a similar masonry block having a notch engaging the flange.

36. The method of claim 35, wherein the notch element of the shoe assembly is configured to form a flange having an oval shape.

37. A method of producing a masonry block having a front face, a rear face, an upper face, a lower face, and a pair of opposed side faces, the method comprising:
providing a mold assembly having a plurality of liner plates that form a mold cavity having an open top and an open bottom, wherein a first liner plate and a second liner plate, which is generally opposite the first liner plate, each include a flange element and are each moveable between corresponding retracted and extended positions;
moving the first and second liner plates to the corresponding extended position;
closing the bottom of the mold cavity with a pallet;
filling the mold cavity with dry cast concrete via the open top;
positioning a shoe assembly into the open top of the mold cavity, the shoe assembly including a flange element;
compacting the dry cast concrete to form a pre-cured masonry block with the lower face resting on the pallet, whereby the flange element of the shoe assembly forms a channel in and extending across the upper face between the opposed side face, and whereby the flange elements of the first and second liner plates cooperate with the pallet to form a flange spaced from the front and rear faces and extending from and across the lower face between the opposed side faces, the flange adapted to engage a portion of a channel in an upper face of at least one similar masonry block;
moving the first and second liner plates to the corresponding retracted position; and
expelling the pre-cured masonry block from the mold cavity; and
curing the pre-cured masonry block.

38. A masonry block produced by the method of claim 37.

39. The method of claim 37, wherein the first and second liner plates are each moveable between the corresponding retracted and extended positions with a drive assembly.

40. The method of claim 39, wherein the drive assembly comprises a gear drive assembly.

41. The method of claim 37, wherein in the first liner plate includes a negative of a desired three-dimensional pattern such that the desired three-dimensional pattern is imprinted on the front face when compacting the dry-cast concrete.

42. The method of claim 41, wherein in the second liner plate includes a negative of a desired three-dimensional pattern such that the desired three-dimensional pattern is imprinted on the rear face when compacting the dry-cast concrete.

43. A masonry block produced by the method of claim 42.

44. A method of producing a masonry block having a front face, a rear face, an upper face, a lower face, and a pair of opposed side faces, the method comprising:
providing a mold assembly having a plurality of liner plates that form a mold cavity having an open top and an open bottom, wherein a first, a second, and a third liner plate each include a flange element and are each moveable between corresponding retracted and extended positions, the second liner plate opposite the first liner plate and the third liner plate generally perpendicular to the first and second liner plates;
moving the first, second and third liner plates to the corresponding extended position;
closing the bottom of the mold cavity with a pallet;
filling the mold cavity with dry cast concrete via the open top;
positioning a shoe assembly into the open top of the mold cavity, the shoe assembly including a flange element;
compacting the dry cast concrete to form a pre-cured masonry block with the lower face resting on the pallet, whereby the flange element of the shoe assembly forms an ell-shaped channel in the upper face, a short leg of the channel open to the rear face and a long leg of the channel open to a first of the pair of opposed side faces, and whereby the flange elements of the first, second, and third liner plates cooperate with the pallet to form a flange extending from and across a portion of a width of the lower face and spaced from the front and rear faces and from a second of the pair of opposed side faces, the flange adapted to engage a portion of a channel in an upper face of at least one similar masonry block so as to form a corner;
moving the first, second, and third liner plates to the corresponding retracted position; and
expelling the pre-cured masonry block from the mold cavity; and
curing the pre-cured masonry block.

45. A masonry block produced by the method of claim 44.

46. The method of claim 44, wherein the first, second, and third liner plates are each moveable between the corresponding retracted and extended positions with a drive assembly.

47. The method of claim 46, wherein the drive assembly comprises a gear drive assembly.

48. The method of claim 44, wherein in the first and third liner plates each include a negative of a desired three-dimensional pattern such that the first liner plate imprints the associated desired three-dimensional pattern is imprinted on the front face and the third liner plate imprints the desired three-dimensional pattern on the second of the pair of opposed side faces when compacting the dry-cast concrete.

49. The method of claim 48, wherein in the second liner plate includes a negative of a desired three-dimensional pattern such that the desired three-dimensional pattern is imprinted on the rear face when compacting the dry-cast concrete.

50. A masonry block produced by the method of claim 49.

51. A masonry block molded in a masonry block machine employing a mold assembly having a mold cavity formed by plurality of liner plates, the masonry block comprising:
a front face;
a rear face;
an upper face joining the front and rear faces and having a notch along an edge shared with the rear face, the notch formed during a molding process by action of first moveable liner plate having a flange element which is a negative of the notch;
a lower face opposed to the upper face and joining the front and rear faces and having a flange extending from the lower face along an edge shared with the rear face, the flange formed during the molding process by action of a moveable shoe assembly having a notch element which is a negative of the flange, wherein the flange is configured to engage a notch in an upper face of at least one similar masonry block;
a first side face joining the front and rear faces; and
a second side face opposed to the first side face and joining the front and rear faces.

52. The masonry block of claim 51, wherein the front face includes a desired three-dimensional pattern, the pattern having been imprinted during the molding process by action of a second moveable liner plate which includes a negative of the desired three-dimensional pattern.

53. The masonry block of claim 51, wherein a depth of the flange is substantially equal to a depth of the notch as measured from the rear face to the front face.

54. The masonry block of claim 51, wherein a depth of the flange is less than a depth of the notch such that a depth of the lower face from the front face to the flange is less than a depth of the upper face from the front face to the notch.

55. The masonry block of claim 54, wherein the front face is inwardly angled relative to the rear face such that the depth of the lower face from the front face to the flange is substantially equal to the depth of the upper face from the front face to the notch, the angle having been formed during the molding process by action of a second moveable liner plate having an angle which is a negative of the angle of the front face.

56. The masonry block of claim 55, wherein the front face includes a desired three-dimensional pattern, the pattern having been imprinted during the molding process by action of the second moveable liner plate which includes a negative of the desired three-dimensional pattern.

57. A masonry block molded in a masonry block machine employing a mold assembly having a mold cavity formed by plurality of liner plates, the masonry block comprising:
a front face;
a rear face;
an upper face joining the front and rear faces and having a flange extending from the upper face along an edge shared with the front face, the flange having been formed during a molding process by action of a moveable shoe assembly having a notch element which is a negative of the flange;
a lower face opposed to the upper face and joining the front and rear faces and having a notch along an edge shared with the front face, the notch having been formed during the molding process by action of a first moveable liner plate having a flange element which is a negative of the notch, wherein the notch is configured to engage a flange in an upper face of at least one similar masonry block;
a first side face joining the front and rear faces; and
a second side face opposed to the first side face and joining the front and rear faces.

58. The masonry block of claim 57 wherein the flange and notch extend across a full width of the masonry block from the first side face to the second side face.

59. The masonry block of claim 57, wherein the flange extends from the upper face along a portion of a full width of the edge shared with the front face, the flange having a width and being spaced from the first and second side faces, and wherein the notch comprises a first notch portion and a second notch portion, each notch portion having a width and extending from a different one of the side faces along a portion of a full width of the edge of the lower face shared with the front face, the sum of the widths of the first and second notch portions being at least equal to the width of the flange and each notch portion being configured to engage a portion of flange elements extending from upper faces of similar masonry blocks.

60. The masonry block of claim 59, wherein the flange is substantially centered between the first and second side faces and the width of each notch portion is substantially equal to one-half the width of the flange.

61. The masonry block of claim 57, wherein a depth of the flange is substantially equal to a depth of the notch as measured from the front face to the rear face.

62. The masonry block of claim 57, wherein a depth of the flange is greater than a depth of the notch as measured from the front face to the rear face such that a depth of the upper face from the rear face to the flange is less than a depth of the lower face form the rear face to the notch.

63. The masonry block of claim 62, wherein the front face is inwardly angled relative to the rear face such that the depth the flange is substantially equal to the depth of the the notch, the angle having been formed during the molding process by action of the first moveable liner plate which includes an angle which is a negative of the angle of the front face.

64. A masonry block molded in a masonry block machine employing a mold assembly having a mold cavity formed by plurality of liner plates, the masonry block comprising:
a front face;
a rear face;
a first side face joining the front and rear faces; and
a second side face opposed to the first side face and joining the front and rear faces.
an upper face joining the front and rear faces and having a flange extending from the upper face, the flange being spaced from the front, rear, and first and second side faces and having been formed during a molding process by action of a moveable shoe assembly having a notch element which is a negative of the flange, the flange having a width as measured in a direction generally from the first to the second side face;
a lower face opposed to the upper face and joining the front and rear faces and having a first and a second notch, each being spaced from the front and rear faces and extending from a different one of the side faces across a portion of the lower face, each notch having a width such that the sum of the widths of the first and second notches is at least equal to the width of the flange, the first and second notches having been respectively formed during the molding process by action of a first and a second moveable liner plate each having a flange element which is a negative of the corresponding notch, wherein each notch is configured to engage a flange extending from upper faces of similar masonry blocks.

65. The masonry block of claim 64, wherein the front face includes a desired three-dimensional pattern, the pattern having been imprinted during the molding process by action of a third moveable liner plate which includes a negative of the desired three-dimensional pattern.

66. The masonry block of claim 65, wherein the rear face includes a desired three-dimensional pattern, the pattern having been imprinted during the molding process by action of a fourth moveable liner plate which includes a negative of the desired three-dimensional pattern.

67. The masonry block of claim 64, wherein the flange extending from the upper face is substantially centered between the front and rear faces and between the first and second side faces, and wherein the first and second notches are substantially centered between the front and rear faces.

68. The masonry block of claim 67, wherein the widths of the first and second notches are each substantially equal to one-half the width of the flange.

69. The masonry block of claim 64, wherein the flange and the first and second notches are horizontally offset such that a depth of the lower face from the front face to the first and second notches is less than a depth of the upper face from the front face to the flange.

70. The masonry block of claim 69, wherein the front face is inwardly angled relative to the rear face such that the depth of the lower face from the front face to the first and second notches is substantially equal to the depth of the upper face from the front face to the flange, the angle having been formed during the molding process by action of a third moveable liner plate having an angle which is a negative of the angle of the front face.

71. The masonry block of claim 64, wherein the flange has a shape that enables rotation of a similar masonry block having a notch engaging the flange.

72. The masonry block of claim of claim 71, wherein the flange has an oval shape.

73. A masonry block molded in a masonry block machine employing a mold assembly having a mold cavity formed by plurality of liner plates, the masonry block comprising:
a front face;
a rear face;
a first side face joining the front and rear faces; and
a second side face opposed to the first side face and joining the front and rear faces.
an upper face joining the front and rear faces and having a channel extending from the first side face to the second side face and spaced from the front and rear faces, the channel having been formed during a molding process by action of a moveable shoe assembly having a notch element which is a negative of the channel;
a lower face opposed to the upper face and joining the front and rear faces and having a flange extending from and across the lower face from the first side face to the second side face and spaced from the front and rear faces, the flange having been formed during the molding process by action of a first and a second moveable liner plate each having a flange element that cooperate to form a negative of the flange, wherein the flange is configured to engage a channel in an upper face of at least one similar masonry block.

74. The masonry block of claim 73, wherein the front face includes a desired three-dimensional pattern, the pattern having been imprinted by action of the first moveable liner plate which includes a negative of the desired three-dimensional pattern.

75. The masonry block of claim 74, wherein the rear face includes a desired three-dimensional pattern, the pattern having been imprinted by action of the second moveable liner plate which includes a negative of the desired three-dimensional pattern.

76. A masonry block molded in a masonry block machine employing a mold assembly having a mold cavity formed by plurality of liner plates, the masonry block comprising:
a front face;
a rear face;
a first side face joining the front and rear faces; and
a second side face opposed to the first side face and joining the front and rear faces.
an upper face joining the front and rear faces and having a ell-shaped channel having a short leg open to the rear face and a long leg open to the first side face, the channel having been formed during a molding process by action of a moveable shoe assembly having a notch element which is a negative of the channel;
a lower face opposed to the upper face and joining the front and rear faces and having a flange extending from and across a portion of the lower face and spaced from the front, rear and second side faces, the flange having been formed during the molding process by action of a first, a second, and a third moveable liner plate each having a flange element that cooperate to form a negative of the flange, wherein the flange is configured to engage a channel in an upper face of at least one similar masonry block.

77. The masonry block of claim 76, wherein the front face and second side face include a desired three-dimensional pattern, the pattern having been respectively imprinted on the front and second side faces by action of the first and third moveable liner plates, each having a negative of the corresponding desired three-dimensional pattern.

78. The masonry block of claim 77, wherein the rear face includes a desired three-dimensional pattern, the pattern having been imprinted by action of the second moveable liner plate having a negative of the desired three-dimensional pattern.

79. The masonry block of claim 76, wherein a depth of the first and second side faces is substantially equal to a width of the front and rear faces.
